(19) United States
(12) Patent Application Publication
(10) Pub. No.: US 2026/0225948 A1
(43) Pub. Date: Aug. 6, 2026

(54) FOLDABLE SUBSTRATES, FOLDABLE APPARATUS, AND METHODS OF MAKING

(71) Applicant: CORNING INCORPORATED, CORNING, NY (US)

(72) Inventors: Gabriel Pierce Agnello, Corning, NY (US); Douglas Clippinger Allan, Corning, NY (US); Joy Banerjee, Corning, NY (US); Robert Alan Bellman, Ithaca, NY (US); Jason Thomas Harris, Horseheads, NY (US); Jared Kittleson, Corning, NY (US); Konstantin Sergeevich Koreshkov, Espoo (FI); Peter Joseph Lezzi, Corning, NY (US); Yousef Kayed Qaroush, Horseheads, NY (US); Vitor Marino Schneider, Painted Post, NY (US); ChuanChe Wang, Horseheads, NY (US)

(21) Appl. No.: 19/463,663

(22) Filed: Jan. 29, 2026

Related U.S. Application Data
(60) Provisional application No. 63/752,937, filed on Feb. 3, 2025.

(51) Int. Cl. C03C 21/00; C03C 15/00

(52) U.S. Cl. CPC C03C 21/002; C03C 15/00

(57) ABSTRACT

Foldable substrates and foldable apparatus containing the same have a central portion positioned between a first portion and a second portion. The central portion has a central thickness less than a substrate thickness in the first portion and the second portion. A lithium difference between a central concentration at a central midpoint minus a first concentration of lithium oxide at a first midpoint of the first portion is from 0.2 mol % to 2 mol %. A larger alkali difference between a central concentration at the central midpoint minus a first concentration at the first midpoint is from 0.2 mol % to 2 mol %. A ratio of the lithium difference to the larger alkali difference is from 0.6 to 1.7. Methods includes disposing a diffusion layer over the central portion before chemically strengthening the foldable substrate.

### CROSS REFERENCE TO RELATED APPLICATION

This application claims the benefit of priority under 35 U.S.C. § 119 of U.S. Provisional Application Ser. No. 63/752,937 filed on Feb. 3, 2025, the content of which is relied upon and incorporated herein by reference in its entirety.

### FIELD

The present disclosure relates generally to foldable substrates, foldable apparatus, and methods of making and, more particularly, to foldable substrates comprising a concentration profile of lithium oxide, foldable apparatus including foldable substrates, and methods of making foldable substrates comprising multiple ion-exchange treatments.

### BACKGROUND

Glass-based substrates are commonly used, for example, in display devices, for example, liquid crystal displays (LCDs), electrophoretic displays (EPD), organic light-emitting diode displays (OLEDs), plasma display panels (PDPs), or the like.

There is a desire to develop foldable versions of displays as well as foldable protective covers to mount on foldable displays. Foldable displays and covers should have good impact and puncture resistance. At the same time, foldable displays and covers should have a small parallel plate distance (e.g., 10 millimeters (mm) or less). However, plastic displays and covers with a small parallel plate distance tend to have poor impact and/or puncture resistance. Consequently, there is a need to develop foldable apparatus that have low minimum parallel plate distance, good impact resistance, good puncture resistance, and free of buckling.

### SUMMARY

There are set forth herein foldable apparatus comprising foldable substrates, foldable substrates, and methods of making foldable apparatus and foldable substrates comprising foldable substrates that comprise a first portion, a second portion, and a central portion positioned therebetween. The substrate and/or the portions can comprise glass-based and/or ceramic-based portions, which can provide good dimensional stability, reduced incidence of mechanical instabilities, good impact resistance, and/or good puncture resistance. The portions can comprise glass-based and/or ceramic-based portions comprising one or more compressive stress regions, which can further provide increased impact resistance and/or increased puncture resistance. By providing a substrate comprising a glass-based and/or ceramic-based substrate, the substrate can also provide increased impact resistance and/or puncture resistance while simultaneously facilitating good folding performance. In aspects, the substrate thickness can be sufficiently large (e.g., from 50 micrometers (microns or μm) to 2 millimeters) to further enhance impact resistance and puncture resistance. Providing foldable substrates comprising a central portion comprising a central thickness that is less than a substrate thickness (e.g., first thickness of the first portion and/or second thickness of the second portion) (e.g., by 10 μm or more) can enable a small parallel plate distance (e.g., 10 millimeters or less) based on the reduced thickness in the central portion, which can enable the foldability and/or rollability of the foldable substrate and/or foldable apparatus.

In aspects, the foldable apparatus and/or foldable substrates can comprise one or more recesses, for example, a first central surface area recessed from a first major surface by a first distance and/or a second central surface area recessed from a second major surface by a second distance. Providing a first recess opposite a second recess can provide the central thickness that is less than a substrate thickness. Further, providing a first recess opposite a second recess can reduce a maximum bend-induced strain of the foldable apparatus, for example, between a central portion and a first portion and/or second portion since the central portion comprising the central thickness can be closer to a neutral axis of the foldable apparatus and/or foldable substrates than if only a single recess was provided. Additionally, providing the first distance substantially equal to the second distance can reduce the incidence of mechanical instabilities in the central portion, for example, because the foldable substrate is symmetric about a plane comprising a midpoint in the substrate thickness and the central thickness. Alternatively, providing at least one recess on only one side of the foldable substrate can provide a smooth major surface that, for example, can be facing the user and/or provide a uniform tactile sensation. Likewise, providing at least one recess on only one side of the foldable substrate can be manufactured with only a single chemically strengthening process, reducing processing time, space, materials, and cost as well as potentially increasing throughput.

The present disclosure unexpectedly demonstrates that buckling-free and low warp foldable substrates can be obtained. As discussed below, a diffusion layer can be disposed over the central portion to limit (but not prevent) ion exchange in one of the chemical strengthening steps, where the entire foldable substrate undergoes at least some ion exchange in each of the two or more chemical strengthening steps. As demonstrated herein for Example 1 (FIGS. 23 and 25-26), there is a critical thickness for the diffusion layer that allows for some ion exchange in the central portion that avoids buckling (seen without a diffusion layer—Example AA) and the large warp (seen with too thick of a diffusion layer—Example 2-see FIG. 27). The ratio of the lithium difference to the larger alkali difference can be characteristic of the method described herein, where elevated concentration profiles of lithium and the larger alkali metal can be formed throughout the entire central thickness of the central portion relative to the bulk composition (e.g., composition at the first midpoint of the first portion).

The foldable substrate can function as a rollable substrate with a central width greater than a second width. Providing a second width of the second portion of 15% or less of the length of the foldable substrate can provide sufficient width to handle the ends of the foldable substrate during processing, to secure the foldable substrate and/or foldable apparatus as part of an electronic device, and/or to maximize an amount of the foldable substrate and/or foldable apparatus that can be part of a display portion visible to the user. Providing a central portion from 15% to 50% of the length of the foldable substrate can enable a display portion of the foldable apparatus to be adjusted as a portion of the rollable substrate is moved into and/or out of view of a user without unnecessarily expanding a size of the corresponding apparatus when in a fully rolled configuration. Providing a first width of the first portion of 35% or more of the length of the foldable substrate can provide a large display portion visible to the user while ensuring that substantially all of the rest of the foldable substrate (e.g., central portion and second portion) can be within a footprint of the first portion.

Some example aspects of the disclosure are described below with the understanding that any of the features of the various aspects may be used alone or in combination with one another.
Aspect 1. A foldable apparatus comprising a substrate comprising:
a substrate thickness defined between a first major surface and a second major surface opposite the first major surface;
a first portion comprising the substrate thickness, a first compressive stress region extending to a first depth of compression from the first major surface, a second compressive stress region extending to a second depth of compression from the second major surface;
a second portion comprising the substrate thickness, a third compressive stress region extending to a third depth of compression from the first major surface, a fourth compressive stress region extending to a fourth depth of compression from the second major surface;
a central portion positioned between the first portion and the second portion, the central portion comprising a central thickness defined between a first central surface area and a second central surface area opposite the first central surface area, a first central compressive stress region extending to a first central depth of compression from the first central surface area, a second central compressive stress region extending to a second central depth of compression from the second central surface area, the first central surface area is recessed from the first major surface by a first distance, and the central thickness is less than the substrate thickness;
a lithium difference defined as a central concentration of lithium oxide at a central midpoint of the central portion minus a first concentration of lithium oxide at a first midpoint of the first portion is from 0.2 mol % to 2 mol %, wherein the central midpoint is midway between the first central surface area and the second central surface area, and the first midpoint is midway between the first major surface and the second major surface in the first portion; and
a larger alkali difference defined as a central concentration of a larger alkali metal oxide at the central midpoint of the central portion minus a first concentration of the larger alkali metal oxide at the first midpoint of the first portion by from 0.2 mol % to 2 mol %, wherein the larger alkali metal oxide is selected from a group of potassium oxide, rubidium oxide, cesium oxide, and francium oxide,
wherein a ratio of the lithium difference to the larger alkali difference is from 0.6 to 1.7, and the substrate comprises a glass-based material.
Aspect 2. The foldable apparatus of aspects 1, wherein the first concentration of the larger alkali metal oxide at the first midpoint is less than or equal to 0.1 mol %.
Aspect 3. The foldable apparatus of any one of aspects 1-2, wherein the first concentration of lithium oxide at the first midpoint is less than or equal to 0.1 mol %.
Aspect 4. A foldable apparatus comprising a substrate comprising:
a substrate thickness defined between a first major surface and a second major surface opposite the first major surface;
a first portion comprising the substrate thickness, a first compressive stress region extending to a first depth of compression from the first major surface, a second compressive stress region extending to a second depth of compression from the second major surface;
a second portion comprising the substrate thickness, a third compressive stress region extending to a third depth of compression from the first major surface, a fourth compressive stress region extending to a fourth depth of compression from the second major surface;
a central portion positioned between the first portion and the second portion, the central portion comprising a central thickness defined between a first central surface area and a second central surface area opposite the first central surface area, a first central compressive stress region extending to a first central depth of compression from the first central surface area, a second central compressive stress region extending to a second central depth of compression from the second central surface area, the first central surface area is recessed from the first major surface by a first distance, and the central thickness is less than the substrate thickness, wherein the first compressive stress region is associated with a first depth of layer of a larger alkali metal oxide, the first central compressive stress region is associated with a first central depth of layer of the larger alkali metal oxide, wherein the larger alkali metal oxide is selected from a group of potassium oxide, rubidium oxide, cesium oxide, and francium oxide,
wherein a lithium difference defined as a concentration of lithium oxide at twice the first central depth of layer from the first central surface area minus a first concentration of lithium oxide at twice the first depth of layer from the first major surface of the first portion is from 0.2 mol % to 2 mol %,
where a larger alkali difference defined as a concentration of the larger alkali metal oxide at twice the first central depth of layer from the first central surface area minus a first concentration of the larger alkali metal oxide at twice the first depth of layer from the first major surface of the first portion by from 0.2 mol % to 2 mol %, and
wherein a ratio of the lithium difference to the larger alkali difference is from 0.6 to 1.7, and the substrate comprises a glass-based material.
Aspect 5. The foldable apparatus of any one of aspects 1-4, wherein the lithium difference is from 0.5 mol % to 1.5 mol %.
Aspect 6. The foldable apparatus of any one of aspects 1-5, wherein the larger alkali difference is from 0.5 mol % to 1.5 mol %.
Aspect 7. The foldable apparatus of any one of aspects 1-6, wherein the ratio of the lithium difference to the larger alkali difference is from 0.75 to 1.4.
Aspect 8. The foldable apparatus of any one of aspects 1-7, wherein the larger alkali difference is potassium oxide, the larger alkali difference is a potassium difference, and the ratio of the lithium difference to the larger alkali difference is a ratio of the lithium difference to the potassium difference.
Aspect 9. The foldable apparatus of any one of aspects 1-8, wherein a ratio of a first depth of layer of potassium ions in the first portion from the first major surface to a first central depth of layer of potassium ions in the central portion from the first central surface area is from 2.0 to 6.0, and the first compressive stress region comprises a non-zero concentration profile of lithium and the larger alkali metal oxide to the first depth of layer of the larger alkali metal oxide.
Aspect 10. A foldable apparatus comprising a substrate comprising:
a substrate thickness defined between a first major surface and a second major surface opposite the first major surface;
a first portion comprising the substrate thickness, a first compressive stress region extending to a first depth of compression from the first major surface, a second compressive stress region extending to a second depth of compression from the second major surface;
a second portion comprising the substrate thickness, a third compressive stress region extending to a third depth of compression from the first major surface, a fourth compressive stress region extending to a fourth depth of compression from the second major surface; and
a central portion positioned between the first portion and the second portion, the central portion comprising a central thickness defined between a first central surface area and a second central surface area opposite the first central surface area, a first central compressive stress region extending to a first central depth of compression from the first central surface area, a second central compressive stress region extending to a second central depth of compression from the second central surface area, the first central surface area is recessed from the first major surface by a first distance, and the central thickness is less than the substrate thickness,
wherein a ratio of a first depth of layer of potassium ions in the first portion from the first major surface to a first central depth of layer of potassium ions in the central portion from the first central surface area is from 2.0 to 6.0, and the substrate comprises a glass-based material, the first compressive stress region comprises a non-zero concentration profile of lithium and a larger alkali metal oxide to a first depth of layer of the larger alkali metal oxide, where the larger alkali metal oxide is selected from a group of potassium oxide, rubidium oxide, cesium oxide, and francium oxide.
Aspect 11. The foldable apparatus of any one of aspects 9-10, wherein the ratio of the first depth of layer of potassium ions to the first central depth of layer of potassium ions is from 2.5 to 4.0.
Aspect 12. The foldable apparatus of any one of aspects 9-11, wherein the first depth of layer of potassium ions divided by the substrate thickness is from 0.12 to 0.17, and the first central depth of layer of potassium ions divided by the central thickness is from 0.15 to 0.20.
Aspect 13. The foldable apparatus of any one of aspects 1-12, wherein a first maximum compressive stress at the first major surface is from 600 MegaPascals to 1,500 MegaPascals, and a first central maximum compressive stress at the first central surface area is from 600 MegaPascals to 1,500 MegaPascals.
Aspect 14. The foldable apparatus of aspect 13, wherein the first maximum compressive stress is from 700 MegaPascals to 1,000 MegaPascals, and the first central maximum compressive stress is from 700 MegaPascals to 1,000 MegaPascals.
Aspect 15. The foldable apparatus of any one of aspects 13-14, wherein an absolute value of a difference between the first maximum compressive stress and the first central maximum compressive stress is from 0 MegaPascals to 100 MegaPascals.
Aspect 16. The foldable apparatus of any one of aspects 1-15, wherein a first surface concentration of lithium oxide at the first major surface is from 2.0 mol % to 5.0 mol %, and a first central surface concentration of lithium oxide at the first central surface area is from 1.0 mol % to 4.0 mol %.
Aspect 17. The foldable apparatus of aspect 16, wherein an absolute value of a difference between the first surface concentration of lithium oxide and the first central surface concentration of lithium oxide is less than or equal to 0.1 mol %.
Aspect 18. The foldable apparatus of any one of aspects 1-17, wherein a first surface concentration of the larger alkali metal oxide at the first major surface is from 8 mol % to 15 mol %, and a first central surface concentration of the larger alkali metal oxide at the first central surface area is from 8 mol % to 15 mol %.
Aspect 19. The foldable apparatus of aspect 18, wherein the first surface concentration of the larger alkali metal oxide is greater than the first central surface concentration of the larger alkali metal oxide by from greater than or equal to 0.2 mol % to 2.0 mol %.
Aspect 20. The foldable apparatus of any one of aspects 1-19, wherein a first surface concentration of sodium oxide at the first major surface is from 0.5 mol % to 3.0 mol %, and a first central surface concentration of sodium oxide at the first central surface area is from 0.5 mol % to 3.0 mol %.
Aspect 21. The foldable apparatus of any one of aspects 1-20, wherein a first larger alkali concentration profile in the first compressive stress region comprises:
a spike region extending between the first major surface and a first knee; and
a deep region extending between the first knee and the first depth of compression, wherein an absolute value of a slope of a stress profile in the spike region is greater than an absolute value of a slope of a stress profile in the deep region.
Aspect 22. The foldable apparatus of aspect 21, wherein a location of the first knee divided by the substrate thickness is from 0.025 to 0.075.
Aspect 23. The foldable apparatus of any one of aspects 1-22, wherein a first central larger alkali concentration profile in the first central compressive stress region comprises follows a Complementary Gaussian Error Function (erfc) profile.
Aspect 24. The foldable apparatus of any one of aspects 1-23, wherein the first depth of compression divided by the substrate thickness is from 0.15 to 0.20.
Aspect 25. The foldable apparatus of any one of aspects 1-24, wherein the substrate thickness is from 50 micrometers to 2 millimeters.
Aspect 26. The foldable apparatus of any one of aspects 1-25, wherein the central thickness is from 25 micrometers to 120 micrometers.
Aspect 27. The foldable apparatus of any one of aspects 1-26, wherein the first distance is from 25% to 70% of the substrate thickness.
Aspect 28. The foldable apparatus of any one of aspects 1-27, wherein the second major surface is coplanar with the second central surface area.
Aspect 29. The foldable apparatus of any one of aspects 1-27, wherein the second central surface area is recessed from the second major surface by a second distance, the second distance is from 25% to 45% of the substrate thickness, and the first distance is from 25% to 45%.
Aspect 30. The foldable apparatus of any one of aspects 1-29, wherein the foldable apparatus achieves a parallel plate distance from 1 millimeter to 10 millimeters.
Aspect 31. The foldable apparatus of any one of aspects 1-29, wherein the foldable apparatus achieves a parallel plate distance of 6 millimeters.
Aspect 32. The foldable apparatus of any one of aspects 1-31, wherein a surface profile of the first central surface area has an average gradient of 0.015 mm/mm or less.
Aspect 33. A method of making a foldable substrate comprising:
chemically strengthening a substrate in a first molten salt solution maintained at from 380° C. to 480° C. for a first period of time from 20 minutes to 8 hours to form an intermediate substrate, the substrate being chemically strengthened comprises:
an initial first major surface and an initial second major surface opposite the first major surface present in a first portion and a second portion; and
a central portion positioned between an initial first portion and an initial second portion, the central portion comprising an existing central thickness defined between an existing first central surface area and an existing second central surface area opposite the existing first central surface area, the existing first central surface area is recessed from the existing first major surface by an existing first distance;
disposing a diffusion layer over the first central surface area and the second central surface area of the intermediate substrate;
immersing the intermediate substrate having the diffusion layer disposed thereon in a second molten salt solution maintained at from 380° C. to 480° C. for a second period of time from 1 minute to 3 hours; and then removing the diffusion layer to form the foldable substrate,
wherein the foldable substrate is a glass-based substrate comprising:
the first portion comprising a substrate thickness, a first compressive stress region extending to a first depth of compression from a first major surface, a second compressive stress region extending to a second depth of compression from a second major surface;
the second portion comprising the substrate thickness, a third compressive stress region extending to a third depth of compression from the first major surface, a fourth compressive stress region extending to a fourth depth of compression from the second major surface; and
the central portion positioned between the first portion and the second portion, the central portion comprising a central thickness defined between a first central surface area and a second central surface area opposite the first central surface area, a first central compressive stress region extending to a first central depth of compression from the first central surface area, a second central compressive stress region extending to a second central depth of compression from a second central surface area, the first central surface area is recessed from the first major surface by a first distance, and the central thickness is less than the substrate thickness.
Aspect 34. The method of aspect 33, wherein the first molten salt solution comprises, based on 100 wt % of the first molten salt solution:
from 20 wt % to 80 wt % of a sodium salt; and
from 20 wt % to 80 wt % of a potassium salt.
Aspect 35. The method of any one of aspects 33-34, wherein the second molten salt solution comprises, based on 100 wt % of the second molten salt solution:
0.10 wt % to 1.0 wt % of a lithium salt; and from 95 wt % to 99.9 wt % of a potassium salt.
Aspect 36. A method of making a foldable substrate comprising:
disposing a diffusion layer over the first central surface area and the second central surface area of an existing substrate;
chemically strengthening the existing substrate having the diffusion layer disposed thereof in a first molten salt solution maintained at from 380° C. to 480° C. for a first period of time from 1 minute to 30 minutes to form an intermediate substrate, the substrate being chemically strengthened comprises:
an initial first major surface and an initial second major surface opposite the first major surface present in a first portion and a second portion; and
a central portion positioned between an initial first portion and an initial second portion, the central portion comprising an existing central thickness defined between an existing first central surface area and an existing second central surface area opposite the existing first central surface area, the existing first central surface area is recessed from the existing first major surface by an existing first distance;
removing the diffusion layer from the intermediate substrate;
immersing the intermediate substrate, after the diffusion layer is removed, in a second molten salt solution maintained at from 380° C. to 480° C. for a second period of time from 20 minutes to 4 hours to form the foldable substrate, wherein the foldable substrate is a glass-based substrate comprising:
the first portion comprising a substrate thickness, a first compressive stress region extending to a first depth of compression from a first major surface, a second compressive stress region extending to a second depth of compression from a second major surface;
the second portion comprising the substrate thickness, a third compressive stress region extending to a third depth of compression from the first major surface, a fourth compressive stress region extending to a fourth depth of compression from the second major surface; and
the central portion positioned between the first portion and the second portion, the central portion comprising a central thickness defined between a first central surface area and a second central surface area opposite the first central surface area, a first central compressive stress region extending to a first central depth of compression from the first central surface area, a second central compressive stress region extending to a second central depth of compression from a second central surface area, the first central surface area is recessed from the first major surface by a first distance, and the central thickness is less than the substrate thickness.
Aspect 37. The method of aspect 36, wherein the first molten salt solution comprises, based on 100 wt % of the first molten salt solution: 0.10 wt % to 1.0 wt % of a lithium salt; and from 95 wt % to 99.9 wt % of a potassium salt.
Aspect 38. The method of any one of aspects 36-37, wherein the second molten salt solution comprises, based on 100 wt % of the second molten salt solution:
from 20 wt % to 80 wt % of a sodium salt; and
from 20 wt % to 80 wt % of a potassium salt.
Aspect 39. The method of any one of aspects 33-38, wherein the substrate is substantially unstrengthened prior to the chemically strengthening the substrate in the first molten salt solution.
Aspect 40. The method of any one of aspects 33-39, wherein the diffusion layer comprises an oxynitride material having a layer thickness from 10 nanometers to 40 nanometers.
Aspect 41. The method of aspect 40, wherein the layer thickness is from 20 nanometers to 30 nanometers.
Aspect 42. The method of any one of aspects 33-39, wherein the diffusion layer comprises aluminum oxynitride having a layer thickness from 20 nanometers to 30 nanometers.
Aspect 43. The method of any one of aspects 33-42, further comprising further chemically strengthening the foldable substrate in a third molten salt solution maintained at from 380° C. to 530° C. for a first period of time from 1 minute to 30 minutes.
Aspect 44. The method of any one of aspects 33-43, wherein a ratio of a first depth of layer of potassium ions in the first portion from the first major surface to a first central depth of layer of potassium ions in the central portion from the first central surface area is from 2.0 to 6.0.
Aspect 45. The method of aspect 44, wherein the first depth of layer of potassium ions divided by the substrate thickness is from 0.12 to 0.17, and the first central depth of layer of potassium ions divided by the central thickness is from 0.15 to 0.20.
Aspect 46. The method of any one of aspects 33-45, wherein a first maximum compressive stress of the first compressive stress region is from 600 MegaPascals to 1,500 MegaPascals, and a first central maximum compressive stress of the first central compressive stress region is from 600 MegaPascals to 1,500 MegaPascals.
Aspect 47. The method of aspect 46, wherein the first maximum compressive stress is from 700 MegaPascals to 1,000 MegaPascals, and the first central maximum compressive stress is from 700 MegaPascals to 1,000 MegaPascals.
Aspect 48. The method of any one of aspects 33-47, wherein the foldable substrate exhibits:
a lithium difference defined as a central concentration of lithium oxide at a central midpoint of the central portion minus a first concentration of lithium oxide at a first midpoint of the first portion is from 0.2 mol % to 2 mol %, wherein the central midpoint is midway between the first central surface area and the second central surface area, and the first midpoint is midway between the first major surface and the second major surface in the first portion; and
a potassium difference defined as a central concentration of a larger alkali metal oxide at the central midpoint of the central portion minus a first concentration of potassium oxide at the first midpoint of the first portion by from 0.2 mol % to 2 mol %, wherein the larger alkali metal oxide is selected from a group of potassium oxide, rubidium oxide, cesium oxide, and francium oxide,
wherein a ratio of the lithium difference to the potassium difference is from 0.6 to 1.7.
Aspect 49. The method of aspect 48, wherein the first concentration of potassium oxide at the first midpoint is less than or equal to 0.1 mol %.
Aspect 50. The method of any one of aspects 48-49, wherein the first concentration of lithium oxide at the first midpoint is less than or equal to 0.1 mol %.
Aspect 51. The method of any one of aspects 33-47, wherein the foldable substrate exhibits:
a lithium difference defined as a concentration of lithium oxide at twice the first central depth of layer from the first central surface area minus a first concentration of lithium oxide at twice the first depth of layer from the first major surface of the first portion is from 0.2 mol % to 2 mol %,
a potassium difference defined as a concentration of the larger alkali metal oxide at twice the first central depth of layer from the first central surface area minus a first concentration of potassium oxide at twice the first depth of layer from the first major surface of the first portion by from 0.2 mol % to 2 mol %, and
a ratio of the lithium difference to the potassium difference is from 0.6 to 1.7.
Aspect 52. The method of any one of aspects 48-51, wherein the lithium difference is from 0.5 mol % to 1.5 mol %.
Aspect 53. The method of any one of aspects 48-52, wherein the potassium difference is from 0.5 mol % to 1.5 mol %.
Aspect 54. The method of any one of aspects 33-53, wherein a first surface concentration of lithium oxide at the first major surface is from 2.0 mol % to 5.0 mol %, and a first central surface concentration of lithium oxide at the first central surface area is from 1.0 mol % to 4.0 mol %.
Aspect 55. The method of aspect 54, wherein an absolute value of a difference between the first surface concentration of lithium oxide and the first central surface concentration of lithium oxide is less than or equal to 0.1 mol %.
Aspect 56. The method of any one of aspects 33-55, wherein a first surface concentration of potassium oxide at the first major surface is from 8 mol % to 15 mol %, and a first central surface concentration of potassium oxide at the first central surface area is from 8 mol % to 15 mol %.
Aspect 57. The method of aspect 56, wherein the first surface concentration of potassium oxide is greater than the first central surface concentration of potassium oxide by from greater than or equal to 0.2 mol % to 2.0 mol %.
Aspect 58. The method of any one of aspects 33-57, wherein a first surface concentration of sodium oxide at the first major surface is from 0.5 mol % to 3.0 mol %, and a first central surface concentration of sodium oxide at the first central surface area is from 0.5 mol % to 3.0 mol %.
Aspect 59. The method of any one of aspects 33-58, wherein a potassium concentration profile in the first compressive stress region comprises:
a spike region extending between the first major surface and a first knee; and
a deep region extending between the first knee and the first depth of compression, wherein an absolute value of a slope of a stress profile in the spike region is greater than an absolute value of a slope of a stress profile in the deep region.
Aspect 60. The method of aspect 59, wherein a location of the first knee divided by the substrate thickness is from 0.025 to 0.075.
Aspect 61. The method of any one of aspects 33-60, wherein a first central larger alkali concentration profile in the first central compressive stress region comprises follows a Complementary Gaussian Error Function (erfc) profile.
Aspect 62. The method of any one of aspects 33-61, wherein the first depth of compression divided by the substrate thickness is from 0.15 to 0.20.
Aspect 63. The method of any one of aspects 33-62, wherein the substrate thickness is from 50 micrometers to 2 millimeters.
Aspect 64. The method of any one of aspects 33-63, wherein the central thickness is from 25 micrometers to 120 micrometers.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic view of an example foldable apparatus in a flat configuration according to aspects, wherein a schematic view of the folded configuration may appear as shown in FIG. 4;

FIG. 2 is a cross-sectional view of the foldable apparatus along line 2-2 of FIG. 1 including a foldable substrate having a pair of recesses opposite on another in accordance with aspects of the present disclosure;

FIG. 3 is a cross-sectional view of the foldable apparatus along line 2-2 of FIG. 1 including another foldable substrate having a single recess in accordance with aspects of the present disclosure;

FIG. 4 is a schematic view of example foldable apparatus of aspects of the disclosure in a folded configuration wherein a schematic view of the flat configuration may appear as shown in FIG. 1;

FIG. 5 is a cross-sectional view of a testing apparatus to determine the minimum parallel plate distance of an example foldable substrate along line 5-5 of FIG. 4;

FIG. 6 is a cross-sectional view of a testing apparatus to determine the minimum parallel plate distance of an example foldable substrate having a pair of recesses opposite one another in accordance with aspects of the present disclosure;

FIG. 7 is a schematic plan view of an example consumer electronic device according to aspects;

FIG. 8 is a schematic perspective view of the example consumer electronic device of FIG. 7;

FIG. 9 is a schematic perspective view of a foldable consumer electronic product;

FIG. 10 is a flow chart illustrating example methods making foldable substrate or foldable apparatus in accordance with aspects of the disclosure;

FIG. 11 schematically illustrates chemically strengthening the foldable substrate in a step of methods of making a foldable apparatus;

FIG. 12 schematically illustrates chemically strengthening the foldable substrate having a single recess, where the central portion has a diffusion layer disposed thereon in a step of methods of making a foldable apparatus;

FIG. 13 schematically illustrates chemically strengthening the foldable substrate having a pair of recesses opposite one another, where the central portion has a diffusion layer disposed thereon in a step of methods of making a foldable apparatus;

FIG. 14 schematically illustrates further chemically strengthening the foldable substrate having a single recess, for example, after the chemical strengthening shown in FIG. 13 in in a step of methods of making a foldable apparatus;

FIG. 15 schematically illustrates the development of a stress profile in a first portion through a first set of chemical strengthening treatments in accordance with methods of the present disclosure;

FIG. 16 schematically illustrates the development of a stress profile in a central portion through a first set of chemical strengthening treatments in accordance with methods of the present disclosure;

FIG. 17 schematically illustrates the development of a stress profile in a first portion through a second set of chemical strengthening treatments in accordance with methods of the present disclosure;

FIG. 18 schematically illustrates the development of a stress profile in a central portion through a second set of chemical strengthening treatments in accordance with methods of the present disclosure;

FIG. 19-FIG. 21 schematically illustrate disposing a polymer-based portion and/or an adhesive layer over the foldable substrate in methods of making a foldable substrate and/or foldable apparatus;

FIG. 22 schematically illustrates concentration profiles from a first major surface of Example 1 as measured by glow discharge optical emission spectroscopy (GDOES) in accordance with aspects of the present disclosure;

FIG. 23 schematically illustrates concentration profiles from a first central surface area of Example 1 as measured GDOES in accordance with aspects of the present disclosure;

FIG. 24 schematically illustrates concentration profiles on a logarithmic axis for Example 3 as measured by GDOES in accordance with aspects of the present disclosure;

FIG. 25 schematically illustrates a surface profile of the first major surface and the first central surface area of Example 1 in accordance with aspects of the present disclosure;

FIG. 26 schematically illustrates a surface profile of the first central surface area of Example 1; and

FIG. 27 schematically illustrates a surface profile of the first central surface area of Example 2 in accordance with aspects of the present disclosure.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

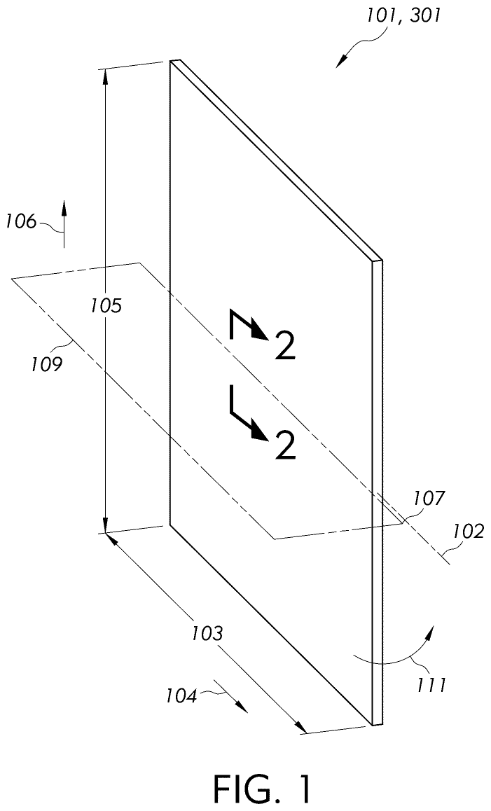

Aspects will now be described more fully hereinafter with reference to the accompanying drawings in which example aspects are shown. Whenever possible, the same reference numerals are used throughout the drawings to refer to the same or like parts. FIGS. 1-4 and 5-6 illustrate views of foldable apparatus 101, 301, 401, and 601 comprising a foldable substrate 201 in accordance with aspects of the disclosure. Unless otherwise noted, a discussion of features of aspects of one foldable apparatus can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

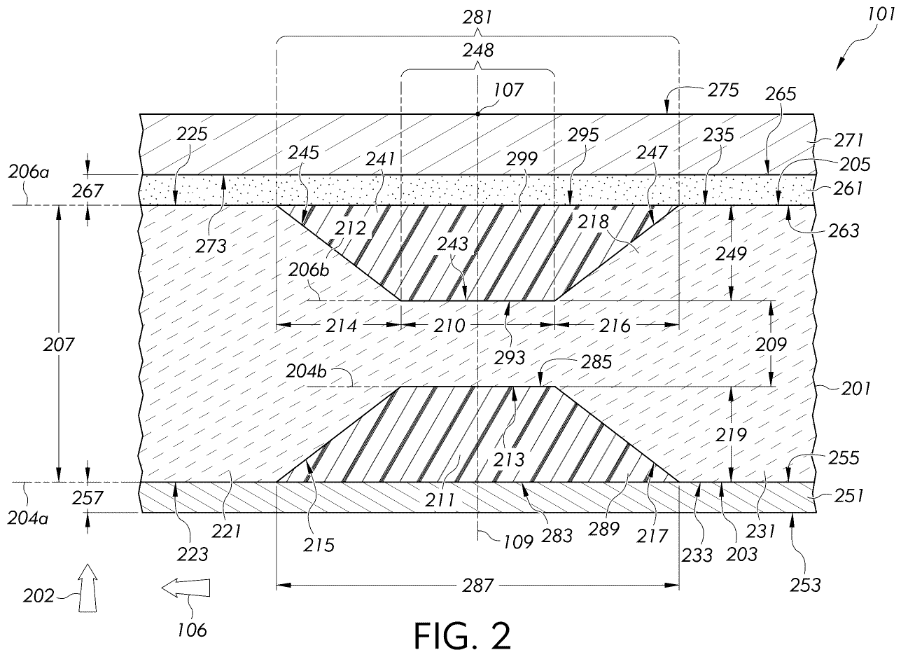

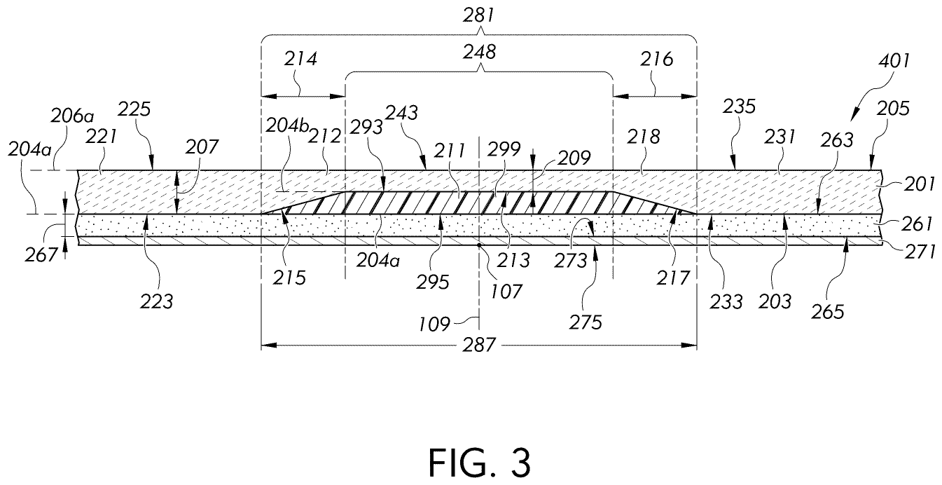

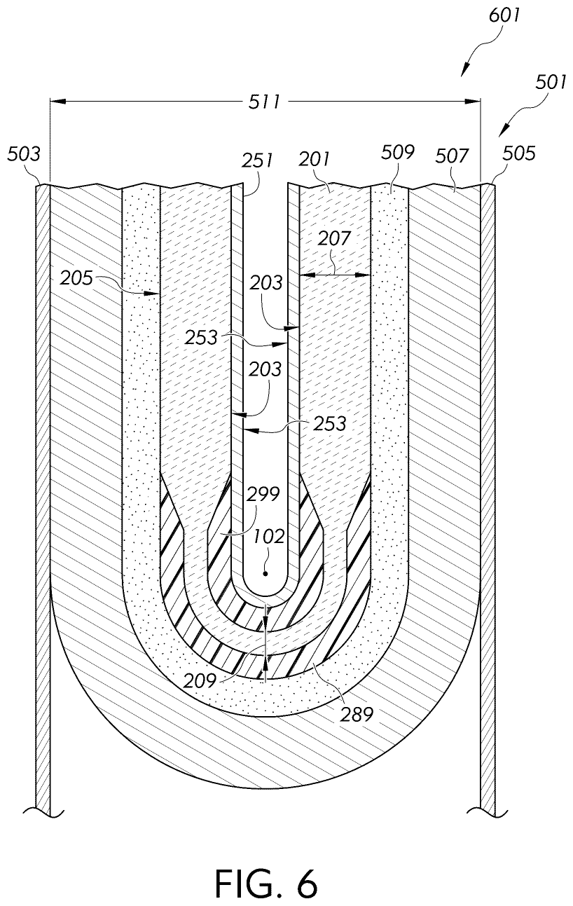

FIGS. 2-4 schematically illustrate example aspects of foldable apparatus 101 and 301 comprising the foldable substrate 201 in accordance with aspects of the disclosure in an unfolded (e.g., flat) configuration while FIGS. 5-6 illustrates an example aspect of a foldable apparatus 401 and 601 comprising the foldable substrate 201 in accordance with aspects of the disclosure in a folded configuration. The foldable apparatus 101 and 301 and the foldable substrate 201 comprise a first portion 221, a second portion 231, and a central portion 281 positioned between the first portion 221 and the second portion 231. In aspects, as shown in FIGS. 2-3, the foldable apparatus 101 and 301 can comprise a release liner 271 although other substrates (e.g., a glass-based substrate and/or a ceramic-based substrate discussed throughout the application) may be used in further aspects rather than with the illustrated release liner 271. In aspects, as shown in FIGS. 2 and 6, the foldable apparatus 101 and 601 can comprise a coating 251. In aspects, as shown in FIGS. 2-3, the foldable apparatus 101 and 301 can comprise an adhesive layer 261. In aspects, as shown in FIGS. 2-3 and 6, foldable apparatus 101, 301, and 601 can comprise a polymer-based portion 289 and/or 299. As shown in FIGS. 2-3 and 5-6, the foldable substrate 201 can comprise a first recess 211. In aspects, as shown in FIGS. 2 and 6, the foldable substrate 201 can further comprise a second recess 241 in addition to the first recess 211. It is to be understood that any of the foldable apparatus of the disclosure can comprise a second substrate (e.g., a glass-based substrate and/or a ceramic-based substrate), a release liner 271, a display device, a coating 251, an adhesive layer 261, and/or a polymer-based portion 289 and/or 299.

Throughout the disclosure, with reference to FIG. 1, the width 103 of the foldable apparatus 101, 301, 401, and/or 601 is considered the dimension of the foldable apparatus taken between opposed edges of the foldable apparatus in a direction 104 of a fold axis 102 of the foldable apparatus, wherein the direction 104 also comprises the direction of the width 103. Furthermore, throughout the disclosure, the length 105 of the foldable apparatus is considered the dimension of the foldable apparatus taken between opposed edges of the foldable apparatus in a direction 106 perpendicular to the fold axis 102 of the foldable apparatus. It is to be understood that the direction 104 of the width 103 and/or the direction 106 of the length 105 can correspond to corresponding directions in the foldable substrate 201. In aspects, as shown in FIGS. 1-2, the foldable apparatus of any aspects of the disclosure can comprise a fold plane 109 that includes the fold axis 102 when the foldable apparatus is in the flat configuration (see FIG. 2). In further aspects, as shown in FIG. 2, the fold plane 109 can extend along the fold axis 102 and in a direction 202 of the substrate thickness 207 when the foldable apparatus is in the flat configuration (see FIG. 2). The fold plane 109 may comprise a central axis 107 of the foldable apparatus. In aspects, the foldable apparatus can be folded in a direction 111 (see FIG. 1) about the fold axis 102 extending in the direction 104 of the width 103 to form a folded configuration (see FIG. 6). Likewise, folding the foldable substrate 201 (see FIG. 3) about the fold axis can form a folded configuration (see FIG. 5). As shown, the foldable apparatus and/or the foldable substrate may include a single fold axis to allow the foldable apparatus and/or the foldable substrate to comprise a bifold wherein, for example, the foldable apparatus and/or the foldable substrate may be folded in half. In further aspects, the foldable apparatus and/or the foldable substrate may include two or more fold axes with each fold axis including a corresponding central portion similar or identical to the central portion 281 discussed herein. For example, providing two fold axes can allow the foldable apparatus and/or the foldable substrate to comprise a trifold wherein, for example, the foldable apparatus and/or the foldable substrate may be folded with the first portion 221, the second portion 231, and a third portion similar or identical to the first portion or second portion with the central portion 281 and another central portion similar to or identical to the central portion positioned between the first portion and the second portion and between the second portion and the third portion, respectively.

Throughout the disclosure, a tensile strength, ultimate elongation (e.g., strain at failure), and yield point of a polymeric material (e.g., adhesive, polymer-based portion) is determined using ASTM D638 using a tensile testing machine, for example, an Instron 3400 or Instron 6800, at 23° C. and 50% relative humidity with a type I dogbone shaped sample. Throughout the disclosure, an elastic modulus (e.g., Young's modulus) and/or a Poisson's ratio is measured using ISO 527-1:2019. Throughout the disclosure, the Young's modulus of glass materials are measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, the foldable substrate 201 can comprise an elastic modulus of 50 GPa or more, 60 GPa or more, 65 GPa or more, 70 GPa or more, 72 GPa or more, 75 GPa or more, 120 GPa or less, 100 GPa or less, 90 GPa or less, 80 GPa or less, 75 GPa or less, 72 GPa or less, or 70 GPa or less. In further aspects, the foldable substrate 201 can comprise a glass material comprising an elastic modulus ranging from 50 GPa to 120 GPa, from 60 GPa to 100 GPa, from 65 GPa to 90 GPa, from 70 GPa to 80 GPa, from 72 GPa to 75 GPa, or any range or subrange therebetween.

Foldable apparatus 101 and/or 301 of the disclosure comprise the foldable substrate 201. In aspects, the foldable substrate 201 can comprise a glass-based substrate having a pencil hardness of 8H or more, for example, 9H or more. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Glass material comprises an amorphous material (e.g., glass) that may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In aspects, the foldable substrate 201 can comprise a ceramic-based substrate. As used herein, “ceramic-based” includes both ceramics and glass-ceramics, wherein glass-ceramics have one or more crystalline phases and an amorphous, residual glass phase. Ceramic-based materials may be strengthened (e.g., chemically strengthened). In aspects, a ceramic-based material can be formed by heating a glass-based material to form ceramic (e.g., crystalline) portions. In further aspects, ceramic-based materials may comprise one or more nucleating agents that can facilitate the formation of crystalline phase(s).

In aspects, the composition of the foldable substrate 201 can comprise a glass-based material comprising from 40 mol % to 80 mol % SiO₂, from 5 mol % to 30 mol % Al₂O₃, from 5 mol % to 20 mol % Na₂O and/or R₂O, and optionally: from 0 mol % to 15 mol % RO; from 0 mol % to 10 mol % B₂O₃; and/or from 0 mol % to 5 mol % ZrO₂. In further aspects, the composition of the foldable substrate 201 can comprise a glass-based material comprising from 60 mol % to 72 mol % SiO₂, from 8 mol % to 17 mol % Al₂O₃, from 12 mol % to 20 mol % Na₂O and/or R₂O, from 3 mol % to 7 mol % MgO and/or RO, and optionally from 0 mol % to 2 mol % of one or more of B₂O₃ and/or P₂O₅. In even further aspects, the composition of the foldable substrate 201 can further comprise from 14 mol % to 19 mol % Na₂O, from 0 mol % to 1 mol % Li₂O, and/or from 0 mol % to 0.5 mol % K₂O. In further aspects, the composition of the foldable substrate 201 can comprise from 60 mol % to 72 mol % SiO₂, from 8 mol % to 16 mol % Al₂O₃, from 12 mol % to 18 mol % Na₂O and/or R₂O, from 2 mol % to 6 mol % MgO and/or RO, optionally from 0 mol % to 2 mol % of one or more of Li₂O, CaO, B₂O₃, and/or P₂O₅ (e.g., from 0.1 mol % to 2.0 mol % CaO) and optionally from 0 mol % to 1 mol % K₂O. In further aspects, the composition of the foldable substrate 201 can comprise from 64.0 mol % 70 mol % SiO₂, from 9.5 mol % to 14.5 mol % Al₂O₃, from 14 mol % to 17 mol % Na₂O, from 3.0 mol % to 5.5 mol % MgO, from 0 mol % to 1 mol % of one or more of Li₂O, CaO, B₂O₃, and/or P₂O₅, and from 0.0 mol % to 0.5 mol % K₂O. In further aspects, Al₂O₃-R₂O (e.g., Al₂O₃—Na₂O) can be from −6.0 mol % to −2.0 mol % or from −5.8 mol % to −2.2 mol %.

In aspects, the glass substrate can be free of one or more of P₂O₅, B₂O₃, TiO₂, ZnO, ZrO₂, Ta₂O₅, HfO₂, La₂O₃, and/or Y₂O₃. Unless otherwise indicated, as used herein, the term “free” does not require absolute precision nor atomic-scale accuracy, but rather “free” means that the component may be present in the final glass-based composition in very small amounts (e.g., as a contaminant, such as less than 0.1 mol %) that could be practically obtained by a reasonable practitioner, which does include 0.0 mol % in some aspects. For example, the inclusion of ZrO₂ in the glass composition may result in the formation of undesirable zirconia inclusions in the glass material, due at least in part to the low solubility of ZrO₂ in the glass material. Also, the inclusion of Ta₂O₅, HfO₂, La₂O₃, and/or Y₂O₃ may increase the cost of raw materials associated with the glass substrate.

In aspects, the foldable substrate 201 can be optically transparent. As used herein, “optically transparent” or “optically clear” means an average transmittance of 70% or more in the wavelength range of 400 nm to 700 nm through a 1.0 mm thick piece of a material. In aspects, the foldable substrate 201 may have an average transmittance of 75% or more, 80% or more, 85% or more, or 90% or more, 92% or more, 94% or more, 96% or more in the wavelength range of 400 nm to 700 nm through a 1.0 mm thick piece of the material. The average transmittance in the wavelength range of 400 nm to 700 nm is calculated by measuring the transmittance of whole number wavelengths from 400 nm to 700 nm and averaging the measurements.

As shown in FIGS. 2-3, the foldable apparatus 101 and 301 comprise the foldable substrate 201 comprising a first major surface 203 and a second major surface 205 opposite the first major surface 203. As shown in FIGS. 2-3, the first major surface 203 can extend along a first plane 204a. The second major surface 205 can extend along a second plane 206a. In aspects, as shown, the second plane 206a can be parallel to the first plane 204a. As used herein, a substrate thickness 207 can be defined between the first major surface 203 and the second major surface 205 as a distance between the first plane 204a and the second plane 206a. In aspects, the substrate thickness 207 can be 50 μm or more, 60 μm or more, 70 μm or more, 80 μm or more, 90 μm or more, 100 μm or more, 125 μm or more, 150 μm or more, 200 μm or more, 300 μm or more, 2 millimeters (mm) or less, 1 mm or less, 800 μm or less, 500 μm or less, 300 μm or less, 200 μm or less, 180 μm or less, 150 μm or less, or 100 μm or less. In aspects, the substrate thickness 207 can range from 50 μm to 2 mm, from 60 μm to 1 mm, 70 μm to 800 μm, from 80 μm to 500 μm, from 90 μm to 300 μm, from 100 μm to 200 μm, from 125 μm to 180 μm, from 125 μm to 150 μm, or any range or subrange therebetween.

As shown in FIGS. 2-3, the first portion 221 of the foldable substrate 201 can comprise a first surface area 223 and a second surface area 225 opposite the first surface area 223. The first portion 221 will now be described with reference to the foldable apparatus 101 of FIG. 2 with the understanding that such description of the first portion 221, unless otherwise stated, can also apply to any aspects of the disclosure, for example, the foldable apparatus 301, 401, and/or 601 illustrated in FIGS. 3 and 5-6. In aspects, as shown, the first surface area 223 can comprise a planar surface, and/or the second surface area 225 of the first portion 221 can comprise a planar surface. In further aspects, as shown, the second surface area 225 can be parallel to the first surface area 223. In aspects, as shown, the first major surface 203 can comprise the first surface area 223 and the second major surface 205 can comprise the second surface area 225. In further aspects, the first surface area 223 can extend along the first plane 204a. In further aspects, the second surface area 225 can extend along the second plane 206a. In aspects, the substrate thickness 207 can correspond to the distance between the first surface area 223 of the first portion 221 and the second surface area 225 of the first portion 221. In aspects, the substrate thickness 207 can be substantially uniform across the first surface area 223. In aspects, a first thickness defined between the first surface area 223 and the second surface area 225 can be within one or more of the ranges discussed above with regards to the substrate thickness 207. In further aspects, the first thickness can comprise the substrate thickness 207. In further aspects, the first thickness of the first portion 221 may be substantially uniform between the first surface area 223 and the second surface area 225 across its corresponding length (i.e., in the direction 106 of the length 105 of the foldable apparatus) and/or its corresponding width (i.e., in the direction 104 of the width 103 of the foldable apparatus).

As shown in FIGS. 2-4, the second portion 231 of the foldable substrate 201 can comprise a third surface area 233 and a fourth surface area 235 opposite the third surface area 233. The second portion 231 will now be described with reference to the foldable apparatus 101 of FIG. 2 with the understanding that such description of the second portion 231, unless otherwise stated, can also apply to any aspects of the disclosure, for example, the foldable apparatus 301, 401, and/or 601 illustrated in FIGS. 3 and 5-6. In aspects, as shown, the third surface area 233 of the second portion 231 can comprise a planar surface, and/or the fourth surface area 235 of the second portion 231 can comprise a planar surface. In further aspects, the third surface area 233 of the second portion 231 can be in a common plane with the first surface area 223 of the first portion 221. In further aspects, as shown, the fourth surface area 235 can be parallel to the third surface area 233. In further aspects, the fourth surface area 235 of the second portion 231 can be in a common plane with the second surface area 225 of the first portion 221. A second thickness can be defined between the third surface area 233 of the second portion 231 and the fourth surface area 235 of the second portion 231. In aspects, the second thickness can be within the range discussed above with regards to the substrate thickness 207. In further aspects, the second thickness can comprise the substrate thickness 207 and/or be substantially equal to the substrate thickness 207 (e.g., first thickness). In aspects, the second thickness of the second portion 231 may be substantially uniform between the third surface area 233 and the fourth surface area 235.

As shown in FIGS. 2-4, the foldable substrate 201 can comprise a central portion 281 positioned between the first portion 221 and the second portion 231. The central portion 281 comprises a first central surface area 213 and a second central surface area 243 opposite the first central surface area 213. As shown, the first central surface area 213 can be positioned between the first surface area 223 and the third surface area 233. In further aspects, the first central surface area 213 can correspond to a central region 248 of the central portion 281. In further aspects, as shown, the first central surface area 213 can extend along a third plane 204b when the foldable apparatus 101, 301, and/or 401 is in a flat configuration. A first recess 211 can be defined between the first central surface area 213 (e.g., third plane 204b) and the first plane 204a.

In aspects, the third plane 204b can be substantially parallel to the first plane 204a and/or the second plane 206a. In further aspects, as shown in FIGS. 2-3, the first central surface area 213 can be recessed from the first major surface 203 by a first distance 219. In further aspects, the first distance 219 that the first central surface area 213 is recessed from the first plane 204a can be 5 μm or more, 10 μm or more, 25 μm or more, 40 μm or more, 60 μm or more, 75 μm or more, 100 μm or more, 125 μm or more, 150 μm or more, 200 μm or more, 250 μm or more, 1 mm or less, 800 μm or less, 500 μm or less, 300 μm or less, 200 μm or less, 150 μm or less, 100 μm or less, 75 μm or less, or 40 μm or less. In further aspects, the first distance 219 can range from 5 μm to 1 mm, from 10 μm to 800 μm, from 25 μm to 500 μm, from 40 μm to 300 μm, from 60 μm to 200 μm, from 75 μm to 150 μm, from 75 μm to 100 μm, or any range or subrange therebetween. In further aspects, the first distance 219, as a percentage of the substrate thickness 207, can be 1% or more, 2% or more, 5% or more, 10% or more, 15% or more, 20% or more, 25% or more, 70% or less, 60% or less, 50% or less, 40% or less, 35% or less, or 30% or less. In further aspects, the first distance 219, as a percentage of the substrate thickness 207, can range from 1% to 70%, from 2% to 60%, from 5% to 60%, from 10% to 50%, from 15% to 45%, from 20% to 35%, from 25% to 30%, or any range or subrange therebetween.

As shown in FIGS. 2-4, the second central surface area 243 of the central portion 281 is positioned between the second surface area 225 and the fourth surface area 235. In aspects, as shown in FIG. 3, the second central surface area 243 can extend along the second plane 206a. In further aspects, as shown, the second central surface area 243 can be coplanar (e.g., flush) with the second major surface 205 (i.e., extend along the second plane 206a). In further aspects, as shown, the second major surface 205 can comprise the second central surface area 243 in addition to the second surface area 225 and the fourth surface area 235. Alternatively, in aspects, as shown in FIG. 2, the second central surface area 243 can extend along a fourth plane 206b (e.g., different than the second plane 206a) when the foldable apparatus 101 and/or 301 is in a flat configuration. In further aspects, a second recess 241 is defined between the second central surface area 243 (e.g., fourth plane 206b) and the second plane 206a.

In aspects, as shown in FIG. 2, the second central surface area 243 can be recessed from the second major surface 205 by a second distance 249. In further aspects, the second distance 249 can be within one or more of the ranges discussed above for the first distance 219. In further aspects, the first distance can be greater than the second distance. In even further aspects, the second distance 249 that the second central surface area 243 is recessed from the second plane 206a, as a percentage of the substrate thickness 207, can be 20% or more, 25% or more, 30% or more, 35% or more, 40% or more, 45% or less, 40% or less, 35% or less, 30% or less, 25% or less, 20% or less, 18% or less, or 15% or less. In even further aspects, the second distance 249, as a percentage of the substrate thickness 207, can range from 20% to 45%, from 25% to 40%, from 30% to 35%, or any range or subrange therebetween. In further aspects, as shown in FIG. 2, the first distance 219 can be substantially equal to the second distance 249. Providing the first distance substantially equal to the second distance can further reduce the incidence of mechanical instabilities in the central portion, for example, because the foldable substrate is symmetric about a plane comprising a midpoint in the substrate thickness and the central thickness.

A central thickness 209 can be defined between the first central surface area 213 and the second central surface area 243 as the distance between the third plane 204b and the fourth plane 206b. In aspects, the central thickness 209 can be 25 μm or more, 40 μm or more, 60 μm or more, 100 μm or more, 150 μm or more, 200 μm or more, 300 μm or less, 200 μm or less, 150 μm or less, 120 μm or less, 100 μm or less, 80 μm or less, 60 μm or less, or 50 μm or less. In aspects, the central thickness 209 can range from 25 μm to 300 μm, from 40 μm to 200 μm, from 60 μm to 150 μm, from 100 μm to 120 μm, or any range or subrange therebetween. In aspects, the central thickness 209 can be less than or equal to 120 μm, for example, from 25 μm to 120 μm, from 40 μm to 100 μm, from 60 μm to 80 μm, or any range or subrange therebetween. In aspects, the central thickness 209 can be less than the substrate thickness 207 by 10 μm or more, 20 μm or more, 30 μm or more, 40 μm or more, 50 μm or more, 75 μm or more, 100 μm or more, 150 μm or more, or 200 μm or more. In aspects, the central thickness 209 as a percentage of the substrate thickness 207 can be 0.5% or more, 1% or more, 2% or more, 5% or more, 10% or more, 40% or less, 30% or less, 25% or less, 20% or less, 13% or less, 10% or less, or 8% or less. In aspects, the central thickness 209 as a percentage of the substrate thickness 207 can range from 0.5% to 40%, from 1% to 30%, from 2% to 25%, from 5% to 20%, from 10% to 13%, or any range or subrange therebetween. In aspects, the central region 248 of the central portion 281 can correspond to a region comprising the central thickness 209. By providing the first central surface area 213 of the central portion 281 extending along the third plane 204b parallel to the second central surface area 243 of the central portion 281 extending along the fourth plane 206b, a uniform central thickness 209 may extend across the central portion 281 that can provide enhanced folding performance at a predetermined thickness for the central thickness 209. A uniform central thickness 209 across the central portion 281 can improve folding performance by preventing stress concentrations that would occur if a portion of the central portion 281 was thinner than the rest of the central portion 281.

In aspects, as shown in FIGS. 2-3, the central portion 281 of the foldable substrate 201 can comprise a first transition region 212 comprising a first transition surface area 215 extending between the first surface area 223 and the first central surface area 213. In further aspects, as shown, a width (e.g., first transition width 214) of the first transition region 212 corresponding to the minimum distance in a direction 106 of the length 105 (see FIG. 1) between a portion of the first central surface area 213 extending along the third plane 204b and a portion of the first surface area 223. In even further aspects, the first transition width 214 of the first transition region 212 can be 0.15 mm or more, 0.3 mm or more, 0.5 mm or more, 0.6 mm or more, 0.7 mm or more, 0.8 mm or more, 2 mm or less, 1.8 mm or less, 1.5 mm or less, 1.2 mm or less, 1 mm or less, 0.8 mm or less, 0.7 mm or less, or 0.5 mm or less. In even further aspects, the first transition width 214 of the first transition region 212 can range from 0.15 mm to 2 mm, from 0.3 mm to 2 mm, from 0.5 mm to 1.8 mm, from 0.6 mm to 1.5 mm, from 0.7 mm to 1.2 mm, from 0.8 mm to 1 mm, or any range or subrange therebetween. In aspects, as shown in FIGS. 2-3, the first transition region 212 can comprise a second transition surface area 245 extending between the second surface area 225 and the second central surface area 243. A width of the second transition surface area 245 corresponding to the minimum distance in a direction 106 of the length 105 (see FIG. 1) between a portion of the second central surface area 243 extending along the fourth plane 206b and a portion of the second surface area 225 can be within one or more of the ranges discussed above for the first transition width 214 and/or substantially equal to the first transition width 214.

In aspects, as shown in FIGS. 2-3, a thickness of the first transition region 212 can decrease between the substrate thickness 207 of the first portion 221 and the central thickness 209 of the central portion 281. In further aspects, as shown, a thickness of the first transition region 212 can smoothly decrease, monotonically decrease, and/or smoothly and monotonically decrease (e.g., linearly change) between the substrate thickness 207 of the first portion 221 and the central thickness 209 of the central portion 281. As used herein, a thickness decreases smoothly if changes in the cross-sectional area are smooth (e.g., gradual) rather than abrupt (e.g., step) changes in thickness. As used herein, a thickness decreases monotonically in a direction if the thickness decreases for a portion and for the rest of the time either stays the same, decreases, or a combination thereof (i.e., the thickness decreases but never increases in the direction). A smooth shape of the first transition region and/or the second transition region can reduce optical distortions. In aspects, as shown in FIGS. 2-3, the first transition surface area 215 can comprise a linearly inclined surface extending between the first central surface area 213 and the first surface area 223. In aspects, although not shown, the first transition surface area can comprise a concave up shape, for example, with a local slope of the first transition surface area smoothly transitioning to a slope of the first central surface area 213 while a local slope of the first transition surface area is substantially different from a slope of the first surface area 223. In aspects, although not shown, the first transition surface area can comprise a sigmoid shape. In aspects, although not shown, a local slope of the first transition surface area can be greater at a midpoint of the first transition surface area than where the first transition surface area meets the first central surface area 213 and where the first transition surface area meets the first surface area 223. In aspects, although not shown, the first transition surface area can comprise a convex up shape, for example, with a local slope of the first transition surface area smoothly transitioning to a slope of the first surface area 223 while a local slope of the first transition surface area is substantially different from a slope of the first central surface area 213. In aspects, the second transition surface area can comprise one of the shapes or properties discussed above in this paragraph for the first transition surface area. For example, as shown in FIG. 2, the second transition surface area 245 can comprise a linearly inclined surface extending between the second central surface area 243 and the second surface area 225.

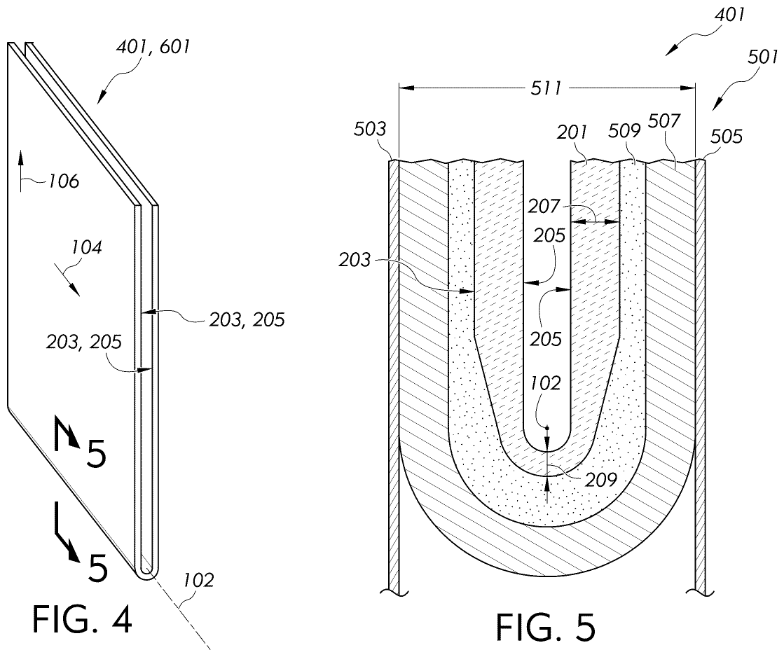

In aspects, as shown in FIGS. 2-3, the central portion 281 of the foldable substrate 201 can comprise a second transition region 218 comprising a third transition surface area 217 extending between the third surface area 233 and the first central surface area 213. In further aspects, as shown, a width (e.g., second transition width 216) of the second transition region 218 can be measured as the minimum distance in a direction 106 of the length 105 (see FIG. 1) between a portion of the first central surface area 213 extending along the third plane 204b and a portion of the third surface area 233. In even further aspects, the second transition width 216 of the second transition region 218 can be within one or more of the ranges discussed above for the first transition width 214. In still further aspects, the second transition width 216 of the second transition region 218 can be substantially equal to (e.g., equal to) the first transition width 214. In aspects, as shown in FIGS. 2-3, the second transition region 218 can comprise a fourth transition surface area 247 extending between the fourth surface area 235 and the second central surface area 243. In further aspects, a width of the fourth transition surface area 247 can be measured as the minimum distance in a direction 106 of the length 105 (see FIG. 1) between a portion of the second central surface area 243 extending along the fourth plane 206b and a portion of the fourth surface area 235. In even further aspects, the width of the fourth transition surface area 247 can be substantially equal to (e.g., equal to) the second transition width 216. In aspects, as shown in FIGS. 2-3, a thickness of the second transition region 218 can decrease between the substrate thickness 207 of the second portion 231 and the central thickness 209 of the central portion 281. In further aspects, as shown, a thickness of the first transition region 212 can smoothly decrease, monotonically decrease, or smoothly and monotonically decrease (e.g., linearly change) between the substrate thickness 207 of the second portion 231 and the central thickness 209 of the central portion 281. In aspects, as shown in FIG. 4, the portion of the second transition region 218 extending between the fourth surface area 235 and the second central surface area 243 can be coplanar with one or both surface areas.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other.

As shown in FIGS. 2-3, the foldable apparatus 101 and 301 can comprise an adhesive layer 261. As shown, the adhesive layer 261 can comprise a first contact surface 263 and a second contact surface 265 that can be opposite the first contact surface 263. In aspects, as shown in FIGS. 2-3, the second contact surface 265 of the adhesive layer 261 and/or the first contact surface 263 of the adhesive layer 261 can comprise a planar surface. An adhesive thickness 267 of the adhesive layer 261 can be defined as a minimum distance between the first contact surface 263 and the second contact surface 265. In aspects, the adhesive thickness 267 of the adhesive layer 261 can be 1 μm or more, 5 μm or more, 10 μm or more, 100 μm or less, 60 μm or less, 30 μm or less, or 20 μm or less. In aspects, the adhesive thickness 267 of the adhesive layer 261 can range from 1 μm to 100 μm, from 5 μm to 60 μm, from 10 μm to 30 μm, from 10 μm to 20 μm, or any range or subrange therebetween.

In aspects, as shown in FIGS. 2-3, the second contact surface 265 of the adhesive layer 261 can face and/or contact the first major surface 273 of a release liner 271 (described below). In aspects, as shown in FIG. 2, the first contact surface 263 of the adhesive layer 261 can face and/or contact the second surface area 225 of the first portion 221. In aspects, as shown in FIG. 2, the first contact surface 263 of the adhesive layer 261 can face and/or contact the second surface area 225 and/or the fourth surface area 235 (e.g., second major surface 205). In aspects, as shown in FIG. 2, the first contact surface 263 of the adhesive layer 261 can face the second central surface area 243 of the central portion 281. In aspects, as shown in FIG. 3, the first contact surface 263 of the adhesive layer 261 can face and/or contact the first surface area 223 and/or the third surface area 233 (e.g., first major surface 203). In aspects, as shown in FIG. 3, the first contact surface 263 of the adhesive layer 261 can face the first central surface area 213 of the central portion 281. In further aspects, although not shown, the first contact surface 263 of the adhesive layer 261 can contact the first central surface area 213 or the second central surface area 243, for example by filling the region (e.g., first recess 211, second recess 241) indicated as occupied by the adjacent polymer-based portion in FIGS. 2-3, respectively. In aspects, although not shown, the second recess may not be totally filled, for example, to leave room for electronic devices and/or mechanical devices. In aspects, although not shown, the foldable substrate 201 of FIG. 3 can be configured with the adhesive layer 261 contacting the second major surface 205 rather than the first major surface 203 while the second polymer-based portion 299 or a coating 251 in place of the second polymer-based portion 299 can be positioned at least partially in the first recess 211.

In aspects, the adhesive layer 261 can comprise a polyolefin, a polyamide, a halide-containing polymer (e.g., polyvinylchloride or a fluorine-containing polymer), an elastomer, a urethane, phenolic resin, parylene, polyethylene terephthalate (PET), polyether ether ketone (PEEK), or combinations or copolymers thereof. Example aspects of polyolefins include polyethylenes and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber), and block copolymers (e.g., styrene-butadiene, high-impact polystyrene, poly(dichlorophosphazene). In further aspects, the adhesive layer 261 can comprise an optically clear adhesive. In even further aspects, the optically clear adhesive can comprise one or more optically transparent polymers: an acrylic (e.g., polymethylmethacrylate (PMMA)), an epoxy, silicone, and/or a polyurethane. Examples of epoxies include bisphenol-based epoxy resins, novolac-based epoxies, cycloaliphatic-based epoxies, and glycidylamine-based epoxies. In even further aspects, the optically clear adhesive can comprise, but is not limited to acrylic adhesives, for example, 3M 8212 adhesive, or an optically transparent liquid adhesive, for example, a LOCTITE optically transparent liquid adhesive. Exemplary aspects of optically clear adhesives comprise transparent acrylics, epoxies, silicones, and polyurethanes. For example, the optically transparent liquid adhesive could comprise one or more of LOCTITE AD 8650, LOCTITE AA 3922, LOCTITE EA E-05MR, LOCTITE UK U-09LV, which are all available from Henkel. In aspects, the adhesive layer 261 can comprise an elastic modulus of 0.001 MegaPascals (MPa) or more, 0.01 MPa or more, 0.1 MPa or more, 1 MPa or less, 0.5 MPa or less, 0.1 MPa or less, or 0.05 MPa or less. In aspects, the adhesive layer 261 can comprise an elastic modulus in a range from 0.001 MPa to 1 MPa, from 0.01 MPa to 0.5 MPa, from 0.1 MPa to 0.5 MPa, or any range or subrange therebetween. In aspects, the adhesive layer can comprise an elastic modulus within one or more of the ranges discussed below for the elastic modulus of the polymer-based portions 289 and/or 299.

As shown in FIGS. 2-3, the polymer-based portion 289 and/or 299 of the foldable apparatus 101 can be positioned between the first portion 221 and the second portion 231. In aspects, as shown, the polymer-based portion can comprise a first polymer-based portion 289 at least partially positioned in and/or filling the first recess 211. In aspects, as shown in FIG. 2, the polymer-based portion can comprise a second polymer-based portion 299 at least partially positioned in and/or filling the second recess 241. In aspects, as shown in FIG. 2, the polymer-based portion can comprise a second polymer-based portion 299 at least partially positioned in and/or filling the first recess 211. In aspects, although not shown, the second recess may not be totally filled, for example, to leave room for electronic devices and/or mechanical devices.

As shown in FIG. 2, the first polymer-based portion 289 can comprise a fourth contact surface 285 opposite the third contact surface 283. In aspects, as shown, the third contact surface 283 can comprise a planar surface, for example, substantially coplanar (e.g., extend along a common plane, first plane 204a) with the first surface area 223 and the third surface area 233. In aspects, as shown in FIG. 2, the fourth major surface 255 of the coating 251 can face and/or contact the third contact surface 283 of the first polymer-based portion 289. In aspects, the fourth contact surface 285 can comprise a planar surface, for example, substantially coplanar (e.g., extend along a common plane, third plane 204b) with the first central surface area 213. In further aspects, the fourth contact surface 285 can contact the first central surface area 213, the first transition surface area 215, and/or the third transition surface area 217.

As shown in FIGS. 2-3, the second polymer-based portion 299 can comprise a fourth contact surface 295 opposite the third contact surface 293. In further aspects, as shown in FIG. 2, the third contact surface 293 can contact the second central surface area 243, the second transition surface area 245, and/or the fourth transition surface area 247. In aspects, as shown in FIG. 2, the third contact surface 293 can comprise a planar surface, for example, being substantially coplanar (e.g., extend along a common plane with the fourth plane 206b) with the second central surface area 243. In aspects, as shown in FIG. 2, the fourth contact surface 295 can comprise a planar surface, for example, being substantially coplanar (e.g., extend along a common plane with the second plane 206a) with the second surface area 225 and the fourth surface area 235.

In aspects, as shown in FIG. 3, the third contact surface 293 can contact the first central surface area 213, the first transition surface area 215, and/or the third transition surface area 217. In aspects, as shown in FIG. 3, the third contact surface 293 can comprise a planar surface, for example, being substantially coplanar (e.g., extend along a common plane with the third plane 204b) with the first central surface area 213. In aspects, as shown, the third contact surface 293 can comprise a planar surface, for example, substantially coplanar (e.g., extend along a common plane with the third plane 204b) with the first central surface area 213. In aspects, as shown in FIG. 3, the fourth contact surface 295 can be coplanar (e.g., extend along a common plane with the first plane 204a) with the first surface area 223 and the third surface area 233. In aspects, as shown in FIGS. 2-3, the first contact surface 263 of the adhesive layer 261 can face and/or contact the fourth contact surface 295 of the second polymer-based portion 299.

In aspects, the polymer-based portion 289 and/or 299 comprises a polymer (e.g., optically transparent polymer). In further aspects, the polymer-based portion 289 and/or 299 can comprise one or more of an optically transparent: an acrylic (e.g., polymethylmethacrylate (PMMA)), an epoxy, a silicone, and/or a polyurethane. Examples of epoxies include bisphenol-based epoxy resins, novolac-based epoxies, cycloaliphatic-based epoxies, and glycidylamine-based epoxies. In further aspects, the polymer-based portion 289 and/or 299 comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example aspects of elastomers include rubbers and block copolymers, for example, comprising one or more of polystyrene, polydichlorophosphazene, and poly(5-ethylidene-2-norbornene). In aspects, the polymer-based portion can comprise a sol-gel material. Example aspects of polyurethanes comprise thermoset polyurethanes, for example, Dispurez 102 available from Incorez and thermoplastic polyurethanes, for example, KrystalFlex PE505 available from Huntsman. In even further aspects, the second portion can comprise an ethylene acid copolymer. An exemplary aspect of an ethylene acid copolymer includes SURLYN available from Dow (e.g., Surlyn PC-2000, Surlyn 8940, Surlyn 8150). An additional exemplary aspect for the second portion comprises Eleglass w802-GL044 available from Axalta with from 1 wt % to 2 wt % cross-linker. In aspects, the polymer-based portion 289 and/or 299 can further comprise nanoparticles, for example, carbon black, carbon nanotubes, silica nanoparticles, or nanoparticles comprising a polymer. In aspects, the polymer-based portion can further comprise fibers to form a polymer-fiber composite.

In aspects, the polymer-based portion 289 and/or 299 can comprise an elastic modulus of 0.001 MegaPascals (MPa) or more, 0.01 MPa or more, 1 MPa or more, 10 MPa or more, 20 MPa or more, 100 MPa or more, 200 MPa or more, 1,000 MPa or more, 5,000 MPa or less, 3,000 MPa or less, 1,000 MPa or less, 500 MPa or less, or 200 MPa or less. In aspects, the polymer-based portion 289 and/or 299 can comprise an elastic modulus in a range from 0.001 MPa to 5,000 MPa, from 0.01 MPa to 3,000 MPa, from 0.01 MPa to 1,000 MPa, from 1 MPa to 200 MPa, from 10 MPa to 200 MPa, from 100 MPa to 200 MPa, or any range or subrange therebetween. In aspects, the adhesive layer 261 comprises an elastic modulus greater than the elastic modulus of the polymer-based portion 289 and/or 299, which arrangement provides improved performance in puncture resistance. In aspects, the elastic modulus of the polymer-based portion 289 and/or 299 can be less than the elastic modulus of the foldable substrate 201. In aspects, the adhesive layer 261 may comprise an elastic modulus within the ranges listed above in this paragraph. In further aspects, the adhesive layer 261 may comprise substantially the same elastic modulus as the elastic modulus of the polymer-based portion 289 and/or 299. In aspects, the elastic modulus of the polymer-based portion 289 and/or 299 can be less than the elastic modulus of the foldable substrate 201.

In aspects, as shown in FIG. 2, a coating 251 can be disposed over the first major surface 203 of the foldable substrate 201. In further aspects, the coating 251 can be disposed over the first portion 221, the second portion 231, and the central portion 281. In aspects, the coating 251 can comprise a third major surface 253 and a fourth major surface 255 opposite the third major surface 253. In further aspects, the coating 251 (e.g., fourth major surface 255) can contact the foldable substrate 201 (e.g., first major surface 203). In further aspects, at least a part of the coating 251 can be positioned in the first recess 211. In even further aspects, the coating 251 can fill the first recess 211. In further aspects, the coating 251 can comprise a coating thickness 257 defined between the third major surface 253 and the fourth major surface 255. In further aspects, the coating thickness 257 can be 0.1 μm or more, 1 μm or more, 5 μm or more, 10 μm or more, 20 μm or more, 25 μm or more, 40 μm or more, 80 μm or more, 200 μm or less, 100 μm or less, or 50 μm or less, 25 μm or less, 20 μm or less, 20 μm or less, 15 μm or less, or 10 μm or less. In aspects, the coating thickness 257 can range from 0.1 μm to 200 μm, from 1 μm to 100 μm, from 10 μm to 50 μm, from 20 μm to 50 μm, or any range or subrange therebetween.

In aspects, the coating 251 can comprise a polymeric hard coating. In further aspects, the polymeric hard coating can comprise one or more of an ethylene-acid copolymer, a polyurethane-based polymer, an acrylate resin, and a mercapto-ester resin. Example aspects of ethylene-acid copolymers include ethylene-acrylic acid copolymers, ethylene-methacrylic acid copolymers, and ethylene-acrylic-methacrylic acid terpolymers (e.g., Nucrel, manufactured by DuPont), ionomers of ethylene acid copolymers (e.g., Surlyn, manufactured by DuPont), and ethylene-acrylic acid copolymer amine dispersions (e.g., Aquacer, manufactured by BYK). Example aspects of polyurethane-based polymers include aqueous modified polyurethane dispersions (e.g., Eleglas®, manufactured by Axalta). Example aspects of acrylate resins that can be UV curable include acrylate resins (e.g., Uvekol® resin, manufactured by Allinex), cyanoacrylate adhesives (e.g., Permabond® UV620, manufactured by Krayden), and UV radical acrylic resins (e.g., Ultrabond windshield repair resin, for example, Ultrabond (45CPS)). Example aspects of mercapto-ester resins include mercapto-ester triallyl isocyanurates (e.g., Norland optical adhesive NOA 61). In further aspects, the polymeric hard coating can comprise ethylene-acrylic acid copolymers and ethylene-methacrylic acid copolymers, which may be ionomerized to form ionomer resins through neutralization of the carboxylic acid residue with typically alkali-metal ions, for example, sodium and potassium, and also zinc. Such ethylene-acrylic acid and ethylene-methacrylic acid ionomers may be dispersed in water and coated onto the substrate to form an ionomer coating. Alternatively, such acid copolymers may be neutralized with ammonia which, after coating and drying liberates the ammonia to reform the acid copolymer as the coating. By providing a coating comprising a polymeric coating, the foldable apparatus can comprise low energy fracture.

In aspects, the coating can comprise a polymeric hard coating comprising an optically transparent polymeric hard-coat layer. Suitable materials for an optically transparent polymeric hard-coat layer include but are not limited to a cured acrylate resin material, an inorganic-organic hybrid polymeric material, an aliphatic or aromatic hexafunctional urethane acrylate, a siloxane-based hybrid material, and a nanocomposite material, for example, an epoxy and urethane material with nanosilicate. In aspects, an optically transparent polymeric hard-coat layer may consist essentially of one or more of these materials. In aspects, an optically transparent polymeric hard-coat layer may consist of one or more of these materials. As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. More specifically, suitable materials for an optically transparent polymeric (OTP) hard-coat layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In aspects, an OTP hard-coat layer may consist essentially of an organic polymer material, an inorganic-organic hybrid polymeric material, or aliphatic or aromatic hexafunctional urethane acrylate. In aspects, an OTP hard-coat layer may consist of a polyimide, an organic polymer material, an inorganic-organic hybrid polymeric material, or aliphatic or aromatic hexafunctional urethane acrylate. In aspects, an OTP hard-coat layer may include a nanocomposite material. In aspects, an OTP hard-coat layer may include a nano-silicate at least one of epoxy and urethane materials. Suitable compositions for such an OTP hard-coat layer are described in U.S. Pat. Pub. No. 2015/0110990, which is hereby incorporated by reference in its entirety by reference thereto. As used herein, “organic polymer material” means a polymeric material comprising monomers with only organic components. In aspects, an OTP hard-coat layer may comprise an organic polymer material manufactured by Gunze Limited and having a hardness of 9H, for example Gunze's “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. In aspects, the inorganic-organic hybrid polymeric material may include polymerized monomers comprising an inorganic silicon-based group, for example, a silsesquioxane polymer. A silsesquioxane polymer may be, for example, an alkyl-silsesquioxane, an aryl-silsesquioxane, or an aryl alkyl-silsesquioxane having the following chemical structure: (RSiO_{1.5})ₙ, where R is an organic group for example, but not limited to, methyl or phenyl. In aspects, an OTP hard-coat layer may comprise a silsesquioxane polymer combined with an organic matrix, for example, SILPLUS manufactured by Nippon Steel Chemical Co., Ltd. In aspects, an OTP hard-coat layer may comprise 90 wt % to 95 wt % aromatic hexafunctional urethane acrylate (e.g., PU662NT (Aromatic hexafunctional urethane acrylate) manufactured by Miwon Specialty Chemical Co.) and 10 wt % to 5 wt % photo-initiator (e.g., Darocur 1173 manufactured by Ciba Specialty Chemicals Corporation) with a hardness of 8H or more. In aspects, an OTP hard-coat layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate. In aspects, an OTP hard-coat layer may be an aliphatic or aromatic hexafunctional urethane acrylate material layer having a thickness within one or more of the thickness ranges discussed above for the coating thickness 257.

In aspects, the coating 251, if provided, may also comprise one or more of an easy-to-clean coating, a low-friction coating, an oleophobic coating, a diamond-like coating, a scratch-resistant coating, or an abrasion-resistant coating. A scratch-resistant coating may comprise an oxynitride, for example, aluminum oxynitride or silicon oxynitride with a thickness of 500 micrometers or more. In such aspects, the abrasion-resistant layer may comprise the same material as the scratch-resistant layer. In aspects, a low friction coating may comprise a highly fluorinated silane coupling agent, for example, an alkyl fluorosilane with oxymethyl groups pendant on the silicon atom. In such aspects, an easy-to-clean coating may comprise the same material as the low friction coating. In other aspects, the easy-to-clean coating may comprise a protonatable group, for example an amine, for example, an alkyl aminosilane with oxymethyl groups pendant on the silicon atom. In such aspects, the oleophobic coating may comprise the same material as the easy-to-clean coating. In aspects, a diamond-like coating comprises carbon and may be created by applying a high voltage potential in the presence of a hydrocarbon plasma.

In aspects, as shown in FIGS. 2-3, the foldable apparatus 101 can comprise the release liner 271 although other substrates (e.g., glass-based substrate and/or ceramic-based substrate discussed throughout the application) may be used in further aspects rather than the illustrated release liner 271. In further aspects, as shown, the release liner 271, or another substrate, can be disposed over the adhesive layer 261. In even further aspects, as shown, the release liner 271, or another substrate, can directly contact the second contact surface 265 of the adhesive layer 261. The release liner 271, or another substrate, can comprise a first major surface 273 and a second major surface 275 opposite the first major surface 273. As shown, the release liner 271, or another substrate, can be disposed on the adhesive layer 261 by attaching the second contact surface 265 of the adhesive layer 261 to the first major surface 273 of the release liner 271, or another substrate. In aspects, as shown, the first major surface 273 of the release liner 271, or another substrate, can comprise a planar surface. In aspects, as shown, the second major surface 275 of the release liner 271, or another substrate, can comprise a planar surface. A substrate comprising the release liner 271 can comprise a paper and/or a polymer, for example polyesters (e.g., polyethylene terephthalate (PET)) and polyolefins.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise liquid crystal display (LCD), an electrophoretic displays (EPD), an organic light-emitting diode (OLED) display, or a plasma display panel (PDP). The consumer electronic product can comprise a cover substrate disposed over the display. In aspects, at least one of a portion of the housing or the cover substrate comprises the foldable apparatus discussed throughout the disclosure. The consumer electronic product can comprise a portable electronic device, for example, a smartphone, a tablet, a wearable device, or a laptop.

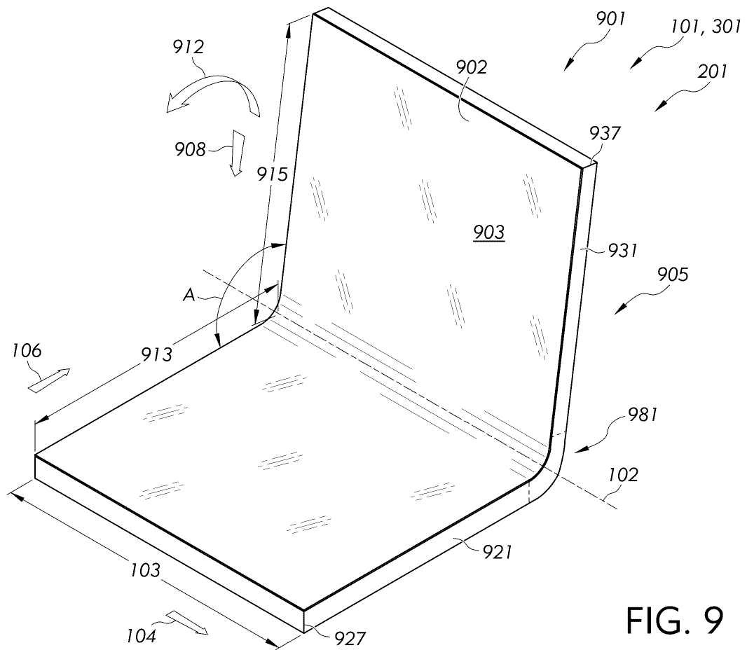

Also, FIG. 9 schematically shows a perspective view of a consumer electronic product 901 that is foldable. The consumer electronic product 901 can include the foldable apparatus 101 and/or 301 and/or the foldable substrate 201 in accordance with aspects of the present disclosure. As shown, the consumer electronic product 901 can include a front surface 903 and a side surface 905. The consumer electronic product 901 can include electronic components, including a display 902 that can be viewed through the front surface 903. In aspects, as shown, the consumer electronic product 901 can be folded in a direction 912 to form a folded configuration that brings a first end 927 and a second end 937 (opposite the first end 927) closer together (than in the unfolded configuration). Additionally, as shown, the consumer electronic product 901 can be folded so that the front surface 903 and/or display 902 faces itself, although the consumer electronic product could be folded opposite the direction 912 so that the front surface 903 is on the outside of the consumer electronic product in the folded configuration. The consumer electronic product 901 shown in FIG. 9 can be folded about the fold axis 102, where a central portion 981 is located between a first portion 921 including the first end 927 and a second portion 931 including the second end 937. A location of the fold axis 102 can determine a first distance 913 between the first end 927 and the fold axis 102 (e.g., in direction 106) relative to a second distance 915 between the second end 937 and the fold axis 102 (e.g., in direction 908). A total length of the consumer electronic product (e.g., length 105 in FIG. 1) can be the sum of the first distance 913 and the second distance 915). Also, as shown, the consumer electronic product is depicted as being in a folded or partially folded configuration with an angle A formed by front surface 903 about the fold axis 102.

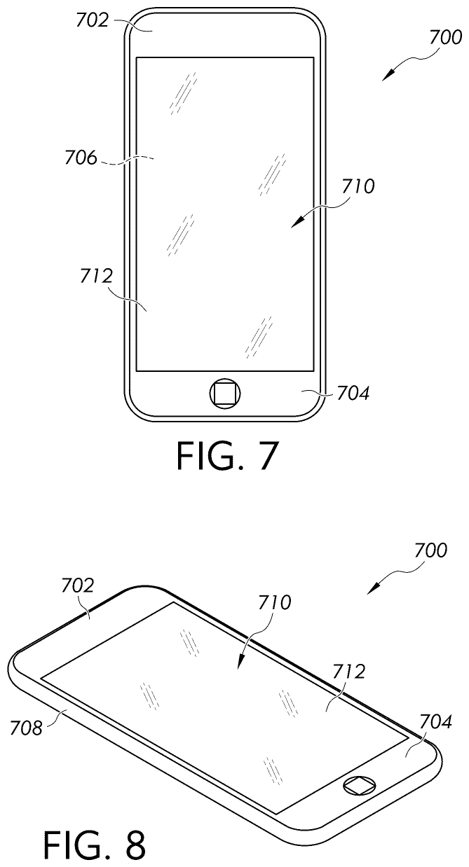

The foldable apparatus disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus disclosed herein is shown in FIGS. 7-8. Specifically, FIGS. 7-8 show a consumer electronic device 700 including a housing 702 having front 704, back 706, and side surfaces 708. Although not shown, the consumer electronic device can comprise electrical components that are at least partially inside or entirely within the housing. For example, electrical components include at least a controller, a memory, and a display. As shown in FIGS. 7-8, the display 710 can be at or adjacent to the front surface of the housing 702. The consumer electronic device can comprise a cover substrate 712 at or over the front surface of the housing 702 such that it is over the display 710. In aspects, at least one of the cover substrate 712 or a portion of housing 702 may include any of the foldable apparatus disclosed herein, for example, the foldable substrate.

In aspects, the foldable substrate 201 comprising a glass-based substrate and/or a ceramic-based substrate, and the first portion 221, the second portion 231, and/or the central portion 281 can comprise one or more compressive stress regions. In aspects, a compressive stress region may be created by chemically strengthening. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the first portion 221, the second portion 231, and/or the central portion 281 can enable good impact and/or puncture resistance (e.g., resists failure for a pen drop height of 15 centimeters (cm) or more, 20 cm or more, 50 cm or more). Without wishing to be bound by theory, chemically strengthening the first portion 221, the second portion 231, and/or the central portion 281 can enable small (e.g., smaller than 10 mm or less) parallel plate distance because the compressive stress from the chemical strengthening can counteract the bend-induced tensile stress on the outermost surface of the substrate. A compressive stress region may extend into a portion of the first portion and/or the second portion for a depth called the depth of compression (DOC). As used herein, depth of compression means the depth at which the stress in the chemically strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than 400 μm, SCALP is used to measure the depth of compression and central tension (CT). Where the stress in the substrate and/or portion is generated by exchanging both potassium and sodium ions into the substrate and/or portion, and the article being measured is thicker than 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate and/or portion (e.g., sodium, potassium). Throughout the disclosure, DOL is measured in accordance with ASTM C-1422. Without wishing to be bound by theory, a DOL is usually greater than or equal to the corresponding DOC. Through the disclosure, when the maximum central tension cannot be measured directly by SCALP (as when the article being measured is thinner than 400 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the first portion 221 may comprise a first compressive stress region at the first surface area 223 extending to a first depth of compression from the first surface area 223 and/or a second compressive stress region at the second surface area 225 extending to a second depth of compression from the second surface area 225. In aspects, the first depth of compression and/or the second depth of compression, as a percentage of the substrate thickness 207, can be 5% or more, 10% or more, 12% or more, 15% or more, 30% or less, 25% or less, 22% or less, 20% or less, 17% or less, or 15% or less. In aspects, the first depth of compression and/or the second depth of compression, as a percentage of the substrate thickness 207, can range from 5% to 30%, from 10% to 25%, from 10% to 22%, from 12% to 20%, from 15% to 17%, or any range or subrange therebetween. In preferred aspects, the first depth of compression and/or the second depth of compression, as a percentage of the substrate thickness 207, can range from 5% to 30%, from 10% to 25%, or from 15% to 20%. In aspects, the first depth of compression and/or the second depth of compression can be 1 μm or more, 10 μm or more, 15 μm or more, 20 μm or more, 25 μm or more, 30 μm or more, 200 μm or less, 150 μm or less, 100 μm or less, 60 μm or less, 45 μm or less, 30 μm or less, or 20 μm or less. In aspects, the first depth of compression and/or the second depth of compression can range from 1 μm to 200 μm, from 1 μm to 150 μm, from 10 μm to 100 μm, from 15 μm to 60 μm, from 20 μm to 45 μm, from 20 μm to 30 μm, or any range or subrange therebetween. By providing a first portion comprising a first glass-based and/or ceramic-based portion comprising a first depth of compression and/or a second depth of compression in a range from 1% to 30% of the first thickness, good impact and/or puncture resistance can be enabled.

In aspects, the first compressive stress region can comprise a first maximum compressive stress, and/or the second compressive stress region can comprise a second maximum compressive stress. In further aspects, the first maximum compressive stress and/or the second maximum compressive stress can be 600 MegaPascals (MPa) or more, 700 MPa or more, 750 MPa or more, 800 MPa or more, 850 MPa or more, 900 MPa or more, 1,500 MPa or less, 1,300 MPa or less, 1,200 MPa or less, 1,000 MPa or less, 900 MPa or less, or 800 MPa or less. In further aspects, the first maximum compressive stress and/or the second maximum compressive stress can range from 600 MPa to 1,500 MPa, from 700 MPa to 1,300 MPa, from 750 MPa to 1,200 MPa, from 800 MPa to 1,000 MPa, from 850 MPa to 900 MPa, or any range or subrange therebetween. By providing a first maximum compressive stress and/or a second maximum compressive stress in a range from 600 MPa to 1,500 MPa, good impact and/or puncture resistance can be enabled.

A “knee” of a stress profile is a depth of an article where the slope of the stress profile transitions from steep (in a spike region) to gradual (in a deep region). The knee may refer to a transition area over a span of depths where the slope is changing. The knee stress CSK is defined as the value of compressive stress that the deeper portion of the CS profile extrapolates to at the depth of spike (DOLsp). The DOLsp is reported as measured by a surface-stress meter by known methods. An absolute value of the slope of the stress profile in the spike region is greater than an absolute value of the slope of the stress profile in the deep region. In aspects, the spike depth of layer (DOLsp) of the first compressive stress region, as a fraction of the substrate thickness, can be 0.025 or more, 0.027 or more, 0.030 or more, 0.035 or more, 0.040 or more, 0.045 or more, or 0.050 or more, 0.055 or more, 0.060 or more, 0.075 or less, 0.070 or less, 0.065 or less, 0.060 or less, 0.055 or less, 0.050 or less, 0.045 or less, 0.040 or less, 0.035 or less, or 0.030 or less. In aspects, the spike depth of layer (DOLsp) of the first compressive stress region, as a fraction of the substrate thickness, can be greater than or equal to 0.025 to less than or equal to 0.075, from greater than or equal to 0.027 to less than or equal to 0.070, from greater than or equal to 0.030 to less than or equal to 0.065, from greater than or equal to 0.035 to less than or equal to 0.060, from greater than or equal to 0.040 to less than or equal to 0.055, from greater than or equal to 0.045 to less than or equal to 0.050, or any range or subrange therebetween.

The first portion 221 may comprise a first tensile stress region positioned between the first compressive stress region and the second compressive stress region. In aspects, the first tensile stress region can comprise a first maximum tensile stress of 10 MPa or more, 20 MPa or more, 30 MPa or more, 100 MPa or less, 80 MPa or less, or 60 MPa or less. In further aspects, the first maximum tensile stress can range from 10 MPa to 100 MPa, from 20 MPa to 80 MPa, from 30 MPa to 60 MPa, or any range or subrange therebetween. Providing a first maximum tensile stress in a range from 10 MPa to 100 MPa can enable good impact and/or puncture resistance while providing low energy fractures, as discussed below.

In aspects, the second portion 231 may comprise a third compressive stress region at the third surface area 233 extending to a third depth of compression from the third surface area 233, and/or the second portion 231 may comprise a fourth compressive stress region at the fourth surface area 235 extending to a fourth depth of compression from the fourth surface area 235. In aspects, the third depth of compression and/or the fourth depth of compression, as a percentage of the substrate thickness 207, can be within one or more of the ranges discussed above for the first depth of compression and/or the second depth of compression. In further aspects, the third depth of compression can be substantially equal to the fourth depth of compression. The third compressive stress region can comprise a third maximum compressive stress, and/or the fourth compressive stress region can comprise a fourth maximum compressive stress. In aspects, the third maximum compressive stress and/or the fourth maximum compressive stress can be within one or more of the ranges discussed above for the first maximum compressive stress and/or the second maximum compressive stress. The second portion 231 may comprise a second tensile stress region positioned between the third compressive stress region and the fourth compressive stress region. In aspects, the second tensile stress region can comprise a second maximum tensile stress that can be within one or more of the ranges discussed above for the first maximum tensile stress. In further aspects, the first maximum tensile stress can be substantially equal to the second maximum tensile stress.

In aspects, the first depth of compression can be substantially equal to the third depth of compression. In aspects, the second depth of compression can be substantially equal to the fourth depth of compression. In aspects, the first maximum compressive stress can be substantially equal to the third maximum compressive stress. In aspects, the second maximum compressive stress can be substantially equal to the fourth maximum compressive stress. In aspects, the first depth of layer of one or more alkali-metal ions can be substantially equal to the third depth of layer of one or more alkali-metal ions. In aspects, the second depth of layer of one or more alkali-metal ions can be substantially equal to the fourth depth of layer of one or more alkali-metal ions.

In aspects, the central portion 281 can comprise a first central compressive stress region at the first central surface area 213 extending to a first central depth of compression from the first central surface area 213, and/or the central portion 281 can comprise a second central compressive stress region at the second central surface area 243 extending to a second central depth of compression from the second central surface area 243. In further aspects, the first central depth of compression and/or the second central depth of compression, as a percentage of the central thickness 209, can be within one or more of the ranges discussed above for the first depth of compression and/or the second depth of compression, as a percentage of the substrate thickness 207. In further aspects, the first central depth of compression and/or the second central depth of compression as a percentage of the central thickness 209 can be 1% or more, 2% or more, 5% or more, 8% or more, 10% or more, 12% or more, 25% or less, 20% or less, 17% or less, 15% or less, 12% or less, 10% or less, 7% or less, or 5% or less. For example, the first central depth of compression and/or the second central depth of compression as a percentage of the central thickness 209 can range from 1% to 25%, from 2% to 20%, from 5% to 17%, from 7% to 12%, or any range or subrange therebetween. In further aspects, the first central depth of compression can be substantially equal to the second central depth of compression. In further aspects, the first central depth of compression and/or the second central depth of compression can be within one or more of the ranges discussed above for the first depth of compression and/or the second depth of compression. In further aspects, the first central depth of compression and/or the second central depth of compression can be 1 μm or more 2 μm or more, 4 μm or more, 6 μm or more, 20 μm or less, 15 μm or less, 10 μm or less, or 8 μm or less. For example, the first central depth of compression and/or the second central depth of compression can range from 1 μm to 20 μm, from 2 μm to 15 μm, from 4 μm to 10 μm, from 6 μm to 8 μm, or any range or subrange therebetween. By providing a central portion comprising a glass-based and/or ceramic-based portion comprising a first central depth of compression and/or a second central depth of compression in a range from 1% to 25% of the central thickness, good impact and/or puncture resistance can be enabled.

The first central compressive stress region can comprise a first central maximum compressive stress, and/or the second central compressive stress region can comprise a second central maximum compressive stress. In aspects, the first central maximum compressive stress and/or the second central maximum compressive stress can be within one or more of the ranges discussed above for the first maximum compressive stress and/or the second maximum compressive stress. By providing a first central maximum compressive stress and/or a second central maximum compressive stress in a range from 600 MPa to 1,500 MPa, good impact and/or puncture resistance can be enabled. In aspects, an absolute difference of the first maximum compressive stress and the first central maximum compressive stress can be less than or equal to 100 MPa, less than or equal to 75 MPa, less than or equal to 50 MPa, or less than or equal to 30 MPa (e.g., from greater than or equal to 0 MPa to less than or equal to 100 MPa, from greater than or equal to 5 MPa to less than or equal to 75 MPa, from greater than or equal to 10 MPa to less than or equal to 50 MPa, from greater than or equal to 20 MPa to less than or equal to 30 MPa, or any range or subrange therebetween). In further aspects, the first maximum compressive stress can be equal to the first central maximum compressive stress. In aspects, an absolute difference of the second maximum compressive stress and the second central maximum compressive stress can be within the corresponding range discussed above in this paragraph. In further aspects, the second maximum compressive stress can be equal to the second central maximum compressive stress. In aspects, an absolute difference of the first central maximum compressive stress and the second central maximum compressive stress can be within the corresponding range discussed above in this paragraph. In further aspects, the first central maximum compressive stress can be equal to the second central maximum compressive stress.

The central portion 281 may comprise a central tensile stress region positioned between the first central compressive stress region and the second central compressive stress region. In aspects, the central tensile stress region can comprise a central maximum tensile stress of 125 MPa or more, 150 MPa or more, 200 MPa or more, 375 MPa or less, 300 MPa or less, or 250 MPa or less. In further aspects, the central maximum tensile stress can range from 125 MPa to 375 MPa, from 125 MPa to 300 MPa, from 125 MPa to 250 MPa, from 150 MPa to 375 MPa, from 150 MPa to 300 MPa, from 150 MPa to 250 MPa, from 200 MPa to 375 MPa, from 200 MPa to 300 MPa, from 200 MPa to 250 MPa, or any range or subrange therebetween. Providing a central maximum tensile stress in a range from 125 MPa to 375 MPa can enable low minimum parallel plate distance.

In aspects, the foldable apparatus 101, 301, 401, and/or 601 and/or the foldable substrate 201 can be free from buckling in the central portion 281 and/or the central region 248. A foldable apparatus and/or a foldable substrate can be buckled when a surface profile of the first central surface area taken along a midline of the central portion equally spaced from the first portion and the second portion using a deflectometer comprises non-parabolic shape. As used herein, the deflectometer profile is measured using a SpecGAGE3D available from Irsa Vision using the default settings. The raw deflectometry measurements correspond to an array of gradients over the measured area. The measured gradients are integrated by the software provided with the SpecGAGE3D to produce a 3D surface. A zero-point of the 3D surface is set so that the average height of the entire 3D surface is 0. A line profile corresponding to the midline of the central portion (i.e., midway between the first portion and the second portion) is extracted from this 3D surface is used as the surface profile (i.e., deflectometer profile). However, the general shape of the surface profile may not be precise enough to define whether a sample is buckled or non-buckled. It has been found that an average of an absolute value of the gradient of the surface profile (i.e., “average gradient”) can distinguish between buckled and non-buckled sample with buckled samples having a larger average gradient than non-buckled samples. As used herein, the average gradient is calculated by averaging all gradient measurements, where each gradient measurement is calculated between adjacent extrema (e.g., a local maximum and adjacent local minimum). In aspects, the surface profile of the first central surface area 213 taken along a midline of the central region 248 can comprise an average gradient of 0.018 mm/mm or less, 0.017 mm/mm or less, 0.016 mm/mm or less, 0.015 mm/mm or less, 0.013 mm/mm or less, 0.12 mm/mm or less, 0.011 mm/mm or less, or 0.010 mm/mm or less. In aspects, the surface profile of the first central surface area 213 taken along a midline of the central region 248 can comprise an average gradient from 0.001 mm/mm to 0.018 mm/mm, from 0.002 mm/mm to 0.017 mm/mm, from 0.003 mm/mm to 0.016 mm/mm, from 0.005 to 0.015 mm/mm, from 0.008 mm/mm to 0.013 mm/mm, from 0.010 mm/mm to 0.012 mm/mm, or any range or subrange therebetween. For samples that are not buckled, the central portion and/or the central region can exhibit a warp that can be tolerated for most applications. The warp was taken as the largest difference in height (vertical axis) of the surface profile along width along the midline excluding the measurements within 1 mm of the edge of the surface profile. In aspects, the surface profile of the first central surface area 213 taken along a midline of the central region 248 can comprise a tolerable warp of 1,000 μm or less, 700 μm or less, 600 μm or less, 500 μm or less, 400 μm or less, 350 μm or less, 320 μm or less, 300 μm or less, 280 μm or less, 250 μm or less, or 200 μm or less. In aspects, a warp of the surface profile per length of the midline (μm/mm) can be 10 μm/mm or less, 9 μm/mm or less, 8 μm/mm or less, 7 μm/mm or less, 6 μm or less, or 5 μm/mm or less.

Buckling is a type of mechanical instability. Without wishing to be bound by theory, buckling can occur when a portion of a foldable substrate is subjected to greater than a critical buckling strain for that portion. Critical buckling strain increases with thickness; so, the central portion may be the most susceptible to buckling. When the central portion is subjected to increasing strain less than the critical buckling strain, the central portion can exhibit increasing saddle warp. One source of strain on the central portion is chemical strengthening induced expansion strain caused by expansion when larger ions replace existing, smaller ions in the foldable substrate. Specifically, a mismatch between a chemical strengthening induced expansion strain of the central portion and the first portion and the second portion can arise due to the different thicknesses (e.g., volume) of the these portions (central portion, first portion, and second portion) and potentially different amounts of chemical strengthening that these portions are subjected to.

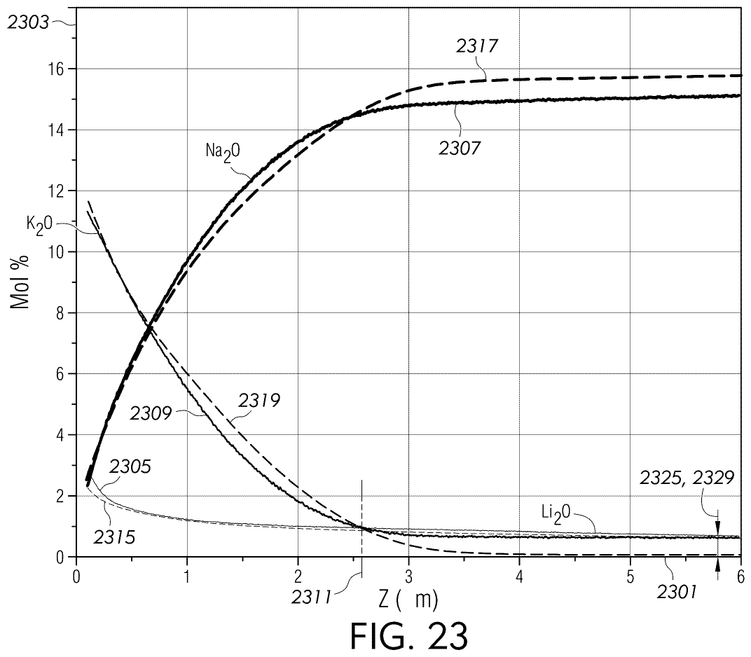

The present disclosure demonstrates that buckling-free and low warp foldable substrates can be obtained. As discussed below, a diffusion layer can be disposed over the central portion to limit (but not prevent) ion exchange in one of the chemical strengthening steps, where the entire foldable substrate undergoes at least some ion exchange in each of the two or more chemical strengthening steps. As demonstrated herein for Example 1 (FIGS. 23 and 25-26), there is a critical thickness for the diffusion layer that allows for some ion exchange in the central portion that avoids buckling (seen without a diffusion layer—Example AA) and the large warp (seen with too thick of a diffusion layer—Example 2-see FIG. 27).

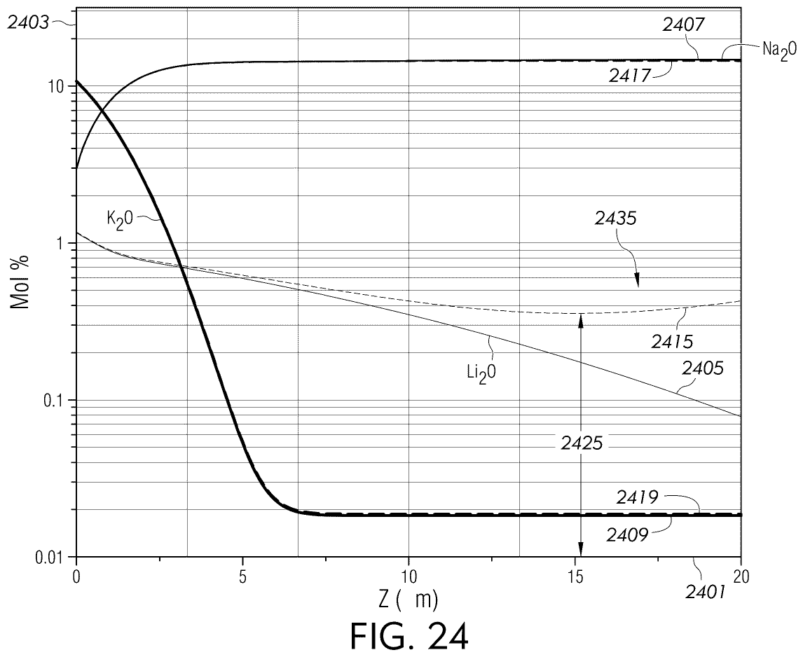

Throughout the disclosure, concentration profiles of alkali metal oxides (e.g., lithium oxide (Li₂O), sodium oxide (Na₂O), and potassium oxide (K₂O)) are measured using glow discharge optical emission spectroscopy (GDOES). While surface concentrations can be measured using secondary-ion mass spectroscopy (SIMS), surface concentrations discussed herein will use measurements from GDOES; however, the “surface concentration” or “concentration at the surface” from GDOES measurements is taken as the concentration at a depth of 1 μm from the surface to avoid any spurious readings or surface contamination during the start of the GDOES measurement. As used herein, concentrations in mol % reported in the concentration profiles from GDOES refer to the amount of the given compound at a certain depth from the surface relative to other compounds detected at that same, certain depth from the surface. As discussed below, FIGS. 23-24 show concentration profiles for Li₂O, Na₂O, and K₂O measured using GDOES.

In aspects, the first compressive stress region and/or the third compressive stress region extending from the first major surface 203 can have a non-zero concentration profile of Li₂O therein. In aspects, the second compressive stress region and/or the fourth compressive stress region extending from the second major surface 205 can have a non-zero concentration profile of Li₂O therein. For example, the non-zero concentration profile of Li₂O in the compressive stress region(s) extending from (one or more) portion(s) of the first major surface and/or the second major surface can range from greater than or equal to 0.01 mol % to less than or equal to 5.0 mol %, from greater than or equal to 0.05 mol % to less than or equal to 4.5 mol %, from greater than or equal to 0.1 mol % to less than or equal to 4.0 mol %, from greater than or equal to 0.25 mol % to less than or equal to 3.0 mol % from greater than or equal to 0.5 mol % to less than or equal to 2.5 mol %, or any range or subrange therebetween.

In further aspects, a concentration profile of Li₂O in the first portion and/or the second portion (i.e., having the substrate thickness 207) can be zero for at least a portion (e.g., near the midpoint-defined below, or the tensile region between the compressive stress regions) therein. In aspects, a concentration of Li₂O at the first major surface 203 (e.g., first surface area 223, third surface area 233) and/or the second major surface 205 (e.g., second surface area 225, fourth surface area 235) can be 2.0 mol % or more, 2.2 mol % or more, 2.5 mol % or more, 2.7 mol % or more, 3.0 mol % or more, 3.2 mol % or more, 3.5 mol % or more, 3.7 mol % or less, 4.0 mol % or less, 4.5 mol % or more, 5.0 mol % or less, 4.7 mol % or less, 4.5 mol % or less, 4.2 mol % or less, 4.0 mol % or less, 3.7 mol % or less, 3.5 mol % or less, 3.2 mol % or less, 3.0 mol % or less, 2.7 mol % or less, or 2.5 mol % or less. In aspects, a concentration of Li₂O at the first major surface 203 and/or the second major surface 205 can range from greater than or equal to 2.0 mol % to less than or equal to 5.0 mol %, from greater than or equal to 2.2 mol % to less than or equal to 4.7 mol %, from greater than or equal to 2.5 mol % to less than or equal to 4.5 mol %, from greater than or equal to 2.7 mol % to less than or equal to 4.2 mol %, from greater than or equal to 3.0 mol % to less than or equal to 4.0 mol %, from greater than or equal to 3.2 mol % to less than or equal to 3.7 mol %, from greater than or equal to 3.5 mol % to less than or equal to 3.7 mol, or any range or subrange therebetween. In aspects, a concentration of Li₂O at the second major surface 205 can be equal to a concentration of Li₂O at the first major surface 203.

In aspects, the first central compressive stress region and/or the second compressive stress region extending from the first central surface area 213 and/or the second central surface area 243, respectively, can have a non-zero concentration profile of Li₂O therein. In further aspects, a concentration profile of Li₂O can be non-zero throughout the entire central thickness. For example, the non-zero concentration profile of Li₂O in the central portion can range from greater than or equal to 0.01 mol % to less than or equal to 4.0 mol %, from greater than or equal to 0.02 mol % to less than or equal to 3.5 mol %, from greater than or equal to 0.05 mol % to less than or equal to 3.0 mol %, from greater than or equal to 0.1 mol % to less than or equal to 2.5 mol % from greater than or equal to 0.2 mol % to less than or equal to 2.0 mol %, or any range or subrange therebetween.

In aspects, a concentration of Li₂O at the first central surface area 213 and/or the second central surface area 243 can be within one or more of the ranges discussed above in this paragraph. Alternatively, a concentration of Li₂O at the first central surface area 213 and/or the second central surface area 243 can be 1.0 mol % or more, 1.2 mol % or more, 1.5 mol % or more, 1.7 mol % or more, 2.0 mol % or more, 2.2 mol % or more, 2.5 mol % or more, 2.7 mol % or more, 3.0 mol % or more, 3.2 mol % or more, 3.5 mol % or more, 3.7 mol % or more, 4.0 mol % or less, 3.7 mol % or less, 3.5 mol % or less, 3.2 mol % or less, 3.0 mol % or less, 2.7 mol % or less, 2.5 mol % or less, 2.2 mol % or less, 2.0 mol % or less, 1.7 mol % or less, or 1.5 mol % or less. For example, a concentration of Li₂O at the first central surface area 213 and/or the second central surface area 243 can range from greater than or equal to 1.0 mol % to less than or equal to 4.0 mol %, from greater than or equal to 1.2 mol % to less than or equal to 3.7 mol %, from greater than or equal to 1.5 mol % to less than or equal to 3.5 mol %, from greater than or equal to 1.7 mol % to less than or equal to 3.2 mol %, from greater than or equal to 2.0 mol % to less than or equal to 3.0 mol %, from greater than or equal to 2.2 mol % to less than or equal to 2.7 mol %, from greater than or equal to greater than or equal to 2.5 mol % to less than or equal to 2.7 mol %, or any range or subrange therebetween. In aspects, an absolute value of a difference in the concentration of Li₂O at the first major surface 203 and the concentration of Li₂O at the first central surface area 213 can be less than or equal to 0.1 mol %. In further aspects, the concentration of Li₂O at the first central surface area 213 and/or the second central surface area 243 can be equal to the concentration of Li₂O at the first major surface 203 and/or at the second major surface 205. Providing a surface concentration of Li₂O (e.g., as an absolute mol % and/or an amount that the surface concentration is elevated relative to a concentration at the midpoint) from 0.2 mol % to 2 mol % can reduce (e.g., mitigate, counteract) a chemical strengthening induced expansion and resulting strain in the foldable substrate.

As used herein, a larger alkali metal oxide refers to one or more of potassium oxide (K₂O), rubidium oxide (Rb₂O), cesium oxide (Cs₂O), and francium oxide (Fr₂O) at the first major surface. In aspects, the larger alkali metal oxide can be potassium oxide (K₂O). In aspects, the first compressive stress region and/or the third compressive stress region can comprise a non-zero concentration profile a larger alkali metal oxide extending from the first major surface to a corresponding depth of layer (excluding the depth of layer itself) of the larger alkali metal oxide; and/or the second compressive stress region and/or the fourth compressive stress region can comprise a non-zero concentration profile a larger alkali metal oxide extending from the second major surface to a corresponding depth of layer (excluding the depth of layer itself) of the larger alkali metal oxide. In further aspects, the concentration of the larger alkali metal oxide at the corresponding major surface can be greater than the concentration of the larger alkali metal oxide at the corresponding depth of layer. In further aspects, the non-zero concentration profile of the larger alkali metal oxide extending from the corresponding major surface to the corresponding depth of layer can range from greater than or equal to 0.01 mol % to less than or equal to 15.0 mol %, from greater than or equal to 0.02 mol % to less than or equal to 14.0 mol %, from greater than or equal to 0.05 mol % to less than or equal to 13.0 mol %, from greater than or equal to 0.1 mol % to less than or equal to 12.0 mol % from greater than or equal to 0.2 mol % to less than or equal to 11.0 mol %, or any range or subrange therebetween.

In aspects, a concentration of the larger alkali metal oxide at the first major surface 203 (e.g., first surface area 223, third surface area 233) and/or the second major surface 205 (e.g., second surface area 225, fourth surface area 235) can be 8 mol % or more, 9 mol % or more, 10 mol % or more, 10.5 mol % or more, 11.0 mol % or more, 11.5 mol % or more, 12.0 mol % or more, 12.5 mol % or more, 15 mol % or less, 14.5 mol % or less, 14.0 mol or less, 13.5 mol % or less, 13.0 mol % or less, 12.5 mol % or less, 12.0 mol % or less, 11.5 mol % or less, 11.0 mol % or less, 10.5 mol % or less, 10 mol % or less, or 9 mol % or less. In aspects, a concentration of the larger alkali metal oxide at the first major surface 203 (e.g., first surface area 223, third surface area 233) and/or the second major surface 205 (e.g., second surface area 225, fourth surface area 235) can range from greater than or equal to 8 mol % to less than or equal to 15 mol %, from greater than or equal to 9 mol % to less than or equal to 14.5 mol %, from greater than or equal to 10 mol % to less than or equal to 14.0 mol %, from greater than or equal to 10.5 mol % to less than or equal to 13.5 mol %, from greater than or equal to 11.0 mol % to less than or equal to 13.0 mol %, from greater than or equal to 11.5 mol % to less than or equal to 12.5 mol %, from greater than or equal to 11.5 mol % to less than or equal to 12.0 mol %, or any range or subrange therebetween. In aspects, a concentration of the larger alkali metal oxide at the second major surface 205 can be equal to the concentration of the larger alkali metal oxide at the first major surface 203. Providing a high (e.g., 5 mol % or more) concentration of K₂O (e.g., as an absolute mol % and/or an amount that the surface concentration is elevated relative to a concentration at the midpoint) can provide a large (e.g., 500 MPa) surface compressive stress that can enable increased fracture resistance.

In aspects, the first central compressive stress region and/or the second compressive stress region can have a non-zero concentration profile of the larger alkali metal oxide from the corresponding central surface area to a corresponding depth of layer (excluding the depth of layer itself) of the larger alkali metal oxide. In further aspects, a range of the concentration profile of the larger alkali metal oxide can be within of the corresponding ranges for the larger alkali metal oxide discussed above in the previous paragraph. In further aspects, a concentration of the larger alkali metal oxide at the first central surface area and/or the second central surface area can be within one or more of the corresponding ranges for the concentration of the larger alkali metal oxide at the first major surface and/or the second major surface discussed above in the previous paragraph. In aspects, the concentration profile of the larger alkali metal oxide in the first central compressive stress region and/or the second central compressive stress region (e.g., the subrange extending to the corresponding depth of compression of the larger alkali metal oxide) can follow a complementary Gaussian Error Function. In aspects, a difference equal to the concentration of the larger alkali metal oxide at the first major surface minus the concentration of the larger alkali metal oxide at the first central surface area can be greater than or equal to 0.2 mol %, greater than or equal to 0.5 mol %, greater than or equal to 0.7 mol %, greater than or equal to 1.0 mol %, greater than or equal to 1.2 mol %, greater than or equal to 1.5 mol %, less than or equal to 2.0 mol %, less than or equal to 1.7 mol %, less than or equal to 1.5 mol %, less than or equal to 1.2 mol %, less than or equal to 1.2 mol %, less than or equal to 1.0 mol %, less than or equal to 0.7 mol %, or less than or equal to 0.5 mol %. In aspects, a difference equal to the concentration of the larger alkali metal oxide at the first major surface minus the concentration of the larger alkali metal oxide at the first central surface area can be from greater than or equal to 0.2 mol % to less than or equal to 2.0 mol %, from greater than or equal to 0.5 mol % to less than or equal to 1.7 mol %, from greater than or equal to 0.7 mol % to less than or equal to 1.5 mol %, from greater than or equal to 1.0 mol % to less than or equal to 1.2 mol %, or any range or subrange therebetween.

In aspects, the first surface concentration (e.g., at the first major surface 203) of the larger alkali metal oxide (e.g., K₂O) can be greater than the first central surface concentration (e.g., at the first central surface area 213) of the larger alkali metal oxide (e.g., K₂O) (i.e., first surface concentration of the larger alkali metal oxide minus the first central surface concentration of the larger alkali metal oxide) by 0.2 mol % or more, 0.3 mol % or more, 0.4 mol % or more, 0.5 mol % or more, 0.75 mol % or more, 1 mol % or more, 2 mol % or less, 1.8 mol % or less, 1.5 mol % or less, 1.2 mol % or less, or 1.0 mol % or less. In aspects, the first surface concentration (e.g., at the first major surface 203) of the larger alkali metal oxide (e.g., K₂O) can be greater than the first central surface concentration (e.g., at the first central surface area 213) of the larger alkali metal oxide (e.g., K₂O) (i.e., first surface concentration of the larger alkali metal oxide minus the first central surface concentration of the larger alkali metal oxide) by from greater than or equal to 0.2 mol % to less than or equal to 2 mol %, from greater than or equal to 0.3 mol % to less than or equal to 1.8 mol %, from greater than or equal to 0.4 mol % to less than or equal to 1.5 mol %, from greater than or equal to 0.5 mol % to less than or equal to 1.2 mol %, from greater than or equal to 0.75 mol % to less than or equal to 1 mol %, or any range or subrange therebetween. In aspects, the concentration of the larger alkali metal throughout the central portion (including the central midpoint) can be greater than the concentration of the larger alkali metal at the first midpoint. For example, the concentration of the larger alkali metal at the central midpoint can be greater than the corresponding concentration of the larger alkali metal at the first midpoint by from greater than or equal to 0.2 mol % to less than or equal to 2.0 mol %, from greater than or equal to 0.5 mol % to less than or equal to 1.7 mol %, from greater than or equal to 0.7 mol % to less than or equal to 1.5 mol %, from greater than or equal to 1.0 mol % to less than or equal to 1.2 mol %, or any range or subrange therebetween.

In aspects, a concentration of Na₂O at the first major surface 203 (e.g., first surface area 223, third surface area 233) and/or the second major surface 205 (e.g., second surface area 225, fourth surface area 235) can be 0.5 mol % or more, 0.7 mol % or more, 1.0 mol % or more, 1.2 mol % or more, 1.5 mol % or more, 1.7 mol % or more, 2.0 mol % or more, 2.2 mol % or more, 2.5 mol % or more, 3.0 mol % or less, 2.7 mol % or less, 2.5 mol % or more, 2.2 mol % or less, 2.0 mol % or less, 1.7 mol % or less, 1.5 mol % or less, 1.2 mol % or less, 1.0 mol % or less, or 0.7 mol % or less. In aspects, a concentration of Na₂O at the first major surface 203 and/or the second major surface 205 can range from greater than or equal to 0.5 mol % to less than or equal to 3.0 mol %, from greater than or equal to 0.7 mol % to less than or equal to 2.7 mol %, from greater than or equal to 1.0 mol % to less than or equal to 2.5 mol %, from greater than or equal to 1.2 mol % to less than or equal to 2.2 mol %, from greater than or equal to 1.5 mol % to less than or equal to 2.0 mol %, from greater than or equal to 1.7 mol % to less than or equal to 2.0 mol %, or any range or subrange therebetween. In aspects, a concentration of Na₂O at the second major surface 205 can be equal to a concentration of Na₂O at the first major surface 203. In aspects, a concentration of Na₂O at the first central surface area 213 and/or the second central surface area 243 can be within one or more of the ranges discussed above in this paragraph. In further aspects, a concentration of Na₂O at the first central surface area 213 and/or the second central surface area 243 can be equal to the concentration of Na₂O at the first major surface 203 and/or the second major surface 205.

In aspects, the first surface concentration (e.g., at the first major surface 203) of Na₂O can be greater than the first central surface concentration (e.g., at the first central surface area 213) of Na₂O (i.e., first surface concentration of Na₂O minus the first central surface concentration of Na₂O) by 0.2 mol % or more, 0.3 mol % or more, 0.4 mol % or more, 0.5 mol % or more, 0.75 mol % or more, 1 mol % or more, 2 mol % or less, 1.8 mol % or less, 1.5 mol % or less, 1.2 mol % or less, or 1.0 mol % or less. In aspects, the first surface concentration (e.g., at the first major surface 203) of Na₂O can be greater than the first central surface concentration (e.g., at the first central surface area 213) of Na₂O (i.e., first surface concentration of Na₂O minus the first central surface concentration of Na₂O) by from greater than or equal to 0.2 mol % to less than or equal to 2 mol %, from greater than or equal to 0.3 mol % to less than or equal to 1.8 mol %, from greater than or equal to 0.4 mol % to less than or equal to 1.5 mol %, from greater than or equal to 0.5 mol % to less than or equal to 1.2 mol %, from greater than or equal to 0.75 mol % to less than or equal to 1 mol %, or any range or subrange therebetween.

As used herein, a midpoint of the foldable substrate 201 (e.g., first portion 221, second portion 231) is defined as a location midway between the first major surface 203 and the second major surface 205. For example, if the substrate thickness 207 is 100 μm, then the midpoint (e.g., in the first portion) is located 50 μm from the first major surface 203 and 50 μm from the second major surface 205. Unless otherwise indicated, the “first midpoint” refers to the midpoint in the first portion (having the substrate thickness). Likewise, as used herein, a “central midpoint” refers to midpoint of the central portion 281 (e.g., central region 248) that is defined as a location midway between the first central surface area 213 and the second central surface area 243. For example, if the central thickness 209 is 30 μm, then the central midpoint (e.g., in the central region) is located 15 μm from the first central surface area 213 and 15 μm from the second central surface area 243. In aspects, when the first distance 219 is equal to the second distance 249, the midpoint of the foldable substrate 201 in the first portion 221 and in the second portion 231 can be coplanar with the central midpoint.

In aspects, a concentration of Li₂O at the first midpoint (i.e., in a region corresponding to the substrate thickness (e.g., in the first portion, in the second portion)) can be less than or equal to 0.1 mol %. In aspects, a concentration of the larger alkali metal oxide at the first midpoint can be less than or equal to 0.1 mol %. In aspects, a lithium difference equal to a central concentration of Li₂O at the central midpoint (i.e., midpoint of the central portion) minus the concentration of Li₂O at the first midpoint (i.e., midpoint of the first portion) can be 0.2 mol % or more, 0.3 mol % or more, 0.4 mol % or more, 0.5 mol % or more, 0.75 mol % or more, 1 mol % or more, 2 mol % or less, 1.8 mol % or less, 1.5 mol % or less, 1.2 mol % or less, or 1.0 mol % or less. In aspects, a lithium difference equal to a central concentration of Li₂O at the central midpoint (i.e., midpoint of the central portion) minus the concentration of Li₂O at the first midpoint (i.e., midpoint of the first portion) can be from greater than or equal to 0.2 mol % to less than or equal to 2 mol %, from greater than or equal to 0.3 mol % to less than or equal to 1.8 mol %, from greater than or equal to 0.4 mol % to less than or equal to 1.5 mol %, from greater than or equal to 0.5 mol % to less than or equal to 1.2 mol %, from greater than or equal to 0.75 mol % to less than or equal to 1 mol %, or any range or subrange therebetween. In preferred aspects, a concentration of Li₂O at the first major surface 203 can be greater than a concentration of Li₂O at the midpoint by from greater than or equal to 0.2 mol % to less than or equal to 2 mol %, from greater than or equal to 0.5 mol % to less than or equal to 1.8 mol %, from greater than or equal to 0.75 mol % to less than or equal to 1.5 mol %, or any range or subrange therebetween. In aspects, a larger alkali difference equal to a central concentration of the larger alkali metal oxide at the central midpoint (i.e., midpoint of the central portion) minus the concentration of the larger alkali metal oxide (e.g., K₂O) at the first midpoint (i.e., midpoint of the first portion) can be within one or more of the ranges discussed above in this paragraph for the lithium difference. In aspects, a ratio of the lithium difference to the larger alkali difference (i.e., the lithium difference divided by the larger alkali difference) can be 0.6 or more, 0.7 or more, 0.75 or more, 0.9 or more 1.0 or more, 1.25 or more, 1.5 or more, 1.7 or less, 1.6 or less, 1.5 or less, 1.4 or less, 1.3 or less, 1.2 or less, 1.1 or less, 1.0 or less, 0.9 or less, 0.8 or less, 0.75 or less, or 0.7 or less. In aspects, a ratio of the lithium difference to the larger alkali difference (i.e., the lithium difference divided by the larger alkali difference) can be from greater than or equal to 0.6 to less than or equal to 1.7, from greater than or equal to 0.7 to less than or equal to 1.6, from greater than or equal to 0.75 to less than or equal to 1.5, from greater than or equal to 0.9 to less than or equal to 1.4, from greater than or equal to 1.0 to less than or equal to 1.3, from greater than or equal to 1.1 to less than or equal to 1.2, or any range or subrange therebetween. In preferred aspects, the ratio of the lithium difference to the larger alkali difference (i.e., the lithium difference divided by the larger alkali difference) can be from greater than or equal to 0.6 to less than or equal to 1.7, from greater than or equal to 0.75 to less than or equal to 1.4, or from greater than or equal to greater than or equal to 0.9 to less than or equal to 1.2. It is believed that this ratio of the lithium difference to the larger alkali difference is characteristic of the method described herein, where elevated concentration profiles of lithium and the larger alkali metal can be formed throughout the entire central thickness of the central portion relative to the bulk composition (e.g., composition at the first midpoint of the first portion).

In aspects, a concentration of Li₂O at the first major surface 203 (e.g., first surface area 223, third surface area 233) and/or the second major surface 205 (e.g., second surface area 225, fourth surface area 235) can be greater than a concentration of Li₂O at the midpoint (e.g., in the first portion, in the second portion) by 0.2 mol % or more, 0.3 mol % or more, 0.4 mol % or more, 0.5 mol % or more, 0.75 mol % or more, 1 mol % or more, 2 mol % or less, 1.8 mol % or less, 1.5 mol % or less, 1.2 mol % or less, or 1.0 mol % or less. In aspects, a concentration of Li₂O at the first major surface 203 (e.g., first surface area 223, third surface area 233) and/or the second major surface 205 (e.g., second surface area 225, fourth surface area 235) can be greater than a concentration of Li₂O at the midpoint (e.g., in the first portion, in the second portion) by from greater than or equal to 0.2 mol % to less than or equal to 2 mol %, from greater than or equal to 0.3 mol % to less than or equal to 1.8 mol %, from greater than or equal to 0.4 mol % to less than or equal to 1.5 mol %, from greater than or equal to 0.5 mol % to less than or equal to 1.2 mol %, from greater than or equal to 0.75 mol % to less than or equal to 1 mol %, or any range or subrange therebetween. In preferred aspects, a concentration of Li₂O at the first major surface 203 can be greater than a concentration of Li₂O at the midpoint by from greater than or equal to 0.2 mol % to less than or equal to 2 mol %, from greater than or equal to 0.5 mol % to less than or equal to 1.8 mol %, from greater than or equal to 0.75 mol % to less than or equal to 1.5 mol %, or any range or subrange therebetween.

In aspects, a concentration of Li₂O at the first central surface area 213 and/or the second central surface area 243 can be greater than a concentration of Li₂O at the central midpoint by 0.1 mol % or more, 0.2 mol % or more, 0.3 mol % or more, 0.4 mol % or more, 0.5 mol % or more, 1.5 mol % or less, 1.2 mol % or less, 1.0 mol % or less, 0.75 mol % or less, 0.6 mol % or less, 0.5 mol % or less, or 0.3 mol % or less. In aspects, a concentration of Li₂O at the first central surface area 213 and/or the second central surface area 243 can be greater than a concentration of Li₂O at the central midpoint by from greater than or equal to 0.1 mol % to less than or equal to 1.5 mol %, from greater than or equal to 0.2 mol % to less than or equal to 1.2 mol %, from greater than or equal to 0.3 mol % to less than or equal to 1.0 mol %, from greater than or equal to 0.4 mol % to less than or equal to 0.75 mol %, from greater than or equal to 0.5 mol % to less than or equal to 0.6 mol %, or any range or subrange therebetween.

In aspects, a concentration of the larger alkali metal oxide at the first major surface 203 (e.g., first surface area 223, third surface area 233) and/or the second major surface 205 (e.g., second surface area 225, fourth surface area 235) can be greater than a concentration of the larger alkali metal oxide at the midpoint (e.g., in the first portion, in the second portion) by 5 mol % or more, 6 mol % or more, 7 mol % or more, 8 mol % or more, 9 mol % or more, 10 mol % or more, 15 mol % or less, 14 mol % or less, 13 mol % or less, 12 mol % or less, 11 mol % or less, or 10 mol % or less. In aspects, a concentration of the larger alkali metal oxide at the first major surface 203 (e.g., first surface area 223, third surface area 233) and/or the second major surface 205 (e.g., second surface area 225, fourth surface area 235) be greater than a concentration of the larger alkali metal oxide at the midpoint (e.g., in the first portion, in the second portion) by from 5 mol % to 15 mol %, from 6 mol % to 14 mol %, from 7 mol % to 13 mol %, from 8 mol % to 12 mol %, from 9 mol % to 11 mol %, from 9 mol % to 10 mol %, or any range or subrange therebetween. In aspects, an amount that a concentration of the larger alkali metal oxide at is greater than the concentration of the larger alkali metal oxide at the midpoint (e.g., in the first portion, in the second portion) can be equal to the amount that the concentration of the larger alkali metal oxide at the first major surface 203 is greater than the concentration at the midpoint. In aspects, a concentration of the larger alkali metal oxide at the first central surface area 213 and/or the second central surface area 243 can be greater than a concentration of the larger alkali metal oxide at the central midpoint by an amount within one or more of the ranges discussed above in this paragraph. In aspects, an amount that the concentration of the larger alkali metal oxide at the first central surface area 213 and/or the second central surface area 243 is greater than a concentration of the larger alkali metal oxide at the central midpoint can be equal to the amount that the concentration of the larger alkali metal oxide at the first major surface 203 is greater than the concentration of the larger alkali metal oxide at the midpoint. Providing a high (e.g., 5 mol % or more) concentration of the larger alkali metal oxide (e.g., as an absolute mol % and/or an amount that the surface concentration is elevated relative to a concentration at the midpoint) can provide a large (e.g., 500 MPa) surface compressive stress that can enable increased fracture resistance.

In aspects, a concentration of the larger alkali metal oxide at the first major surface 203 can be greater than the concentration of Li₂O at the first major surface 203. In further aspects, a ratio of the concentration of the larger alkali metal oxide at the first major surface 203 to the concentration of Li₂O at the first major surface 203 can be 5 or more, 7 or more, 8 or more, 9 or more, 10 or more, 12 or more, 20 or less, 15 or less, 12 or less, or 10 or less. In further aspects, a ratio of the concentration of the larger alkali metal oxide at the first major surface 203 to the concentration of Li₂O at the first major surface 203 can range from 5 to 20, from 7 to 20, from 8 to 20, from 9 to 15, from 10 to 12, or any range or subrange therebetween.

In aspects, a first depth of layer of the larger alkali metal oxide (e.g., K₂O) associated with the first compressive stress region, as a percentage of the substrate thickness, can be 10% or more, 12% or more, 13% or more, 14% or more, 15% or more, 16% or more, 17% or more, 20% or less, 17% or less, 16% or less, 15% or less, 14% or less, or 13% or less. In aspects, a first depth of layer of the larger alkali metal oxide associated with the first compressive stress region, as a percentage of the substrate thickness, can be greater than or equal to 12% to less than or equal to less than or equal to 17%, from greater than or equal to 13% to less than or equal to 16%, from greater than or equal to 14% to less than or equal to 15%, or any range or subrange therebetween. In aspects, the second depth of layer, third depth of layer, and/or forth depth of layer of the larger alkali metal oxide associated with the corresponding compressive stress region, can be within one or more of the ranges discussed above in this paragraph for (and/or equal to) the first depth of layer.

In aspects, a first central depth of layer of the larger alkali metal oxide (e.g., K₂O) associated with the first central compressive stress region, as a percentage of the central thickness, can be 12% or more, 15% or more, 16% or more, 17% or more, 18% or more, 19% or more, 20% or less, 19% or less, 18% or less, 17% or less, 16% or less, or 15% or less. In aspects, a first central depth of layer of the larger alkali metal oxide associated with the first compressive stress region, as a percentage of the central thickness, can be greater than or equal to 15% to less than or equal to less than or equal to 20%, from greater than or equal to 16% to less than or equal to 19%, from greater than or equal to 17% to less than or equal to 18%, or any range or subrange therebetween. In aspects, a second central depth of layer of the larger alkali metal oxide associated with the second central compressive stress region can be within one or more of the ranges discussed above in this paragraph (or equal to) the first central depth of layer. In aspects, the first central depth of layer as a percentage of the central thickness can be greater than the first depth of layer as a percentage of the substrate thickness, although the first central depth of layer as a percentage of the central thickness can be equal to the first depth of layer as a percentage of the substrate thickness in other aspects. In further aspects, the first depth of layer can be greater than the first central depth of layer even when the first central depth of layer as a percentage of the central thickness is greater than (or equal to) the first depth of layer as a percentage of the substrate thickness.

In aspects, a ratio of the first depth of layer (DOL₁) of the larger alkali metal oxide (e.g., K₂O)—associated with the first compressive stress region in the first portion extending from the first major surface)—to the first central depth of layer (DOL_{C}) of the larger alkali metal oxide—associated with the first central compressive stress region in the first central portion extending from the first central surface area-((DOL₁/DOL_{C}) can be 2.0 or more, 2.5 or more, 3.0 or more, 3.5 or more, 4.0 or more, 4.5 or more, 5.0 or more, 6.0 or less, 5.5 or less, 5.0 or less, 4.5 or less, 4.0 or less, 3.5 or less, or 3.0 or less. In aspects, a ratio of the first depth of layer (DOL₁) of the larger alkali metal oxide to the first central depth of layer (DOL_{C}) of the larger alkali metal oxide can be from greater than or equal to 2.0 to less than or equal to 6.0, from greater than or equal to 2.5 to less than or equal to 5.5, from greater than or equal to 3.0 to less than or equal to 5.0, from greater than or equal to 3.5 to less than or equal to 4.5, from greater than or equal to 4.0 to less than or equal to 4.5, or any range or subrange therebetween. In preferred aspects, the ratio of the first depth of layer (DOL₁) of the larger alkali metal oxide to the first central depth of layer (DOL_{C}) of the larger alkali metal oxide can be from greater than or equal to 2.0 to less than or equal to 6.0, from greater than or equal 2.5 to less than or equal to 4.0, or from greater than or equal to 3.0 to less than or equal 3.5. In further aspects, as discussed above, the first compressive stress region can comprise a non-zero concentration profile of lithium (e.g., lithium oxide-Li₂O) and the larger alkali metal oxide (e.g., K₂O) to the first depth of layer of the larger alkali metal oxide.

In aspects, a second lithium difference equal to a concentration of Li₂O at twice the first central depth of layer (of the larger alkali metal oxide—e.g., K₂O) from the first central surface area minus a concentration of Li₂O at twice the first depth of layer (of the larger alkali metal oxide—e.g., K₂O) from the first major surface-Li₂O (2*DOL_{C})—Li₂O (2*DOL₁)—can be 0.2 mol % or more, 0.3 mol % or more, 0.4 mol % or more, 0.5 mol % or more, 0.75 mol % or more, 1 mol % or more, 2 mol % or less, 1.8 mol % or less, 1.5 mol % or less, 1.2 mol % or less, or 1.0 mol % or less. In aspects, a second lithium difference equal to a concentration of Li₂O at twice the first central depth of layer (of the larger alkali metal oxide) from the first central surface area minus a concentration of Li₂O at twice the first depth of layer (of the larger alkali metal oxide) from the first major surface can be from greater than or equal to 0.2 mol % to less than or equal to 2 mol %, from greater than or equal to 0.3 mol % to less than or equal to 1.8 mol %, from greater than or equal to 0.4 mol % to less than or equal to 1.5 mol %, from greater than or equal to 0.5 mol % to less than or equal to 1.2 mol %, from greater than or equal to 0.75 mol % to less than or equal to 1 mol %, or any range or subrange therebetween. In preferred aspects, the second lithium difference equal to a concentration of Li₂O at twice the first central depth of layer (of the larger alkali metal oxide) from the first central surface area minus a concentration of Li₂O at twice the first depth of layer (of the larger alkali metal oxide) from the first major surface area can be from greater than or equal to 0.2 mol % to less than or equal to 2 mol %, from greater than or equal to 0.5 mol % to less than or equal to 1.8 mol %, from greater than or equal to 0.75 mol % to less than or equal to 1.5 mol %, or any range or subrange therebetween. In aspects, a second larger alkali difference equal to a concentration of the larger alkali metal oxide (e.g., K₂O) at twice the first central depth of layer (of the larger alkali metal oxide—e.g., K₂O) from the first central surface area minus the concentration of the larger alkali metal oxide (e.g., K₂O) at twice the first depth of layer (of the larger alkali metal oxide—e.g., K₂O) from the first major surface can be within one or more of the ranges discussed above in this paragraph for the lithium difference. In further aspects, the concentration of the larger alkali metal oxide at (e.g., K₂O) at twice the first depth of layer (of the larger alkali metal oxide—e.g., K₂O) from the first major surface can be equal to the central concentration of the larger alkali metal oxide (i.e., at the first midpoint). In aspects, a ratio of the second lithium difference to the second larger alkali difference (i.e., the second lithium difference divided by the second larger alkali difference) can be 0.6 or more, 0.7 or more, 0.75 or more, 0.9 or more 1.0 or more, 1.25 or more, 1.5 or more, 1.7 or less, 1.6 or less, 1.5 or less, 1.4 or less, 1.3 or less, 1.2 or less, 1.1 or less, 1.0 or less, 0.9 or less, 0.8 or less, 0.75 or less, or 0.7 or less. In aspects, a ratio of the second lithium difference to the second larger alkali difference (i.e., the second lithium difference divided by the second larger alkali difference) can be from greater than or equal to 0.6 to less than or equal to 1.7, from greater than or equal to 0.7 to less than or equal to 1.6, from greater than or equal to 0.75 to less than or equal to 1.5, from greater than or equal to 0.9 to less than or equal to 1.4, from greater than or equal to 1.0 to less than or equal to 1.3, from greater than or equal to 1.1 to less than or equal to 1.2, or any range or subrange therebetween. In preferred aspects, the ratio of the second lithium difference to the second larger alkali difference (i.e., the second lithium difference divided by the second larger alkali difference) can be from greater than or equal to 0.6 to less than or equal to 1.7, from greater than or equal to 0.75 to less than or equal to 1.4, or from greater than or equal to greater than or equal to 0.9 to less than or equal to 1.2.

As used herein, a “total thickness variation” (TTV) of the central portion refers to the absolute value of the difference between the minimum thickness of the central portion 281 (e.g., central region 248) and the maximum thickness of the central portion 281 (e.g., central region 248). The maximum thickness and minimum thickness are measured by combining the 3D surfaces measured for each surface of the region (e.g., central portion 281, central region 248) using SpecGAGE3D, as described above. In aspects, the central portion 281 and/or the central region 248 can comprise a TTV of 6 μm or less, 5 μm or less, 4 μm or less, 3.8 μm or less, 3.6 μm or less, or 3.4 μm or less. In aspects, the central portion 281 and/or the central region 248 can comprise a TTV in a range from 0.5 μm to 6 μm, from 1 μm to 5 μm, from 1.5 μm to 4 μm, from 2 μm to 3.8 μm, from 2.5 μm to 3.6 μm, from 3 μm to 3.4 μm, or any range or subrange therebetween. Providing a low TTV (e.g., 6 μm or less) can further decrease an incidence of buckling by reducing variation in chemically-strengthening induced strain associated with the expansion or contraction due to ion-exchange.

As used herein, refractive index is measured in accordance with ASTM E1967-19 at a wavelength of 589 nm. In aspects, the polymer-based portion 289 and/or 299 can be optically clear and/or comprise a first index of refraction. In aspects, the first refractive index of the polymer-based portion 289 and/or 299 may be 1.3 or more, 1.4 or more, 1.45 or more, 1.49 or more, 2 or less, 1.7 or less, 1.6 or less, or 1.55 or less. In aspects, the first refractive index of the polymer-based portion 289 and/or 299 can range from 1 to 2, from 1.3 to 1.7, from 1.4 to 1.6, from 1.45 to 1.55, from 1.49 to 1.55, or any range or subrange therebetween. In aspects, a differential equal to the absolute value of the difference between a second index of refraction of the foldable substrate 201 and the first index of refraction of the polymer-based portion 289 and/or 299 can be 0.1 or less, 0.07 or less, 0.05 or less, 0.001 or more, 0.01 or more, or 0.02 or more. In aspects, the differential is in a range from 0.001 to 0.1, from 0.01 to 0.07, from 0.02 to 0.05, or any range or subrange therebetween. In aspects, the second index of refraction of the foldable substrate 201 may be greater than the first index of refraction of the polymer-based portion 289 and/or 299. In aspects, the second index of refraction of the foldable substrate 201 may be less than the first index of refraction of the polymer-based portion 289 and/or 299.

In aspects, the adhesive layer 261 can comprise a third index of refraction. In aspects, the third index of refraction of the adhesive layer 261 can be within one or more of the ranges discussed above with regards to the first index of refraction of the polymer-based portion 289 and/or 299. In aspects, a differential equal to the absolute value of the difference between the third index of refraction of the adhesive layer 261 and the first index of refraction of the polymer-based portion 289 and/or 299 can be within one or more of the ranges discussed above for the differential between the second index of refraction and the first index of refraction. In aspects, the third index of refraction of the adhesive layer 261 may be greater than the first index of refraction of the polymer-based portion 289 and/or 299. In aspects, the third index of refraction of the adhesive layer 261 may be less than the first index of refraction of the polymer-based portion 289 and/or 299. In aspects, a differential equal to the absolute value of the difference between the third index of refraction of the adhesive layer 261 and the second index of refraction of the foldable substrate 201 can be within one or more of the ranges discussed above for the differential between the second index of refraction and the first index of refraction. In aspects, the third index of refraction of the adhesive layer 261 may be greater than the second index of refraction of the foldable substrate 201. In aspects, the third index of refraction of the adhesive layer 261 may be less than the second index of refraction of the foldable substrate 201.

In aspects, the coating 251 can comprise a fourth index of refraction. In aspects, the fourth index of refraction of the coating 251 can be within one or more of the ranges discussed above with regards to the first index of refraction of the polymer-based portion 289 and/or 299. In aspects, a differential equal to the absolute value of the difference between the fourth index of refraction of the coating 251 and the first index of refraction of the polymer-based portion 289 and/or 299 can be within one or more of the ranges discussed above for the differential between the second index of refraction and the first index of refraction. In aspects, the fourth index of refraction of the coating 251 may be greater than the first index of refraction of the polymer-based portion 289 and/or 299. In aspects, the fourth index of refraction of the coating 251 may be less than the first index of refraction of the polymer-based portion 289 and/or 299. In aspects, a differential equal to the absolute value of the difference between the fourth index of refraction of the coating 251 and the second index of refraction of the foldable substrate 201 can be within one or more of the ranges discussed above for the differential between the second index of refraction and the first index of refraction. In aspects, the fourth index of refraction of the coating 251 may be greater than the second index of refraction of the foldable substrate 201. In aspects, the fourth index of refraction of the coating 251 may be less than the second index of refraction of the foldable substrate 201. In aspects, a differential equal to the absolute value of the difference between the fourth index of refraction of the coating 251 and the third index of refraction of the adhesive layer 261 can be within one or more of the ranges discussed above for the differential between the second index of refraction and the first index of refraction. In aspects, the fourth index of refraction of the coating 251 may be greater than the third index of refraction of the adhesive layer 261. In aspects, the fourth index of refraction of the coating 251 may be less than the third index of refraction of the adhesive layer 261.

FIGS. 4-6 schematically illustrate aspects of a foldable apparatus 401 and/or 601 in accordance with aspects of the disclosure in a folded configuration. As shown in FIG. 5, the foldable apparatus 501 is folded such that the second major surface 205 of the foldable substrate 201 is on the inside of the folded foldable apparatus 401, for example, foldable apparatus 301 can be folded to form foldable apparatus 401. For example, a display could be located on the side of the second major surface 205, and a viewer would view the display from the side of the first major surface 203. Alternatively, a display could be located on the side of the first major surface 203, and a viewer would view the display from the side of the second major surface 205. As shown in FIG. 6, the foldable apparatus 601 is folded such that the first major surface 203 of the foldable substrate 201 is on the inside of the folded foldable apparatus 601, for example, foldable apparatus 101 can be folded to form foldable apparatus 601.

As shown in FIG. 6, the foldable apparatus 101 shown in FIG. 1 (modified as described in the Parallel Plate Test below) is folded to form folded foldable apparatus 601 such that the first major surface 203 of the foldable substrate 201 is on the inside of the folded foldable apparatus 601. In FIG. 6, a user would view a display device in place of the PET sheet 507 through the foldable substrate 201 and, thus, would be positioned on the side of the second major surface 205. In aspects, as shown in FIG. 6, the foldable apparatus 601 can comprise a coating 251 disposed over the foldable substrate 201 (e.g., first major surface 203). In further aspects, a user would view a display device in place of the PET sheet 507 through the coating 251. In aspects, as shown in FIG. 6, the polymer-based portion 289 and/or 299 can be disposed over the foldable substrate 201. In further aspects, although not shown, an additional substrate (e.g., glass-based substrate and/or ceramic-based substrate in place of release liner 271 or PET sheet 507), and the additional substrate can be disposed over a display device. As shown in FIG. 5, the foldable apparatus 501 is folded such that the second major surface 205 of the foldable substrate 201 is on the inside of the folded foldable apparatus. In FIG. 5, a user would view a display device in place of the PET sheet 507 through the foldable substrate 201 and, thus, would be positioned on the side of the second major surface 205. It is to be understood that the foldable apparatus can be designed to fold such that the display device is on the inside of the bend, on the outside of the bend, or such that the foldable apparatus can be folded in either direction.

As used herein, “foldable” includes complete folding, partial folding, bending, flexing, or multiple capabilities. As used herein, the terms “fail,” “failure” and the like refer to breakage, destruction, delamination, or crack propagation. Likewise, a foldable apparatus achieves a parallel plate distance of “X,” or has a parallel plate distance of “X,” or comprises a parallel plate distance of “X” if it resists failure when the foldable apparatus is held at a parallel plate distance of “X” for 24 hours at 85° C. and 85% relative humidity.

As used herein, the “parallel plate distance” of a foldable apparatus and/or foldable substrate is measured with the following test configuration and process using a parallel plate apparatus 501 (see FIGS. 5-6) that comprises a pair of parallel rigid stainless-steel plates 503, 505 comprising a first rigid stainless-steel plate 503 and a second rigid stainless-steel plate 505. When measuring the “parallel plate distance” for the foldable substrate 201, as shown in FIG. 5, the foldable substrate 201 is placed between the pair of plates 503 and 505 such that the second major surface 205 is on the inside of the bent configuration, where test adhesive layer 509 comprising a thickness of 50 μm and a 100 μm thick polyethylene terephthalate (PET) sheet 507 are disposed over the first major surface 203 with the PET sheet 507 contacting the rigid stainless-steel plates 503, 505. When measuring the “parallel plate distance” for a foldable apparatus resembling the foldable apparatus 101 and 601 shown in FIGS. 2 and 6, respectively, the adhesive layer 261 is removed and is replaced by a test adhesive layer 509 comprises a thickness of 50 μm. Further, the test is conducted with a 100 μm thick polyethylene terephthalate (PET) sheet 507 rather than with the release liner 271 of FIG. 2. Thus, during the test to determine the “parallel plate distance” of a configuration of a foldable apparatus, the foldable apparatus 601 is produced by using the 100 μm thick PET sheet 507 rather than with the release liner 271 of FIG. 2.

When preparing the foldable apparatus 601, the 100 μm thick PET sheet 507 is attached to the test adhesive layer 509 in an identical manner that the release liner 271 is attached to the second contact surface 265 of the adhesive layer 261 as shown in FIG. 2. To test the foldable apparatus 601 of FIG. 6, the test adhesive layer 509 and the PET sheet 507 can likewise be installed as shown in the configuration of FIG. 6 to conduct the test on the foldable apparatus 601. The foldable apparatus 601 is placed between the pair of parallel rigid stainless-steel plates 503 and 505 such that the foldable substrate 201 will be on the inside of the bend, similar to the configuration shown in FIG. 6. For determining a “parallel plate distance”, the distance between the parallel plates is reduced at a rate of 50 μm/second until the parallel plate distance 511 is equal to the “parallel plate distance” to be tested. Then, the parallel plates are held at the “parallel plate distance” to be tested for 24 hours at 85° C. and 85% relative humidity. As used herein, the “minimum parallel plate distance” is the smallest parallel plate distance that the foldable apparatus can withstand without failure under the conditions and configuration described above.

In aspects, the foldable apparatus 101, 301, 401, and/or 601 and/or foldable substrate 201 can achieve a parallel plate distance of 100 mm or less, 50 mm or less, 20 mm or less, 10 mm or less, 5 mm or less, or 3 mm or less. In further aspects, the foldable apparatus and/or foldable substrate can achieve a parallel plate distance of 50 millimeters (mm), or 20 mm, or 10 mm, of 5 mm, or 3 mm. In aspects, the foldable apparatus and/or foldable substrate can comprise a minimum parallel plate distance of 40 mm or less, 20 mm or less, 10 mm or less, 5 mm or less, 3 mm or less, 1 mm or less, 1 mm or more, 3 mm or more, 5 mm or more, or 10 mm or more. In aspects, the foldable apparatus and/or foldable substrate can comprise a minimum parallel plate distance in a range from 1 mm to 40 mm, from 1 mm to 20 mm, from 1 mm to 10 mm, from 1 mm to 5 mm, from 1 mm to 3 mm. In aspects, the foldable apparatus and/or foldable substrate can achieve a minimum parallel plate distance in a range from 2 mm to 40 mm, from 2 mm to 20 mm, from 3 mm to 10 mm, from 3 mm to 5 mm, or any range or subrange therebetween.

A central width 287 of the central portion 281 of the foldable substrate 201 is defined between the first portion 221 and the second portion 231 in the direction 106 of the length 105. In aspects, the central width 287 of the central portion 281 of the foldable substrate 201 can extend from the first portion 221 to the second portion 231. A width 210 of the first central surface area 213 and the second central surface area 243 of the foldable substrate 201 is defined between the first transition region 212 and the second transition region 218, for example, as the portion comprising the central thickness 209, in the direction 106 of the length 105. In aspects, the central width 287 of the central portion 281 of the foldable substrate 201 and/or the width 210 of the first central surface area 213 of the foldable substrate 201 can be 1.4 times or more, 1.6 times or more, 2 times or more, 2.2 times or more, 3 times or less, or 2.5 times or less the minimum parallel plate distance. In aspects, the central width 287 of the central portion 281 of the foldable substrate 201 and/or the width 210 of the first central surface area 213 of the foldable substrate 201 as a multiple of the minimum parallel plate distance can range from 1.4 times to 3 times, from 1.6 times to 2.5 times, from 2 times to 2.5 times, from 2.2 times to 2.5 times, or any range or subrange therebetween. Without wishing to be bound by theory, the length of a bent portion in a circular configuration between parallel plates can be 1.6 times the parallel plate distance. Without wishing to be bound by theory, the length of a bend portion in an elliptical configuration between parallel plates can be 2.2 times the parallel plate distance. In aspects, the central width 287 of the central portion 281 of the foldable substrate 201 and/or the width 210 of the first central surface area 213 of the foldable substrate 201 can be 1 mm or more, 3 mm or more, 5 mm or more, 8 mm or more, 10 mm or more, 15 mm or more, 20 mm or more, 60 mm or less, 50 mm or less, 40 mm or less, 35 mm or less, 30 mm or less, or 25 mm or less. In aspects, the central width 287 of the central portion 281 of the foldable substrate 201 and/or the width 210 of the first central surface area 213 of the foldable substrate 201 can range from 1 mm to 100 mm, from 3 mm to 60 mm, from 5 mm to 50 mm, from 8 mm to 40 mm, from 10 mm to 40 mm, from 15 mm to 35 mm, from 20 mm to 30 mm, or any range of subrange therebetween. In aspects, the central width 287 of the central portion 281 of the foldable substrate 201 and/or the width 210 of the first central surface area 213 of the foldable substrate 201 can be 2.8 mm or more, 6 mm or more, 9 mm or more, 60 mm or less, 40 mm, or less, or 24 mm or less. In aspects, the central width 287 of the central portion 281 of the foldable substrate 201 and/or the width 210 of the first central surface area 213 of the foldable substrate 201 can range from 2.8 mm to 40 mm, from 6 mm to 24 mm, or any range of subrange therebetween. In aspects, the first central surface area 213, the central portion 281 (e.g., centerline of the central portion 281), and/or the fold plane 109 can correspond to a midpoint between opposing ends of the foldable substrate and/or the foldable apparatus in the direction 106 of the length 105. By providing a width within the above-noted ranges for the central portion, folding of the foldable apparatus without failure can be facilitated.

In aspects, the foldable substrate and/or the foldable apparatus can be rollable. As used herein, a foldable substrate or a foldable apparatus is “rollable” if it can achieve a threshold parallel plate distance over a length of the corresponding foldable substrate and/or foldable apparatus that is the greater of 10 mm or 10% of the length of the corresponding foldable substrate and/or foldable apparatus. For example, as shown in FIGS. 2-3, the foldable substrate 201 is considered “rollable” when the central width 287 of the central portion 281 is greater than 10% of the length 105 (see FIG. 1) extending in the direction 106 of the length 105.

Additionally or alternatively, the central width 287 can be greater than a first width of the first portion and/or a second width of the second portion. In aspects, the central width 287, as a percentage of the length of the foldable substrate 201 and/or the foldable apparatus 101 and/or 301, can be 15% or more, 20% or more, 25% or more, 30% or more, 35% or more, 40% or more, 42% or more, 44% or more, 45% or more, 50% or less, 49% or less, 48% or less, 47% or less, 46% or less, 45% or less, 38% or less, or 32% or less. In aspects, the central width 287, as a percentage of the length of the foldable substrate 201 and/or the foldable apparatus 101 and/or 301, can range from 15% to 50%, from 20% to 50%, from 25% to 49%, from 30% to 49%, from 35% to 48%, from 40% to 48%, from 42% to 47%, from 43% to 46%, from 44% to 45%, or any range or subrange therebetween. In further aspects, the second width can be less than the central width 287. Providing a central width within one or more of the ranges mentioned above in this paragraph can enable a display portion of the foldable apparatus to be adjusted as a portion of the rollable substrate is moved into and/or out of view of a user without unnecessarily expanding a size of the corresponding apparatus when in a fully rolled configuration.

The foldable apparatus 101, 301, 401, and/or 601 may have an impact resistance defined by the capability of a region of the foldable apparatus (e.g., a region comprising the first portion 221, a region comprising the second portion 231, a region comprising the polymer-based portion 289 and/or 299 and/or central portion 281) to avoid failure at a pen drop height (e.g., 5 centimeters (cm) or more, 10 centimeters or more, 20 cm or more), when measured according to the “Pen Drop Test.” As used herein, the “Pen Drop Test” is conducted such that samples of foldable apparatus are tested with the load (i.e., from a pen dropped from a certain height) imparted to an outer major surface (e.g., first major surface 203 of the foldable substrate 201 for foldable apparatus 101 or 301 shown in FIGS. 2-3, second major surface 205 of the foldable substrate 201 for foldable apparatus 301 or 401 shown in FIGS. 3-4) with the foldable apparatus configured as in the parallel plate test with 100 μm thick PET sheet 507 attached to the test adhesive layer 509 having a thickness of 50 μm (as shown in FIGS. 5-6) instead of the release liner 271 shown in FIG. 2. As such, the PET layer in the Pen Drop Test is meant to simulate a foldable electronic display device (e.g., an OLED device). During testing, the foldable apparatus bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate.

A tube is used for the Pen Drop Test to guide a pen to an outer surface of the foldable apparatus. For the foldable apparatus 101, 301, 401, and/or 601 in FIGS. 2-3 and 5-6, the pen is guided to the outer major surface (e.g., third major surface 253 of the coating 251 or first major surface 203 of the foldable substrate 201 for foldable apparatus 101 shown in FIG. 2, second major surface 205 of the foldable substrate 201 for foldable apparatus 301 shown in FIG. 3), and the tube is placed in contact with the outer major surface of the foldable substrate 201 and/or foldable apparatus so that the longitudinal axis of the tube is substantially perpendicular to the outer major surface with the longitudinal axis of the tube extending in the direction of gravity. The tube has an outside diameter of 1 inch (2.54 cm), an inside diameter of nine-sixteenths of an inch (1.4 cm), and a length of 90 cm. An acrylonitrile butadiene (ABS) shim is employed to hold the pen at a predetermined height for each test. After each drop, the tube is relocated relative to the sample to guide the pen to a different impact location on the sample. The pen employed in Pen Drop Test is a BIC Easy Glide Pen, Fine, having a tungsten carbide ballpoint tip of 0.7 mm (0.68 mm) diameter, and a weight of 5.73 grams (g) including the cap.

For the Pen Drop Test, the pen is dropped with the cap attached to the top end (i.e., the end opposite the tip) so that the ballpoint can interact with the test sample. In a drop sequence according to the Pen Drop Test, one pen drop is conducted at an initial height of 1 cm, followed by successive drops in 0.5 cm increments up to 20 cm, and then after 20 cm, 2 cm increments until failure of the test sample. After each drop is conducted, the presence of any observable fracture, failure, or other evidence of damage to the sample is recorded along with the particular pen drop height. Using the Pen Drop Test, multiple samples can be tested according to the same drop sequence to generate a population with improved statistical accuracy. For the Pen Drop Test, the pen is to be changed to a new pen after every 5 drops, and for each new sample tested. In addition, all pen drops are conducted at random locations on the sample at or near the center of the sample, with no pen drops near or on the edge of the samples.

For purposes of the Pen Drop Test, “failure” means the formation of a visible mechanical defect in a laminate. The mechanical defect may be a crack or plastic deformation (e.g., surface indentation). The crack may be a surface crack or a through crack. The crack may be formed on an interior or exterior surface of a laminate. The crack may extend through all or a portion of the foldable substrate 201 and/or coating. A visible mechanical defect has a minimum dimension of 0.2 mm or more.

In aspects, the foldable apparatus can resist failure for a pen drop in a region comprising the first portion 221 or the second portion 231 at a pen drop height of 10 centimeters (cm), 12 cm, 14 cm, 16 cm, or 20 cm. In aspects, a maximum pen drop height that the foldable apparatus can withstand without failure over a region comprising the first portion 221 or the second portion 231 may be 10 cm or more, 12 cm or more, 14 cm or more, 16 cm or more, 40 cm or less, 30 cm or less, 20 cm or less, or 18 cm or less. In aspects, a maximum pen drop height that the foldable apparatus can withstand without failure over a region comprising the first portion 221 or the second portion 231 can range from 10 cm to 40 cm, from 12 cm to 30 cm, from 14 cm to 20 cm, from 16 cm to 20 cm, from 18 cm to 20 cm, or any range or subrange therebetween.

In aspects, the foldable apparatus can resist failure for a pen drop in a region (e.g., central portion 281) comprising the polymer-based portion 289 and/or 299 between the first portion 221 and the second portion 231 at a pen drop height of 1 cm, 2 cm, 3 cm, 4 cm, 5 cm, or more. In aspects, a maximum pen drop height that the foldable apparatus can withstand without failure over a region comprising the polymer-based portion 289 and/or 299 between the first portion 221 and the second portion 231 may be 1 cm or more, 2 cm or more, 3 cm or more, 4 cm or more, 20 cm or less, 10 cm or less, 8 cm or less, or 6 cm or less. In aspects, a maximum pen drop height that the foldable apparatus can withstand without failure over a region comprising the polymer-based portion 289 and/or 299 between the first portion 221 and the second portion 231 can range from 1 cm to 20 cm, from 2 cm to 10 cm, from 3 cm to 8 cm, from 4 cm to 8 cm, from 4 cm to 6 cm, or any range or subrange therebetween. In aspects, a maximum pen drop height that the foldable apparatus can withstand without failure of a region comprising the polymer-based portion 289 and/or 299 between the first portion 221 and the second portion 231 can range from 1 cm to 10 cm, from 1 cm to 8 cm, from 2 cm to 5 cm, from 3 cm to 5 cm, from 4 cm to 5 cm, or any range or subrange therebetween.

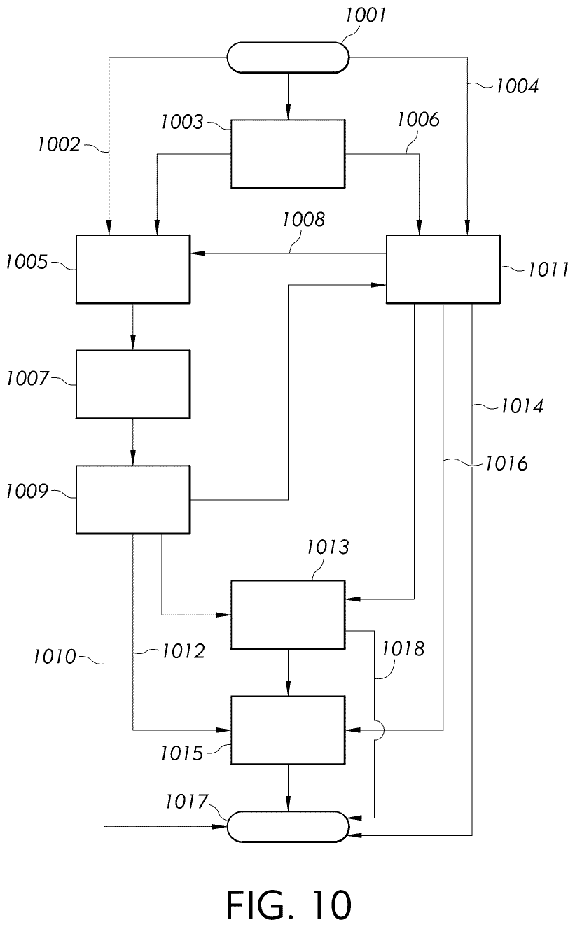

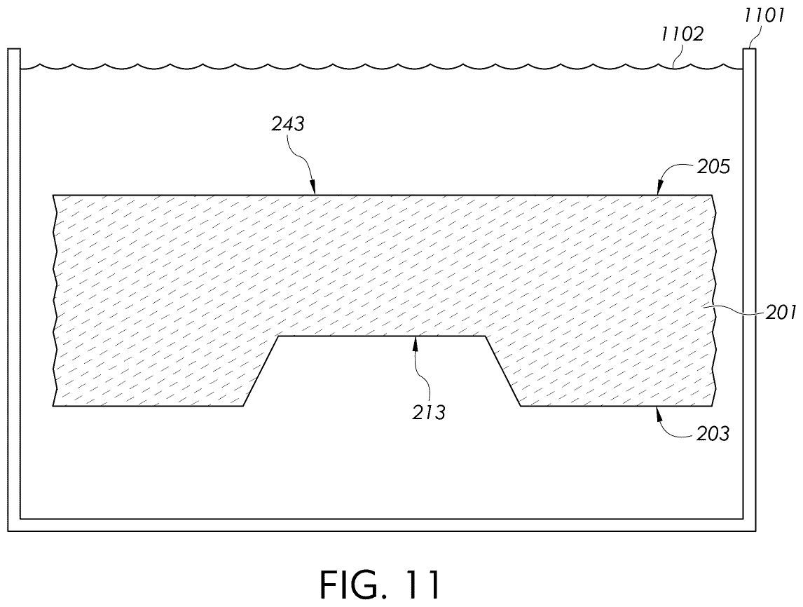

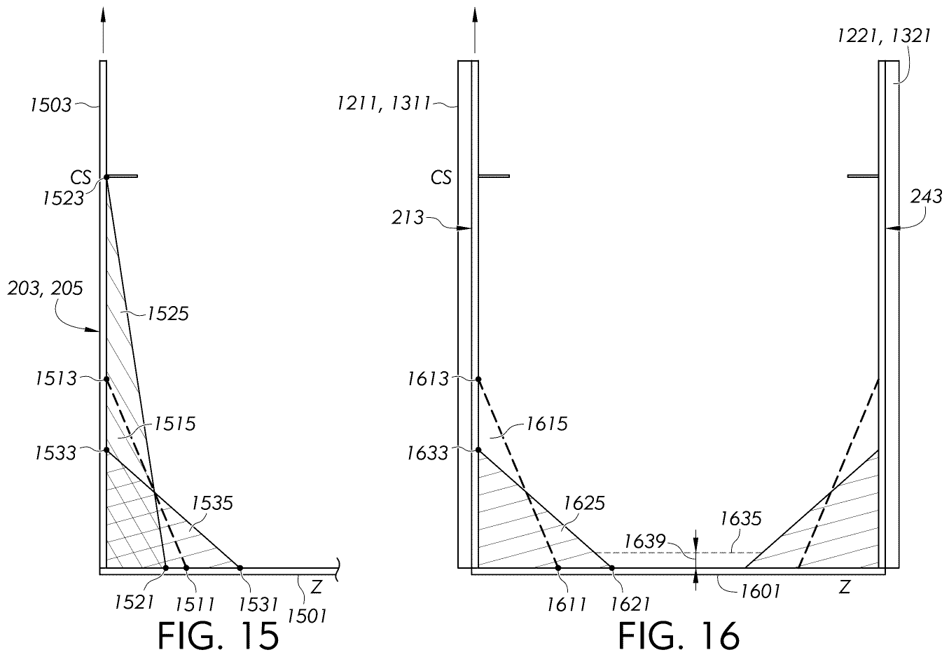

Aspects of methods of making the foldable apparatus 101, 301, 401, and/or 601 and/or foldable substrate 201 illustrated in FIGS. 2-3 and 5-6 in accordance with aspects of the disclosure will be discussed with reference to the flow chart in FIG. 10 and example method steps illustrated in FIGS. 11-14 and 19-21 and schematic development of stress profiles illustrated in FIGS. 15-18.

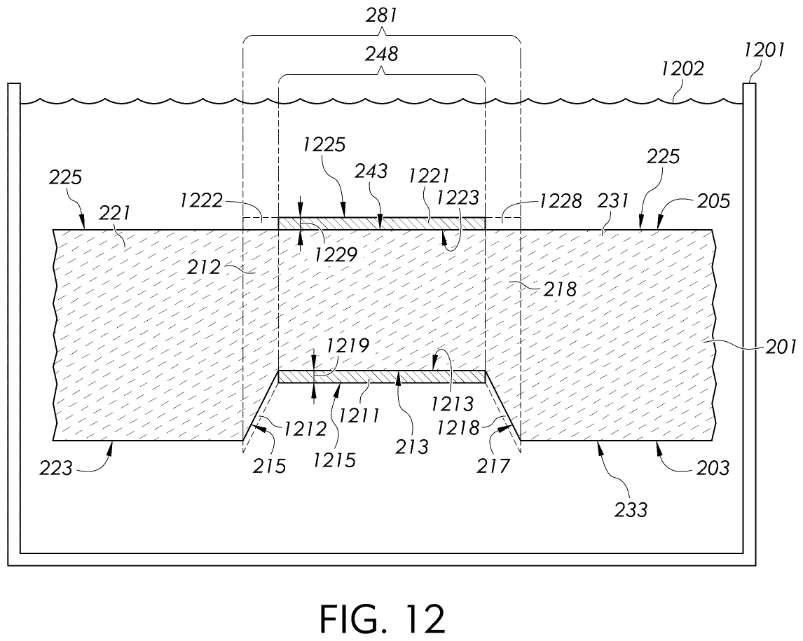

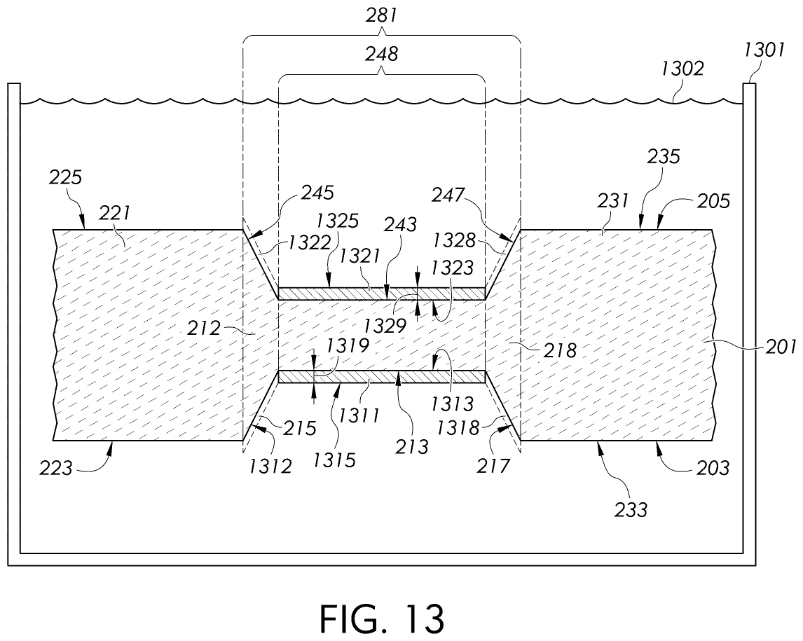

In a first step 1001 of methods of the disclosure, methods can start with obtaining a foldable substrate 201 (see FIGS. 11-12). In aspects, the foldable substrate 201 may be provided by purchase or otherwise obtaining a substrate or by forming the foldable substrate. In aspects, the foldable substrate 201 can comprise a glass-based substrate and/or a ceramic-based substrate. In further aspects, glass-based substrates and/or ceramic-based substrates can be provided by forming them with a variety of ribbon forming processes, for example, slot draw, down-draw, fusion down-draw, up-draw, press roll, redraw, or float. In further aspects, ceramic-based substrates can be provided by heating a glass-based substrate to crystallize one or more ceramic crystals. In aspects, the foldable substrate 201 can be substantially unstrengthened at the end of step 1001, although the foldable substrate may comprise one or more compressive stress regions at the end of step 1001 at the end of step 1001. As used herein, substantially unstrengthened refers to a substrate comprising either no depth of layer, no depth of compression, a depth of layer in a range from 0% to 5% of the substrate thickness, or a depth of compression in a range from 0% to 5% of the substrate thickness. In aspects, as shown in FIGS. 11-12, in step 1001, the foldable substrate 201 can comprise the first central surface area 213 recessed from the first major surface 203. Additionally, as shown in FIG. 13, the foldable substrate can additionally comprise a second central surface area 243 recessed from the second major surface 205 (see FIG. 2), although the second central surface area can be flush and/or coplanar with second major surface (see FIGS. 3 and 11-12). The central portion 281 comprises the first central surface area 213 and the second central surface area 243. Alternatively, methods can proceed to step 1003 comprising forming a first recess 211 and/or a second recess 241 (e.g., see FIGS. 2-3).

After step 1001, methods can proceed to step 1003 comprising by etching the central portion to form a first recess 211 and/or a second recess 241. Although not shown, step 1001 can comprise disposing an etching mask on the first portion and the second portion, leaving at least one side of the central portion exposed. For example, in aspects, an initial etching mask can be disposed on the entire first major surface and/or second major surface, where a central region of the etching mask can be subsequently removed. Alternatively, discrete portions can be disposed on the first portion and the second portion. Then, the central portion of the foldable substrate can be contacted with an etchant to remove form the first recess and/or the second recess and associated central surface area (e.g., first central surface area and/or second central surface area). For example, the foldable substrate with the etching mask(s) disposed thereon can be immersed in the etchant (e.g., contained in an etchant bath) to for the corresponding recess(s) and central surface area(s). Afterwards, the etching mask(s) can be removed. Consequently, the foldable substrate 201 resembling that shown in FIGS. 3 and 12 (having a first recess 211) or FIGS. 2 and 13 (having a second recess 241 opposite a first recess 211) can be formed. Additionally, in further aspects, the foldable substrate can be rinsed in water and/or an alkaline detergent solution during step 1003.

After step 1001, 1003, or 1011 (discussed below), in aspects, as shown in FIGS. 12-13, methods can proceed to step 1005 comprising disposing a diffusion layer over the central portion. In aspects (e.g., coming from step 1001 or 1003), the foldable substrate (still) be substantially unstrengthened at the beginning of step 1011, although the foldable substrate can be chemically strengthened as a result of step 1011 when coming to step 1005 from step 1011. In aspects, as shown in FIG. 12, a first diffusion layer 1211, 1311 can be disposed on the first central surface area 213. In further aspects, as indicated by regions 1212, 1312 and/or 1218, 1318 in dashed lines, the first diffusion layer 1211, 1311 can further extend over a first transition surface area 215 and/or the third transition surface area 217 (if present), although the first diffusion layer may be limited to (or cover-just) the first central surface area 213 (e.g., central region without covering the entire central portion). In aspects, as shown, the first diffusion layer 1211, 1311 comprises a first contact surface 1213, 1313 facing and/or contacting the first central surface area 213 with a second contact surface 1215, 1315 of the first diffusion layer 1211, 1311 opposite the first contact surface 1213, 1313 and a first diffusion layer thickness 1219, 1319 defined therebetween. In aspects, as shown in FIGS. 12-13, a second diffusion layer 1221, 1321 can be disposed on the second central surface area 243, including when the second central surface area 243 is coplanar with the second major surface 205 (as shown in FIG. 12) or when the second central surface area 243 is recessed from the second major surface 205 (as shown in FIG. 13). Additionally, in further aspects, as indicated by regions 1212, 1312 and 1218, 1318 in dashed lines, the second diffusion layer 1221, 1321 can further extend over the corresponding side of the foldable substrate for the entire central portion 281 (e.g., including regions 1222, 1322 and/or 1228, 1328), although the second diffusion layer 1221, 1321 can be limited to (or cover-just) the second central surface area 243. In aspects, as shown, the second diffusion layer 1221, 1321 comprises a third contact surface 1223, 1323 facing and/or contacting the second central surface area 243 with a fourth contact surface 1225, 1325 of the second diffusion layer 1221, 1321 opposite the third contact surface 1223, 1323 and a second diffusion layer thickness 1229, 1329 defined therebetween. In aspects, the first diffusion layer thickness 1219, 1319 can be equal to the second diffusion layer thickness 1229, 1329. In aspects, the first diffusion layer thickness 1219, 1319 and/or the second diffusion layer thickness 1229, 1329 can be 10 nanometers (nm) or more, 15 nm or more, 20 nm or more, 22 nm or more, 25 nm or more, 27 nm or more, 30 nm or more, 35 nm or more, 40 nm or less, 35 nm or less, 30 nm or less, 27 nm or less, 25 nm or less, 22 nm or less, 20 nm or less, or 15 nm or less. In aspects, the first diffusion layer thickness 1219, 1319 and/or the second diffusion layer thickness 1229, 1329 can be from greater than or equal to 10 nm to less than or equal to 40 nm, from greater than or equal to 15 nm to less than or equal to 35 nm, from greater than or equal to 20 nm to less than or equal to 30 nm, from greater than or equal to 22 nm to less than or equal to 27 nm, from greater than or equal to 25 nm to less than or equal to 27 nm, or any range or subrange therebetween. In preferred aspects, the first diffusion layer thickness 1219, 1319 and/or the second diffusion layer thickness 1229, 1329 can be from greater than or equal to 10 nm to less than or equal to 40 nm or from greater than or equal to 20 to less than or equal to 30 nm. In aspects, the first diffusion layer 1211, 1311 and/or the second diffusion layer 1221, 1321 can be an oxynitride material, for example, silicon oxynitride, aluminum oxynitride, alkali-silicon oxynitrides, or combinations thereof. In preferred aspects, the first diffusion layer 1211, 1311 and/or the second diffusion layer 1221, 1321 is aluminum oxynitride. In aspects, the first diffusion layer 1211, 1311 and/or the second diffusion layer 1221, 1321 can be disposed by chemical vapor deposition (CVD) (e.g., low-pressure CVD, plasma-enhanced CVD), physical vapor deposition (PVD) (e.g., evaporation, molecular beam epitaxy, ion plating), atomic layer deposition (ALD), sputtering, spray pyrolysis, chemical bath deposition, and/or sol-gel deposition.

After step 1005, as shown in FIGS. 12-13, methods can proceed to step 1007 comprising chemically strengthening the foldable substrate 201 with the diffusion layer (e.g., first diffusion layer 1211 and/or second diffusion layer 1221) disposed thereon. In aspects, as shown, chemically strengthening the foldable substrate 201 can comprise contacting at least a portion of a foldable substrate 201 a first molten salt solution 1202 or 1302 (e.g., contained in a first molten salt bath 1201 or 1301). Chemically strengthening a foldable substrate 201 (e.g., glass-based substrate, ceramic-based substrate) by ion exchange can occur when a first cation within a depth of a surface of a foldable substrate 201 is exchanged with a second cation within a first molten salt solution 1202 or 1302 that has a larger radius than the first cation. For example, a lithium cation or a sodium cation within the depth of the surface of the foldable substrate 201 can be exchanged with a potassium cation within a first molten salt solution 1302. Consequently, the surface of the foldable substrate 201 is placed in compression and thereby chemically strengthened by the ion exchange process since the lithium cation has a smaller radius than the radius of the exchanged sodium cation or potassium cation within the first molten salt solution 1302. In further aspects, as shown, the first portion 221 (e.g., first surface area 223, second surface area 225) and the second portion 231 (e.g., third surface area 233, fourth surface area 235) of the foldable substrate 201 can be in direct contact with and simultaneously ion-exchanged with the first molten salt solution 1202 or 1302, for example, by immersing the foldable substrate 201 in the first molten salt solution 1202 or 1302 contained in the first molten salt bath 1201 or 1301. In even further aspects, ion-exchange can occur between the central portion 281 (and/or the central region 248) and the first molten salt solution 1202 or 1302 through the corresponding diffusion layer, which slows down but does not entirely prevent (i.e., does not block) ion exchange therethrough.

In aspects, the chemical strengthening in step 1007 can occur for a first period of time while the first molten salt solution 1202 or 1302 is maintained at a first temperature. In further aspects, the first temperature can be 380° C. or more, 390° C. or more, 400° C. or more, 410° C. or more, 420° C. or more, 430° C. or more, 480° C. or less, 450° C. or less, 430° C. or less, or 420° C. or less. In aspects, the first temperature of can range from greater than or equal to 380° C. to less than or equal to 480° C., from greater than or equal to 390° C. to less than or equal to 450° C., from greater than or equal to 400° C. to less than or equal to 430° C., from greater than or equal to 410° C. to less than or equal to 420° C., or any range or subrange therebetween. In aspects, the first period of time can be 1 minute or more, 2 minutes or more, 5 minutes or more, 10 minutes or more, 15 minutes or more, 20 minutes or more, 30 minutes or more, 45 minutes or more, 1 hour or more, 3 hours or less, 2 hours or less, 1.5 hours or less, 1.0 hour or less, 45 minutes or less, 30 minutes or less, 20 minutes or less, or 10 minutes or less. In aspects, the first period of time can be from greater than or equal to 1 minute to less than or equal to 3 hours, from greater than or equal to 2 minutes to less than or equal to 2 hours, from greater than or equal to 5 minutes to less than or equal to 1.5 hours, from greater than 10 minutes to less than or equal to 1.0 hour, from greater than or equal to 15 minutes to less than or equal to 45 minutes, from greater than or equal to 20 minutes to less than or equal to 30 minutes, or any range or subrange therebetween.

In aspects, the first molten salt solution 1202 or 1302 in step 1007 can comprise a salt of the larger alkali metal (e.g., potassium) and optionally a sodium salt. In further aspects, the sodium salt, if present, can comprise sodium nitrate, although the sodium salt can be sodium carbonate, sodium sulfate, sodium chloride, etc. in other aspects—in addition to combinations of any of these salts. Likewise, in further aspects, the anion of the salt of the larger alkali metal can be nitrate (e.g., potassium nitrate), although the anion can be carbonate, sulfate, chloride, etc. in other aspects—in addition to combinations of any of these salts. In further aspects, an amount of the sodium salt in the first molten salt solution 1202 or 1302, based on 100 wt % of the first molten salt solution, can be 20 wt % or more, 22 wt % or more, 25 wt % or more, 27 wt % or more, 30 wt % or more, 33 wt % or more, 35 wt % or more, 40 wt % or more, 45 wt % or more, 50 wt % or more, 55 wt % or more, 60 wt % or more, 66 wt % or more, 70 wt % or more, 73 wt % or more, 75 wt % or more, 78 wt % or more, 80 wt % or less, 78 wt % or less, 75 wt % or less, 73 wt % or less, 70 wt % or less, 66 wt % or less, 60 wt % or less, 55 wt % or less, 50 wt % or less, 45 wt % or less, 40 wt % or less, 35 wt % or less, 33 wt % or less, 30 wt % or less, 27 wt % or less, 25 wt % or less, or 22 wt % or less. In further aspects, an amount of the lithium salt in the first molten salt solution 1202 or 1302, based on 100 wt % of the first molten salt solution, can be greater than or equal to 20 wt % to less than or equal to 80 wt %, from greater than or equal to 22 wt % to less than or equal to 78 wt %, from greater than or equal to 25 wt % to less than or equal to 75 wt %, from greater than or equal to 27 wt % to less than or equal to 73 wt %, from greater than or equal to 30 wt % to less than or equal to 70 wt %, from greater than or equal to 33 wt % to less than or equal to 66 wt %, from greater than or equal to 35 wt % to less than or equal to 60 wt %, from greater than or equal to 40 wt % to less than or equal to 55 wt %, from greater than or equal to 45 wt % to less than or equal to 50 wt %, or any range or subrange therebetween. In further aspects, a balance of the first molten salt solution (other than the lithium salt and any minor additives, for example silicic acid) can be a salt of the larger alkali metal oxide. In aspects, a concentration of the salt of the larger alkali metal in the first molten salt solution 1202 or 1302 can be within one or more of the ranges discussed above in this paragraph for the sodium salt. Alternatively, the first molten salt solution can optionally comprise 4 wt % or less of a sodium salt (e.g., sodium nitrate), for example, from greater than or equal to 0 wt % to less than or equal to 4 wt %, from greater than or equal to 0.5 wt % to less than or equal to 3.5 wt %, from greater than or equal to 1.0 wt % to less than or equal to 3.0 wt %, from greater than or equal to 1.5 wt % to less than or equal to 2.5 wt %, from greater than or equal to 1.5 wt % to less than or equal to 2.0 wt %, or any range or subrange therebetween. Alternatively, the first molten salt solution (before the chemically strengthening) can be free of a sodium salt. In further aspects, the first molten salt solution can further comprise silicic acid, for example, from 0.1 wt % to 1 wt %, from 0.25 wt % to 0.75 wt %, from 0.25 wt % to 0.5 wt %, which can be added by superaddition to the composition of the first molten salt solution discussed above in this paragraph. In aspects, the first molten salt solution can consist of a sodium salt, a salt of the larger alkali metal, and optionally silicic acid. Providing a sodium salt in addition to the salt of the larger alkali metal can allow a deep depth of layer to be developed without warping or buckling the foldable substrate.

When step 1007 occurs before step 1011 (if present), the chemical strengthening of the foldable substrate 201 in step 1007 can form a plurality of compressive stress regions in the first portion 221, the second portion 231, and/or the central portion 281. As discussed above, the diffusion layers do not necessarily prevent ion exchange; consequently, a compressive stress region can be developed in the central portion depending on the length of the chemical strengthening treatment, the thickness of the corresponding diffusion layer, etc., although a compressive stress layer may not be formed in the central portion as a result of step 1007 in other aspects. Without wishing to be bound by theory, the smaller lithium ions (e.g., from the first molten salt solution) can diffuse through the corresponding diffusion layer faster than the larger alkali metal ion (or other alkali metal ions in the foldable substrate), which can result in an increase in a concentration of lithium within the central portion (as well as the first portion and the second portion) extending from the corresponding surface without necessarily producing a noticeable increase in a concentration of the larger alkali metal in the central portion (e.g., extending from the corresponding central surface area).

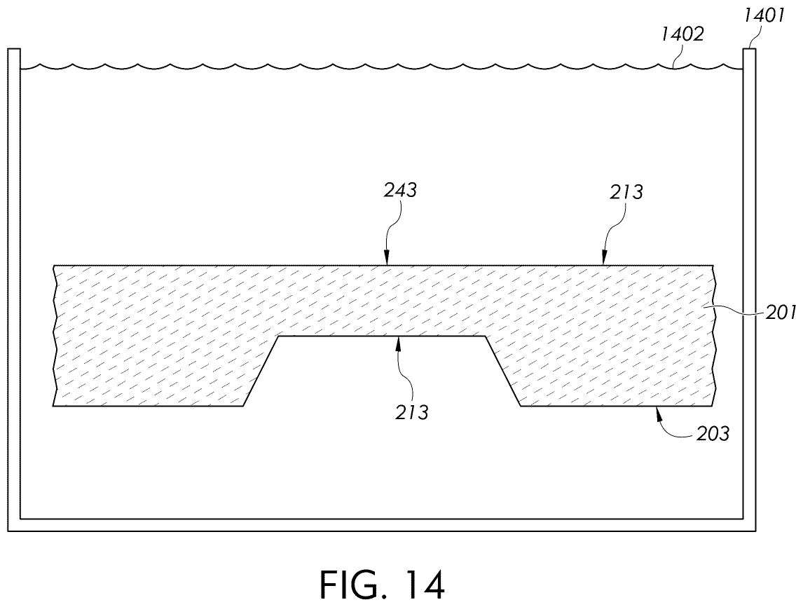

After step 1007, as shown in FIGS. 11 and 14 (compared to FIGS. 12-13), methods can proceed to step 1009 comprising removing the diffusion layer(s) from the foldable substrate 201. In aspects, the first diffusion layer 1211 can be removed from the first central surface area 213, and/or the second diffusion layer 1221 can be removed from the second central surface area 243. In aspects, the diffusion layer(s) can be removed using a tool (e.g., grinding, sweeping, pushing, polishing), using a laser, and/or washing the foldable substate (e.g., contacting the diffusion layer(s) with an acidic solution or a basic solution).

After step 1001, 1003, or 1009, in aspects, as shown in FIG. 11, methods can proceed to step 1011 comprising chemically strengthening the foldable substrate. In aspects (e.g., coming from step 1001 or 1003), the foldable substrate (still) be substantially unstrengthened at the beginning of step 1011, although the foldable substrate can be chemically strengthened as a result of step 1007 when coming to step 1011 from step 1009. In aspects, as shown, chemically strengthening the foldable substrate 201 can comprise contacting at least a portion of a foldable substrate 201 with a second molten salt solution 1102 (e.g., contained in a second molten salt bath 1101). In aspects, as shown, chemically strengthening the foldable substrate 201 in step 1011 can comprise immersing the foldable substrate 201 in the second molten salt solution 1102 contained in the second molten salt bath 1101. In aspects, as shown, step 1011 can comprise simultaneously contacting the first major surface 203, the second major surface 205, the first central surface area 213, and the second central surface area 243 with the second molten salt solution 1102. Consequently, in aspects, ion exchange can simultaneously occur between the first portion 221, the second portion 231, and the central portion 281 of the foldable substrate 201 and the second molten salt solution 1102 in step 1011.

In aspects, the second molten salt solution 1102 in step 1011 can comprise a salt of the larger alkali metal (e.g., potassium). In further aspects, the anion of the salt of the larger alkali metal can be nitrate (e.g., potassium nitrate), although the anion can be carbonate, sulfate, chloride, etc. in other aspects—in addition to combinations of any of these salts. In further aspects, an amount of the salt of the larger alkali metal, based on 100 wt % of the second molten salt solution, can be 20 wt % or more, 22 wt % or more, 25 wt % or more, 27 wt % or more, 30 wt % or more, 33 wt % or more, 35 wt % or more, 40 wt % or more, 45 wt % or more, 50 wt % or more, 55 wt % or more, 60 wt % or more, 66 wt % or more, 70 wt % or more, 73 wt % or more, 75 wt % or more, 78 wt % or more, 100 wt % or less, 95 wt % or less, 90 wt % or less, 85 wt % or less, 80 wt % or less, 78 wt % or less, 75 wt % or less, 73 wt % or less, 70 wt % or less, 66 wt % or less, 60 wt % or less, 55 wt % or less, 50 wt % or less, 45 wt % or less, 40 wt % or less, 35 wt % or less, 33 wt % or less, 30 wt % or less, 27 wt % or less, 25 wt % or less, or 22 wt % or less. In further aspects, an amount of the salt of the larger alkali metal, based on 100 wt % of the second molten salt solution, can from be greater than or equal to 20 wt % to less than or equal to 80 wt %, from greater than or equal to 22 wt % to less than or equal to 78 wt %, from greater than or equal to 25 wt % to less than or equal to 75 wt %, from greater than or equal to 27 wt % to less than or equal to 73 wt %, from greater than or equal to 30 wt % to less than or equal to 70 wt %, from greater than or equal to 33 wt % to less than or equal to 66 wt %, from greater than or equal to 35 wt % to less than or equal to 60 wt %, from greater than or equal to 40 wt % to less than or equal to 55 wt %, from greater than or equal to 45 wt % to less than or equal to 50 wt %, or any range or subrange therebetween. In further aspects, an amount of the salt of the larger alkali metal, based on 100 wt % of the second molten salt solution, can be 50 wt % or more, for example, from greater than or equal to 50 wt % to less than or equal to 100 wt %, from greater than or equal to 55 wt % to less than or equal to 95 wt %, from greater than or equal to 60 wt % to less than or equal to 90 wt %, from greater than or equal to 66 wt % to less than or equal to 85 wt %, from greater than or equal to 70 wt % to less than or equal to 80 wt %, from greater than or equal to 75 wt % to less than or equal to 80 wt %, or any range or subrange therebetween. In further aspects, the second molten salt solution 1102 can be free of a sodium salt (before ion exchange with the foldable substrate. Alternatively, an amount of the sodium salt in the second molten salt solution can be greater than or equal to 20 wt % to less than or equal to 80 wt %, from greater than or equal to 22 wt % to less than or equal to 78 wt %, from greater than or equal to 25 wt % to less than or equal to 75 wt %, from greater than or equal to 27 wt % to less than or equal to 73 wt %, from greater than or equal to 30 wt % to less than or equal to 70 wt %, from greater than or equal to 33 wt % to less than or equal to 66 wt %, from greater than or equal to 35 wt % to less than or equal to 60 wt %, from greater than or equal to 40 wt % to less than or equal to 55 wt %, from greater than or equal to 45 wt % to less than or equal to 50 wt %, or any range or subrange therebetween. Alternatively, the second molten salt solution can optionally comprise 4 wt % or less of a sodium salt (e.g., sodium nitrate), for example, from greater than or equal to 0 wt % to less than or equal to 4 wt %, from greater than or equal to 0.5 wt % to less than or equal to 3.5 wt %, from greater than or equal to 1.0 wt % to less than or equal to 3.0 wt %, from greater than or equal to 1.5 wt % to less than or equal to 2.5 wt %, from greater than or equal to 1.5 wt % to less than or equal to 2.0 wt %, or any range or subrange therebetween In further aspects, the second molten salt solution 1102 can optionally comprise silicic acid in an amount, by superaddition to the second molten salt solution, in a range from greater than 0 wt % to 1 wt %, from 0.1 wt % to 0.9 wt %, from 0.2 wt % to 0.8 wt %, from 0.3 wt % to 0.7 wt %, from 0.4 wt % to 0.6 wt %, or any range or subrange therebetween. In aspects, the second molten salt solution 1102 can consist of a salt of the larger alkali metal, a sodium salt, and optionally silicic acid.

In aspects, the second molten salt solution 1102 in step 1011 can include a lithium salt in addition to at least the salt of the larger alkali metal oxide. In further aspects, the lithium salt can comprise lithium nitrate, although the lithium salt can be lithium carbonate, lithium sulfate, lithium chloride, etc. in other aspects—in addition to combinations of any of these salts. Likewise, in further aspects, the anion of the salt of the larger alkali metal can be nitrate (e.g., potassium nitrate), although the anion can be carbonate, sulfate, chloride, etc. in other aspects—in addition to combinations of any of these salts. In further aspects, an amount of the lithium salt in the second molten salt solution 1102, based on 100 wt % of the first molten salt solution, can be 0.1 wt % or more, 0.2 wt % or more, 0.25 wt % or more, 0.3 wt % or more, 0.4 wt % or more, 0.5 wt % or more, 0.6 wt % or more, 0.75 wt % or more, 1.0 wt % or less, 0.8 wt % or less, 0.7 wt % or less, 0.66 wt % or less, 0.5 wt % or less, or 0.25 wt % or less. In further aspects, an amount of the lithium salt in the second molten salt solution 1102, based on 100 wt % of the first molten salt solution, can be greater than or equal to 0.1 wt % to less than or equal to 1.0 wt %, from greater than or equal to 0.2 wt % or more to less than or equal to 0.8 wt %, from greater than or equal to 0.25 wt % to less than or equal to 0.75 wt %, from greater than or equal to 0.3 wt % to less than or equal to 0.66 wt %, from greater than or equal to 0.4 wt % to less than or equal to 0.5 wt %, or any range or subrange therebetween. When the second molten salt solution is free of a sodium salt, the balance of the second molten salt solution (other than any minor additives, including silicic acid) can be the salt of the larger alkali metal. For example, an amount of the salt of the larger alkali metal (e.g., potassium nitrate), based on 100 wt % of the second molten salt solution, can be 95 wt % or more, 95.5 wt % or more, 96.0 wt % or more, 96.5 wt % or more, 97.0 wt % or more, 97.25 wt % or more, 97.5 wt % or more, 97.75 wt % or more, 98.0 wt % or more, 98.25 wt % or more, 98.5 wt % or more, 98.75 wt % or more, 99.0 wt % or more, 99.1 wt % or more, 99.25 wt % or more, 99.5 wt % or more, 99.75 wt % or more, 99.9 wt % or less, 99.8 wt % or less, 99.75 wt % or less, 99.5 wt % or less, 99.25 wt % or less, 99.1 wt % or less, 99.0 wt % or less, 98.9 wt % or less, 98.75 wt % or less, 98.50 wt % or less, 98.25 wt % or less, 98.1 wt % or less, 98.0 wt % or less, 97.9 wt % or less, 97.75 wt % or less, 97.5 wt % or less, 97.25 wt % or less, 97.1 wt % or less, 97.0 wt % or less, 96.9 wt % or less, 96.75 wt % or less, 96.5 wt % or less, 96.25 wt % or less, 96.1 wt % or less, 96.0 wt % or less, or 95.5 wt % or less. In further aspects, an amount of the salt of the larger alkali metal (e.g., potassium nitrate), based on 100 wt % of the second molten salt solution, can be from greater than or equal to 95 wt % to less than or equal to 99.9 wt %, from greater than or equal to 95.5 wt % to less than or equal to 99.8 wt %, from greater than or equal to 96.0 wt % to less than or equal to 99.75 wt %, from greater than or equal to 96.5 wt % to less than or equal to 99.5 wt %, from greater than or equal to 97.0 wt % to less than or equal to 96.25 wt %, from greater than or equal to 99.25 wt % to less than or equal to 96.5 wt % to less than or equal to 99.1 wt %, from greater than or equal to 96.75 wt % to less than or equal to 99.0 wt %, from greater than or equal to 97.0 wt % to less than or equal to 98.9 wt %, from greater than or equal to 97.25 wt % to less than or equal to 98.75 wt %, from greater than or equal to 97.5 wt % to less than or equal to 98.5 wt %, from greater than or equal to 97.75 wt % to less than or equal to 98.25 wt %, from greater than or equal to 98.0 wt % to less than or equal to 98.1 wt %, or any range or subrange therebetween.

In aspects, the chemical strengthening in step 1011 can occur for a second period of time while the second molten salt solution 1102 is maintained at a second temperature. In further aspects, the second temperature can be 380° C. or more, 390° C. or more, 400° C. or more, 410° C. or more, 420° C. or more, 430° C. or more, 480° C. or less, 450° C. or less, 430° C. or less, or 420° C. or less. In aspects, the second temperature of can range from greater than or equal to 380° C. to less than or equal to 480° C., from greater than or equal to 390° C. to less than or equal to 450° C., from greater than or equal to 400° C. to less than or equal to 430° C., from greater than or equal to 410° C. to less than or equal to 420° C., or any range or subrange therebetween. In aspects, the second period of time can be 20 minutes or more, 25 minutes or more, 30 minutes or more, 40 minutes or more, 50 minutes or more, 60 minutes or more, 90 minutes or more, 120 minutes or more, 4 hour or less, 3 hours or less, 2 hours or less, 1.5 hours or less, 1.0 hour or less, 45 minutes or less, or 30 minutes or less. In aspects, the second period of time can be from greater than or equal to 20 minutes to less than or equal to 4 hours, from greater than or equal to 25 minutes to less than or equal to 3 hours, from greater than or equal to 30 minutes to less than or equal to 2 hours, from greater than 40 minutes to less than or equal to 1.5 hour, from greater than or equal to 50 minutes to less than or equal to 60 minutes, or any range or subrange therebetween. Additionally, in further aspects, the foldable substrate can be rinsed in water and/or an alkaline detergent solution after the chemical strengthening but still in step 1011.

After step 1009, or 1011, in aspects, as shown in FIG. 14, methods can proceed to step 1013 comprising further chemically strengthening the foldable substrate. In aspects, as shown, chemically strengthening the foldable substrate 201 can comprise contacting at least a portion of a foldable substrate 201 with a third molten salt solution 1402 (e.g., contained in a third molten salt bath 1401). In aspects, as shown, chemically strengthening the foldable substrate 201 in step 1013 can comprise immersing the foldable substrate 201 in the third molten salt solution 1402 contained in the third molten salt bath 1401. In aspects, as shown, step 1013 can comprise simultaneously contacting the first major surface 203, the second major surface 205, the first central surface area 213, and the second central surface area 243 with the third molten salt solution 1402. Consequently, in aspects, ion exchange can simultaneously occur between the first portion 221, the second portion 231, and the central portion 281 of the foldable substrate 201 and the third molten salt solution 1402 in step 1013.

In aspects, the third molten salt solution 1402 in step 1013 can comprise a salt of the larger alkali metal (e.g., potassium). In further aspects, the anion of the salt of the larger alkali metal can be nitrate (e.g., potassium nitrate), although the anion can be carbonate, sulfate, chloride, etc. in other aspects—in addition to combinations of any of these salts. In further aspects, an amount of the salt of the larger alkali metal, based on 100 wt % of the third molten salt solution, can be 90 wt % or more, 92 wt % or more, 94 wt % or more, 96 wt % or more, 97 wt % or more, 98 wt % or more, 99.0 wt % or more, 99.1 wt % or more, 99.25 wt % or more, 99.5 wt % or more, 99.75 wt % or more, 99.9 wt % or more, 100 wt % or less, 99.9 wt % or less, 99.75 wt % or less, 99.5 wt % or less, 99.25 wt % or less, 99.1 wt % or less, 99.0 wt % or less, 98 wt % or less, 97 wt % or less, 96 wt % or less, 95 wt % or less, 94 wt % or less, or 92 wt % or less. In further aspects, an amount of the salt of the larger alkali metal, based on 100 wt % of the third molten salt solution, can be greater than or equal to 90 wt % to less than or equal to 100 wt %, from greater than or equal to 92 wt % to less than or equal to 99.9 wt %, from greater than or equal to 94 wt % to less than or equal to 99.75 wt %, from greater than or equal to 96 wt % to less than or equal to 99.5 wt %, from greater than or equal to 97 wt % to less than or equal to 99.25 wt %, from greater than or equal to 98 wt % to less than or equal to 99.0 wt %, from greater than or equal to 99.1 wt % to less than or equal to 60 wt %, or any range or subrange therebetween. In further aspects, the amount of the salt of the larger alkali metal, based on 100 wt % of the third molten salt solution, can be 99.0 wt % or more, for example, from greater than or equal to 99.0 wt % to less than or equal to 100 wt %, from greater than or equal to 99.1 wt % to less than or equal to 99.9 wt %, from greater than or equal to 99.25 wt % to less than or equal to 99.75 wt %, from greater than or equal to 99.5 wt % to less than or equal to 99.75 wt %, or any range or subrange therebetween. In further aspects, the third molten salt solution 1402 can further comprise a lithium salt. In even further aspects, an amount of the lithium salt in the third molten salt solution, based on 100 wt % of the third molten salt solution, can be 0.0 wt % or more, 0.02 wt % or more, 0.05 wt % or more, 0.1 wt % or more, 0.25 wt % or more, 0.33 wt % or more, 0.4 wt % or more, 0.5 wt % or more, 0.6 wt % or more, 0.66 wt % or more, 0.75 wt % or more, 0.9 wt % or more, 1.0 wt % or less, 0.9 wt % or less, 0.75 wt % or less, 0.66 wt % or less, 0.6 wt % or less, 0.5 wt % or less, 0.4 wt % or less, 0.33 wt % or less, 0.25 wt % or less, or 0.1 wt % or less. In even further aspects, an amount of the lithium salt in the third molten salt solution, based on 100 wt % of the third molten salt solution, can be greater than or equal to 0.0 wt % to less than or equal to 1.0 wt %, from greater than or equal to 0.02 wt % to less than or equal to 0.9 wt %, from greater than or equal to 0.05 wt % to less than or equal to 0.75 wt %, from greater than or equal to 0.1 wt % to less than or equal to 0.66 wt %, from greater than or equal to 0.25 wt % to less than or equal to 0.6 wt %, from greater than or equal to 0.33 wt % to less than or equal to 0.5 wt %, or any range or subrange therebetween. In further aspects, the third molten salt solution can comprise the lithium salt within one or more of the ranges mentioned above in this paragraph with the balance comprising the salt of the larger alkali metal. In further aspects, the In further aspects, the third molten salt solution 1402 can optionally comprise silicic acid in an amount, by superaddition to the third molten salt solution, in a range from greater than 0 wt % to 1 wt %, from 0.1 wt % to 0.9 wt %, from 0.2 wt % to 0.8 wt %, from 0.3 wt % to 0.7 wt %, from 0.4 wt % to 0.6 wt %, or any range or subrange therebetween. In aspects, the third molten salt solution 1402 can consist of a salt of the larger alkali metal, optionally a lithium salt, and optionally silicic acid.

In aspects, the chemical strengthening in step 1013 can occur for a third period of time while the third molten salt solution 1402 is maintained at a third temperature. In further aspects, the third temperature can be 380° C. or more, 390° C. or more, 400° C. or more, 410° C. or more, 420° C. or more, 430° C. or more, 450° C. or more, 480° C. or more, 500° C. or more, 530° C. or less, 520° C. or less, 500° C. or less, 480° C. or less, 450° C. or less, 430° C. or less, or 420° C. or less. In aspects, the third temperature of can range from greater than or equal to 380° C. to less than or equal to 530° C., from greater than or equal to 390° C. to less than or equal to 520° C., from greater than or equal to 400° C. to less than or equal to 500° C., from greater than or equal to 410° C. to less than or equal to 480° C., from greater than or equal to 420° C. to less than or equal to 450° C., or any range subrange therebetween. Additionally or alternatively, the third temperature can be within one or more of the ranges discussed above for the first temperature or the second temperature in steps 1007 and 1011, respectively. In aspects, the third period of time can be 1 minute or more, 5 minutes or more, 10 minutes or more, 15 minutes or more, 20 minutes or more, 30 minutes or less, 20 minutes or less, 15 minutes or less, 10 minutes or less, or 5 minutes or less. In aspects, the third period of time can be greater than or equal to 1 minute to less than or equal to 30 minutes, from greater than or equal to 5 minutes to less than or equal to 20 minutes, from greater than or equal to 10 minutes to less than or equal to 15 minutes, or any range or subrange therebetween. Additionally, in further aspects, the foldable substrate can be rinsed in water and/or an alkaline detergent solution after the chemical strengthening but still in step 1013.

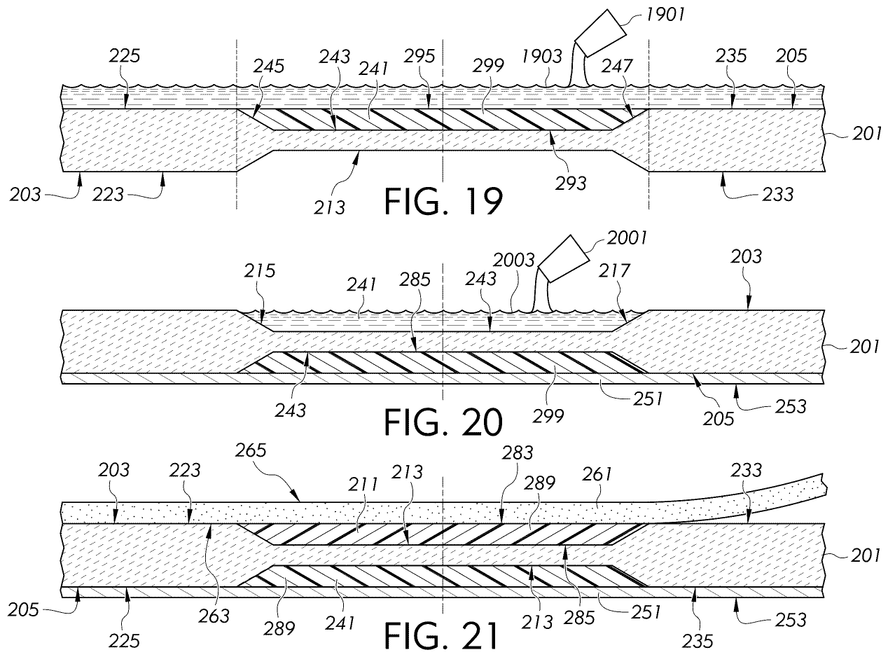

After step 1009, 1011, or 1013, in aspects, methods can proceed to step 1015. In aspects, step 1015 can comprise contacting the foldable substrate with an etchant solution, for example, etching the foldable substrate to remove a uniform thickness (e.g., from 0.1 μm to 5 μm, from 0.1 μm to 2 μm, from 0.2 μm to 1 μm, from 0.5 μm to 0.8 μm, or any range or subrange therebetween) from the foldable substrate. Etching the foldable substrate in step 1015 can remove flaws near or at the surface of the foldable substrate 201 (e.g., created or magnified by the chemical strengthening in or more of steps 1007, 1011, and/or 1013), which can increase a strength (e.g., pen drop height) and/or flexibility (e.g., ability to achieve a particular parallel plate distance) of the foldable substrate 201. Additionally or alternatively, in aspects, as shown in FIGS. 19-21, step 1015 can comprise assembling a foldable apparatus comprising the foldable substrate. In aspects, as shown in FIGS. 19-21, step 1009 can comprise assembling the foldable apparatus by disposing a polymer-based portion (e.g., first polymer-based portion 289, second polymer-based portion 299), an adhesive layer 261, and/or a coating 251 over the foldable substrate 201. In further aspects, as shown in FIG. 19, a first polymer-based portion 289 can be disposed in the first recess 211 and/or over the first central surface area 213. In further aspects, as shown in FIGS. 19-20, a coating 251 can be disposed over the first major surface 203 (e.g., first surface area 223 and third surface area 233), for example, by dispensing a first liquid 1903 from a container 1901 (e.g., conduit, flexible tube, micropipette, or syringe) over the first major surface 203 that can be cured to form the coating 251. In even further aspects, the first liquid 1903 may comprise a coating precursor, a solvent, particles, nanoparticles, and/or fibers. In still further aspects, the coating precursor can comprise, without limitation, one or more of a monomer, an accelerator, a curing agent, an epoxy, and/or an acrylate. Curing the first liquid 1903 can comprise heating the first liquid 1903, irradiating the first liquid 1903 with ultraviolet (UV) radiation, and/or waiting a predetermined amount of time (e.g., from 30 minutes to 24 hours, from 1 hour to 8 hours). In aspects, although not shown, the coating 251 can be disposed in the first recess 211 (e.g., fill the first recess 211) without contacting the first major surface 203 (e.g., first surface area 223, third surface area 233), for example, in place of the first polymer-based portion 289 in FIGS. 19-21. In further aspects, as shown in FIGS. 19-21, a second polymer-based portion 299 can be disposed in the second recess 241, for example, by dispensing a second liquid 2003 from a container 2001 (e.g., conduit, flexible tube, micropipette, or syringe) over the second central surface area 243 that can be cured to form the second polymer-based portion 299. Curing the second liquid 2003 can comprise heating the second liquid 2003, irradiating the second liquid 2003 with ultraviolet (UV) radiation, and/or waiting a predetermined amount of time (e.g., from 30 minutes to 24 hours, from 1 hour to 8 hours). In further aspects, as shown in FIG. 20, an adhesive layer 261 can contact the second major surface 205 (e.g., the second surface area 225 and the fourth surface area 235). For example, the adhesive layer 261 can comprise one or more sheets of an adhesive material. In aspects, there can be an integral interface between the one or more sheets comprising the adhesive layer 261, which can reduce (e.g., avoid) optical diffraction and/or optical discontinuities as light travels between the sheets since the one or more sheets can include substantially the same index of refraction. In aspects, although not shown, at least a portion of the adhesive layer can be disposed in the second recess. In aspects, a release liner (see release liner 271 in FIG. 2) or a display device may be disposed on the adhesive layer 261 (e.g., second contact surface 265).

After step 1009, 1011, 1013, or 1015, in aspects, methods can proceed to step 1017, where methods of making the foldable substrate and/or the foldable apparatus can be complete. In aspects, methods of making a foldable substrate and/or a foldable apparatus in accordance with aspects of the disclosure can proceed along steps 1001, 1003, 1005, 1007, 1009, 1011, 1013, 1015, and 1017 of the flow chart in FIG. 10 sequentially, as discussed above. In aspects, methods can follow arrow 1002 from step 1001 to step 1005, for example, if the foldable substrate 201 already comprises the first recess at the end of step 1001. In aspects, methods can follow arrow 1004 from step 1001 to step 1011, for example, if the foldable substrate 201 already comprises the first recess at the end of step 1001 and the foldable substrate is to be initially chemically strengthened (in step 1011) before the diffusion layer(s) is/are disposed thereon (in step 1005). In aspects, methods can follow arrow 1006 from step 1003 to step 1011, for example, if the foldable substrate is to be initially chemically strengthened (in step 1011) before the diffusion layer(s) is/are disposed thereon (in step 1005). In aspects, methods can follow arrow 1008 from step 1011 to step 1005, for example, if the foldable substrate was (initially) chemically strengthened in step 1011 (e.g., following arrow 1004 or 1006) before the diffusion layer was disposed thereon (in step 1005). In aspects, methods can follow arrow 1010 from step 1009 to step 1017, for example, if methods are complete at the end of step 1017. In aspects, methods can follow arrow 1012 from step 1009 to step 1015, for example, if the foldable substrate is to be assembled into a foldable apparatus and/or etched (in step 1015) without being further chemically strengthened in step 1013. In aspects, methods can follow arrow 1014 from step 1011 to step 1017, for example, if methods are complete at the end of step 1011. In aspects, methods can follow arrow 1016 from step 1011 to step 1016, for example, if the foldable substrate is to be assembled into a foldable apparatus and/or etched (in step 1015) without being further chemically strengthened in step 1013. In aspects, methods can follow arrow 1018 from step 1013 to step 1017, for example, if methods are complete at the end of step 1013. Any of the above options may be combined to make a foldable apparatus in accordance with the embodiments of the disclosure.

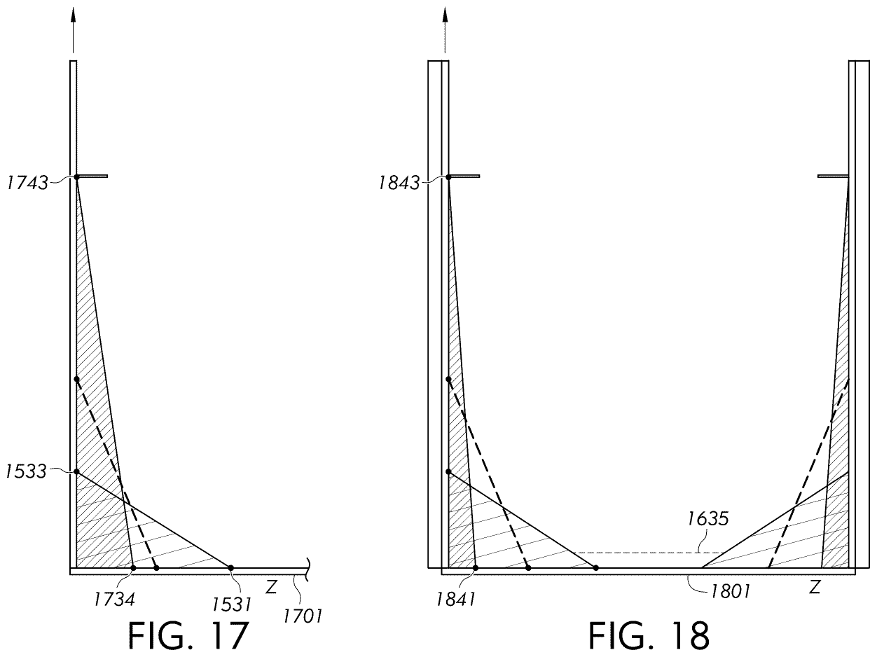

A few exemplary aspects of methods will now be discussed with reference to the flow chart in FIG. 10 and the development of stress profiles schematically illustrated in FIGS. 15-18. FIGS. 15 and 17 schematically present compressive stress (and added ion profiles) on the vertical axis 1503 or 1703 generated by the chemical strengthening steps as a function of depth (z) from the first major surface 203 and/or the second major surface 205 (e.g., in the first portion and/or the second portion) on the horizontal axis 1501 or 1701. FIGS. 16 and 18 schematically present compressive stress on the vertical axis 1603 or 1803 generated by the chemical strengthening steps as a function of depth (z) from the first central surface area 213 and/or the second central surface area 243 (e.g., in the central portion) on the horizontal axis 1601 or 1801.

In a first exemplary aspects, methods can proceed through steps 1001, (optionally 1003), 1011, 1005, 1007, 1009, (optionally 1013), (optionally step 1015), and 1017 sequentially. In this aspect, as shown in FIG. 15, the first chemical strengthening treatment (in step 1011) with the larger alkali metal (e.g., optionally including lithium salt and/or sodium salt) in the molten salt solution ion exchanges the larger alkali metal to an initial depth of layer 1511 and an initial surface compressive stress 1513 and a corresponding initial compressive stress region 1515 extending therebetween. Likewise, as shown in FIG. 16, the first chemical strengthening treatment (in step 1011) creates an initial central compressive stress region 1615 with an initial central compressive stress 1613 and an initial central depth of layer 1611. In further aspects, the amount of the salt of the larger alkali metal in the molten salt solution (in step 1011) relative to other components (e.g., sodium salt and/or lithium salt) therein can be selected to achieve a deep initial depth of layer for a relatively low surface compressive stress. When the first molten salt solution contains a lithium salt, diffusion of the lithium salt into the central portion can be such that a concentration profile of lithium throughout the central portion is elevated (e.g., relative to the composition at the first midpoint in first portion), although the added lithium can further diffuse in subsequent chemical strengthening treatments that can result in the non-zero lithium concentration profile throughout the central thickness.

Then, the second chemical strengthening treatment (in step 1007, e.g., without a lithium salt) with the diffusion layer(s) 1211, 1221 or 1311, 1321 (see FIG. 16) disposed over the central portion. Consequently, the effect of salt of the larger alkali metal in this molten salt solution is primarily on the first portion and the second portion (relative to the central portion) since the first portion and the second portion directly contact this molten salt solution while the diffusion layer(s) reduce (e.g., slow) the ion-exchange in the central portion. In further aspects, an amount of the salt of the larger alkali metal (as a wt % of the molten salt solution in step 1007) can be greater than the corresponding amount of the salt of the larger alkali metal (as a wt % of the molten salt solution in step 1011), which can facilitate the formation of a higher surface compressive stress at the end of step 1007 (relative to earlier step 1011). For example, as shown in FIG. 15, the second chemical strengthening treatment (in step 1007) can increase the (intermediate) surface compressive stress 1523 (relative to the initial surface compressive stress 1523) as part of the intermediate compressive stress region 1525 added (e.g., modified, increased) in this step. At the same time, the duration of the second chemical strengthening treatment (in step 1007) can be limited such that the intermediate depth of layer 1521 of the larger alkali metal added in the second chemical strengthening treatment can be less than the initial depth of layer 1511. It is to be understood that the larger alkali metal (ions) added in step 1011 will diffuse in step 1007 due to the elevated temperature of the second chemical strengthening treatment, for example, as indicated by the decreased surface compressive stress 1533 and increased depth of layer 1531 of the thermally diffused compressive stress layer 1535 (and/or concentration profile) for the ions introduced in the first chemical strengthening treatment (in step 1007). For the central portion, as shown in FIG. 16, changes to the stress profile and/or larger alkali metal concentration profile (in the central portion—in step 1007) can be largely the result of diffusion of the larger alkali metal (ions) previously introduced (in step 1011). As such, the central surface compressive stress 1633 can decrease relative to the initial central compressive stress 1613 while the depth of layer 1621 associated with the resulting compressive stress region 1625 can be deeper than the initial depth of layer 1611. Alternatively, some of the larger alkali metal from the second molten salt solution make it through the diffusion layer to ion exchange with alkali metal ions in the central portion. For example, as discussed below with reference to Example 1, the additional larger alkali metal ions introduced into the central portion by the second molten salt solution can enable the concentration of the larger alkali metal to be elevated through the central thickness. Alternatively or additionally, as shown in FIG. 16 (and FIG. 18), a concentration profile of one or more of the alkali metals (from one or more of the molten salt solutions in step 1011 and/or 1007) in the central portion can be elevated (concentration 1639 associated with region 1635) throughout the thickness (e.g., relative to the central concentration of the first portion). As discussed above, this first exemplary aspect of methods can comprise the two chemical strengthening treatments discussed above with reference to FIGS. 15-16; alternatively, this first exemplary aspect of methods can (optionally) further include a third chemical strengthening treatment (discussed below).

In further aspects, this first exemplary aspect of methods can optionally include a third chemical strengthening treatment (in step 1013) after the diffusion layer(s) is/are removed. This third chemical strengthening treatment can comprise an amount of the salt of the larger alkali metal (as a wt % of the molten salt solution in step 1013) that is greater than (or equal to) the corresponding amount of the salt of the larger alkali metal in either of the previous molten salt solution (as a wt % of the molten salt solution in step 1011 or step 1007, respectively). In even further aspects, a third period of time for the third chemical strengthening treatment can be greater than the corresponding period of time for the first chemical strengthening treatment. Consequently, as shown in FIG. 17, the depth of layer 1734 of ions introduced in the third chemical strengthening treatment can be less than the depth of layers initially created by the other treatments while the associated compressive stress 1743 can be greater than the corresponding compressive stress initially created by the other compressive stress treatments. A resulting stress profile can be approximated by the of the compressive stress regions shown in FIG. 17. Likewise, for the central portion, as shown in FIG. 18, the depth of layer 1841 of ions introduced in the third chemical strengthening treatment can be less than the depth of layers initially created by the other treatments while the associated compressive stress 1843 can be greater than the corresponding compressive stress initially created by the other compressive stress treatments.

In a first exemplary aspect, methods can proceed through steps 1001, (optionally 1003), 1005, 1007, 1009, 1011, (optionally 1013), (optionally step 1015), and 1017 sequentially. In this aspect, as shown in FIG. 15, the first chemical strengthening treatment (in step 1007) with a first molten salt solution including the salt of the larger alkali metal with the diffusion layer(s) 1211, 1221 or 1311, 1321 (see FIG. 16) disposed over the central portion. Consequently, the effect of salt of the larger alkali metal in this molten salt solution is primarily on the first portion and the second portion (relative to the central portion) since the first portion and the second portion directly contact this molten salt solution while the diffusion layer(s) reduce (e.g., slow) the ion-exchange in the central portion. For example, as shown in FIG. 15, the first chemical strengthening treatment (in step 1007) can form an (initial) compressive stress region 1525 extending to an (initial) depth of layer 1521 in the first portion. For the central portion, as shown in FIG. 16, the ion concentration profile of added ions can have the same shape as for the first portion, but the magnitude can be reduced due to the diffusion layer(s). Consequently, the depth of layer can be relatively shallow (e.g., depth of layer 1611 compared to step 1011 in the exemplary aspect of the method discussed above). In further aspects, the duration of this chemical strengthening treatment can be short enough that substantially none of the larger alkali metal (ion) is exchanged into the central portion, although the duration can be such that there is some alkali metal (ions) exchanged into the central portion.

Then, the second chemical strengthening treatment (in step 1011—e.g., with the lithium salt) with the corresponding molten salt solution after the diffusion layer(s) have been removed. In further aspects, an amount of the salt of the larger alkali metal (as a wt % of the molten salt solution in step 1011) can be less than the corresponding amount of the salt of the larger alkali metal (as a wt % of the molten salt solution in step 1007), which can facilitate the formation of a lower addition to the surface compressive stress at the end of step 1011 (relative to earlier step 1007). Additionally or alternatively, in further aspects, a duration of the second chemical strengthening treatment (in step 1011) can be greater than the duration of the first chemical strengthening treatment (in step 1007), which can facilitate the formation of a deeper depth of layer in the second chemical strengthening treatment. As shown in FIG. 15, step 1011 can introduce the larger alkali metal (ions) to form a corresponding compressive stress region 1535 with deep depth of layer 1531 but a comparatively low contribution to the surface compressive stress 1533. Likewise, in the central portion, as shown in FIG. 16, this chemical strengthening treatment can introduce a relatively deep depth of compression and/or depth of layer 1621). Additionally, the duration of this compressive stress region can be sufficient to ensure that the lithium ions introduced in this (second) chemical strengthening treatment (step 1011) extends throughout the central thickness. In aspects, after the second chemical strengthening treatment (in step 1011), this exemplary aspect can further (optionally) comprise a third chemical strengthening treatment, which can have the same effect and/or properties discussed above with reference to FIGS. 17-18.

### EXAMPLES

Various aspects will be further clarified by the following examples. Examples A-Z and YY-ZZ and Comparative Examples AA-DD comprise a glass-based substrate (Composition 1 having a nominal composition in mol % of: 68.9 SiO₂; 10.3 Al₂O₃; 15.2 Na₂O; 5.5 MgO; and 0.1 SnO₂) with dimensions of 100 mm by 60 mm in a direction perpendicular to the substrate thickness. Unless otherwise specified, the examples have a substrate thickness of 100 μm with central thickness of 30 μm formed by etching a recess in the first major surface with a width of 20 mm.

In Example 1, a diffusion layer of AlON having a thickness of 25 nm was disposed on opposite surfaces of the central portion. With the diffusion layer disposed thereon, the glass-based substrate was chemically strengthened in a first molten salt bath having 70 wt % NaNO₃ and 30 wt % KNO₃ maintained at 410° C. for 170 minutes. Then, the diffusion layer is removed before the glass-based substrate is chemically strengthened in a second molten salt bath having 0.5 wt % LiNO₃ and 99.5 wt % KNO₃ maintained at 410° C. for 1.75 minutes (without the diffusion layer).

In Example AA, no diffusion layer is used during any of the chemical strengthening. Otherwise, Example AA was subjected to the same chemical strengthening conditions as Example 1. Example AA was severely buckled at the end of the second chemical strengthening treatment.

In Example 2, a 50 nm thick diffusion layer of AION was disposed on opposite surfaces of the central portion. Otherwise, Example 2 was subjected to the same chemical strengthening conditions as Example 1.

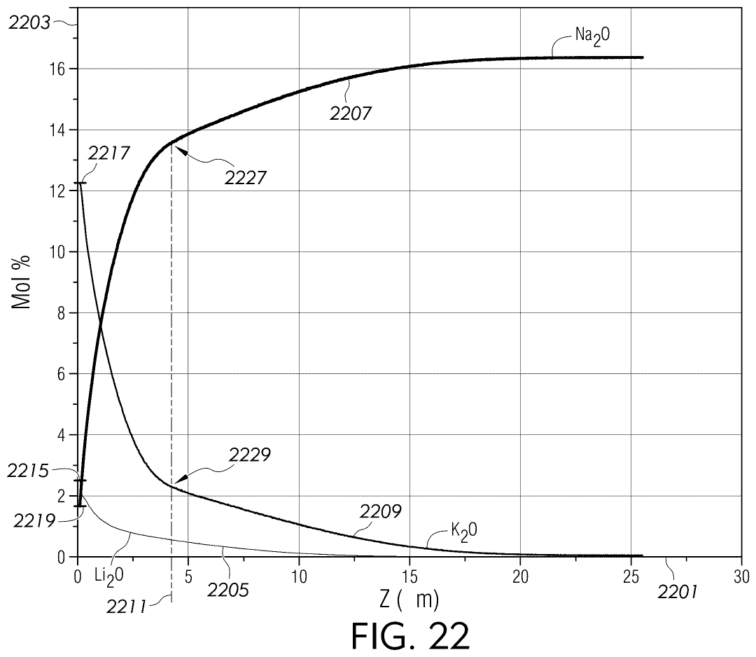

FIGS. 22-23 schematically depict concentration profiles from the first major surface and the first central surface area, respectively, as measured by GDOES after the above-mentioned treatment in Examples 1-2, where the vertical axis 2203 or 2303 (i.e., y-axis) corresponds to the concentration in mol % at the corresponding depth (z—from the corresponding surface) on the horizontal axis 2201 or 2301 (i.e., x-axis) in micrometers (μm). Curves 2205, 2305, and 2315 correspond to the concentration profile of lithium oxide (Li₂O). Curves 2207, 2307, and 2317 correspond to the concentration profile of sodium oxide (Na₂O). Curves 2209, 2309, and 2319 correspond to the concentration profile of potassium oxide (K₂O). In FIG. 23, curves 2315, 2317, and 2319 correspond to Example 2 while curves 2305, 2307, and 2309 correspond to Example 1. Since the first portion was not covered in any of these examples, the curves shown in FIG. 22 are the same for Examples 1-2. While FIGS. 22-23 reflect two chemical strengthening treatments, it is to be understood that a third (subsequent) chemical strengthening treatment could be performed and that it would be expected to maintain the trends discussed below (especially the Li₂O offset 2325 and K₂O offset 2329 discussed with reference to FIG. 23).

In FIG. 22, K₂O concentration (curve 2209) decreases from a surface concentration 2217 of greater than 12 mol % (but less than 13 mol %) at the surface as distance from the surface increases. Since Composition 1 does not have K₂O nor Li₂O, the corresponding curves 2205 and 2209 go to zero as the distance from the surface increases (in the first portion). Also, a knee (between a spike region and a deep region) is indicated by dashed line 2211, with corresponding concentrations of Na₂O (curve 2207) and K₂O (curve 2209) indicated by arrows 2227 and 2229, respectively. The presence of this knee is indicative of multiple ion-exchange treatments with different molten salt bath compositions. Also, the Li₂O concentration (curve 2205) decreases from a surface concentration 2215 of about 2.5 mol % as the distance from the surface increases. For these conditions, the surface concentration 2215 of Li₂O is greater than the surface concentration 2219 of Na₂O.

In FIG. 23, the K₂O concentration (curves 2309 and 2319) decrease from a surface concentration (comparable to surface concentration 2217) at the surface as the distance from the surface increases. A depth of layer (dashed line 2311) is shown in FIG. 23 for the sample with the 25 nm diffusion layer (curve 2309). For the 50 nm diffusion layer, the K₂O concentration (curve 2319) goes to 0 (corresponding to the bulk concentration and the concentration at the midpoint of the first point) just as in the first portion (see FIG. 22).

In contrast, for the 25 nm diffusion layer, the K₂O concentration (curve 2309) appears to plateau at a non-zero concentration (e.g., about 1 mol %—see K₂O offset 2329 in FIG. 23). It is expected that this non-zero concentration may extend through the entire central thickness of the sample using the 25 nm etch mask. Comparing these K₂O concentration profiles for the central portion indicates that some potassium must have been able to ion-exchange into the central portion through the 25 nm diffusion barrier that was sufficient to have the non-zero K₂O offset 2329 whereas the 50 nm diffusion barrier limited potassium diffusion such that little or no ion-exchange occurred while the diffusion layer was disposed thereon, as evidenced by the lower K₂O concentration (e.g., 0 mol %) at deeper concentrations (e.g., twice the depth of layer 2311). Although not shown (due to severe buckling), the sample without a diffusion layer would be expected to have even greater potassium ion-exchange since the diffusion layer would not have limited it.

Also, FIG. 23 shows Na₂O concentration profiles (curves 2307 and 2317) having similar surface concentrations (e.g., about 2 mol %) to one another that increase (towards the value of the bulk concentration) as distance from the surface increases. As shown in FIG. 23, the apparent plateau for curve 2307 (25 nm diffusion layer) is lower than that for curve 2317 (50 nm diffusion layer), which is consistent with (and opposite shift of) the trend seen in the K₂O concentration profile.

Additionally, FIG. 23 shows Li₂O concentration profiles (curves 2305 and 2315) with a surface concentration greater than 2 mol % (and likely greater than the surface concentration of Na₂O here; similar to the trend seen for the first portion in FIG. 22). These Li₂O concentration profiles decrease as distance from the surface increases. However, neither curve 2305 nor 2315 goes to zero (even though the bulk composition was Li-free and curve 2205 goes to zero for the first portion). Rather, both curves 2305 and 2315 have a non-zero concentration (Li₂O offset 2325) of about 1 mol %. In FIG. 22, the Li₂O offset 2325 looks about equal to the K₂O offset 2329. This non-zero Li₂O offset 2325 indicates that lithium from the lithium-containing molten salt solution was able to diffuse deep into the central portion. Indeed, it is believed that the concentration of Li₂O is non-zero throughout the entire central thickness (similar to the trend for K₂O discussed above with reference to curve 2309).

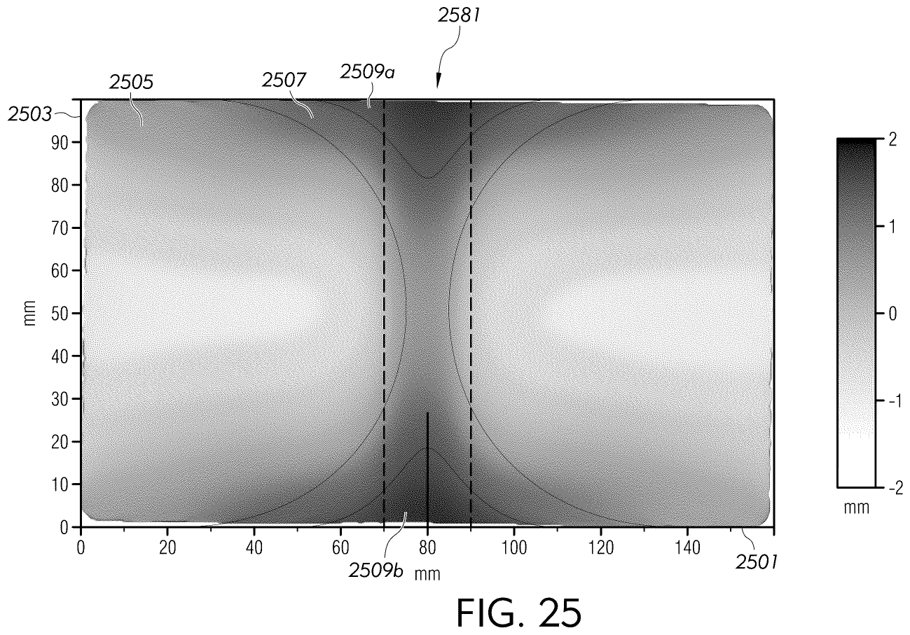

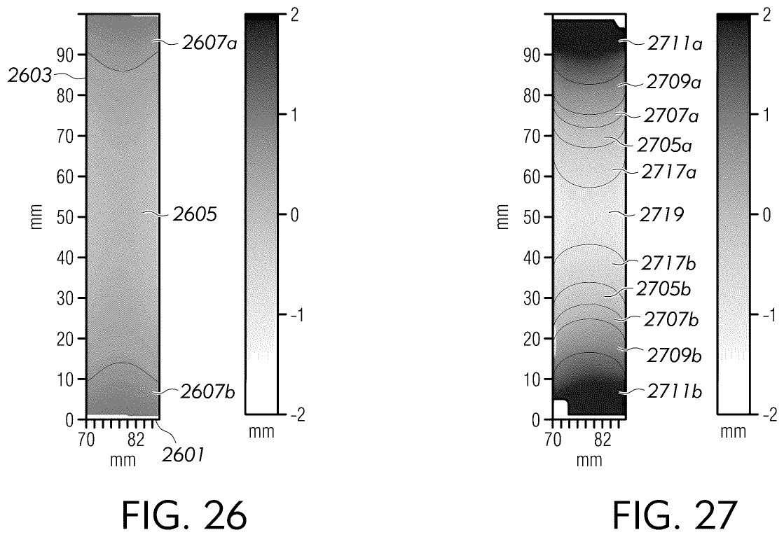

FIG. 25 depicts a surface profile of an entire side of Example 1 (first major surface and recessed first central surface area). FIGS. 26-27 depict the surface profile of the first central surface area (central portion 2581 of Examples 1-2, respectively. The surface profiles were measured using the SpecGAGE3D (available from Irsa Vision) deflectometer, as described above. In FIGS. 25-27, the vertical axis 2503 and 2603 extends parallel to the fold axis, and the horizontal axis 2501 and 2601 extends perpendicular to the fold axis. As shown in FIG. 25, the bulk of the first major surface is in region 2505 having no or very low deflection. Region 2507 near the transition between the first major surface and the first central surface area and in the middle of the central region has slightly more deflection than region 2605 (but still less than or equal to 1 mm). Regions 2509a and 2509b have the most deflection (still less than 2 mm) and is isolated to the peripheral edges of the central portion 2581 (first central surface area). The shape of the surface in FIG. 25 appears to be parabolic, indicating that the same is free of buckling.

FIG. 26 shows the central portion (first central surface) of Example 1 (corresponding to the middle of FIG. 25). As shown, region 2605 has no or very little in the middle 80% or more of the central portion. Regions 2607a and 2707b have more warp than region 2605 and is located at the periphery of the central portion.

FIG. 27 shows the central portion (first central surface) of Example 2. The scale is the same as in FIG. 26. As shown, much larger warp is seen in FIG. 27 (for about the 30% of the central portion closest to the edge-top and bottom) than any warp seen in FIG. 26. In FIG. 27, region 2719 is at the middle of the central portion, which has the lowest deflection. Going towards the edges from region 2719, the warp increases through successive regions. Regions 2717a and 2717b has more deflection (warp) than region 2719 and comparable warp to region 2607a and 2607b in FIG. 26. Regions 2705a, 2705b, 2707a, 2707b, 2709a, 2709b, 2711a, and 2711b have greater deflection than any deflection seen in FIG. 26. The decreased warp in FIG. 26 (Example 1-25 nm diffusion layer) relative to FIG. 27 (Example 2-50 nm diffusion layer) (and the extremely buckled sample of Example AA with no diffusion layer) demonstrates an unexpected benefit associated with the range around Example 1, where low warp and no buckling can be obtained.

To further explore the effect of the process, Example 3 includes a single chemical strengthening treatment. Specifically, Example 3 was chemically strengthened in a molten salt solution having 0.35 wt % LiNO₃ with the balance being KNO₃ maintained at 410° C. for 2 minutes. FIG. 24 schematically depicts the concentration profile for the first portion (from the first major surface) and the central portion (from the first central surface area) for Example 3. In FIG. 24, the vertical axis 2403 (i.e., y-axis) is logarithmically scaled and corresponds to concentration in mol %, and the horizontal axis 2401 (i.e., x-axis) is still linearly scaled and corresponds to the distance from the corresponding surface in micrometers (μm). Curves 2405 and 2415 correspond to the concentration profile of lithium oxide (Li₂O). Curves 2407 and 2417 correspond to the concentration profile of sodium oxide (Na₂O). Curves 2409 and 2419 correspond to the concentration profile of potassium oxide (K₂O).

For Example 4, it is generally expected that the concentration profiles would be the same between the first portion and the central portion since no diffusion layer was used, unless one or more of the ions can diffuse through about 50% or more of the central thickness. As shown in FIG. 24, the potassium concentration profile (curves 2409 and 2419) is the same for the first portion and the central portion, where the concentration profile goes from a surface concentration greater than about 10 mol % to essentially 0 mol % (less than 0.05 mol %) by 7.5 μm. This is consistent with the trend seen for Examples 1-2 (FIGS. 22-23) that this chemical strengthening treatment alone is insufficient to create the K₂O offset 2329 seen in FIG. 23. Complementary to K₂O, the Na₂O concentration (both of curves 2407 and 2417) goes from a surface concentration of about 3 mol % to a plateau corresponding to the concentration of Na₂O in the bulk. As shown, the Li₂O concentration profile (curves 2405 and 2415) decreases from a surface concentration of about 1 mol % or more as the distance from the corresponding surface increases. In the first portion, curve 2405 (Li₂O concentration profile) decreases from the first major surface for the entire distance shown (to less than 0.1 mol %). In contrast, in the central portion, curve 2415 (Li₂O concentration profile) deviates from curve 2405 to have a plateau region 2435 with a minimum Li₂O concentration of at least 0.3 mol % (Li₂O offset 2425). Due to the logarithmic vertical axis 2403 in FIG. 24, curve 2405 has some curvature in region 2435, although this would appear as a flat portion on a linear vertical axis (see FIG. 23). This difference between curves 2405 and 2415 indicates that the lithium is able to diffusion throughout essentially the entire central thickness (from both central surface areas). Due to the faster diffusion of lithium relative to potassium, the lithium can extend throughout essentially the entire central thickness while potassium goes less than 7.5 μm into the sample. Also, the lithium salt concentration is greater in the corresponding chemical strengthening step of Examples 1-2 (0.5 wt %) than in Example 3 (0.25 wt %), the Li₂O offset is almost certainly created based on that step (even with the slightly shorter treatment time in Examples 1-2). Overall, this indicates that this chemical strengthening treatment creates the Li₂O offset 2425 and 2325 but not a K₂O offset, which must be due to additional ion-exchange through the diffusion layer (see FIG. 23).

Example 5 corresponds to Example 1 that is further chemically strengthened (third ion-exchange treatment) in a 100 wt % KNO₃ molten salt solution maintained at 410° C. for 2 minutes after the processing discussed in Example 1. Then, 1.0 μm was etched from all surfaces using an HF etchant to remove any surface flaws introduced or magnified by the various chemical strengthening treatment. Table 1 provides properties of the stress profile achieved for Example 5 after the third ion-exchange treatment both before and after the etching. As shown in Table 1, the depth of layer (DOL) of potassium is greater than the depth of compression (DOC) for the first portion, which is mainly attributed to the deep DOL created in the chemical strengthening treatment without the diffusion layer. The DOL of the central portion is likely influenced by the K₂O offset see in FIG. 22. The etching decreased the DOL by 1.0 μm in both the first portion and the central portion after the etching corresponding to the amount of material removed by the etching. The compressive stress of the first portion decreased by 30 MPa but was still about 900 MPa or more due to the etching while the compressive stress decreased by nearly 200 MPa due to the etching, although the post-etching compressive stress of the central portion is still greater than or equal to 700 MPa.

TABLE 1
Properties of Example 5

| | DOC (μm) | DOL (μm) | CS (MPa) |
|---|---|---|---|
| First Portion (before etch) | 12.9 | 20.0 | 930 |
| First Portion (after etch) | 12.7 | 19.0 | 900 |
| Central Portion (before etch) | 3.0 | 3.5 | 940 |
| Central Portion (after etch) | 3.0 | 2.5 | 730 |

Example 6 disposed a 25 nm diffusion layer on the central portion before a first chemical strengthening of the foldable substrate in a 100 wt % KNO₃ molten salt solution maintained at 410° C. for 60 minutes (with comparable results expected for times from 40 to 80 minutes). Then, the diffusion layer was removed and the foldable substrate before a second chemical strengthening of the foldable substrate in a 70 wt % KNO₃ and 30 wt % NaNO₃ molten salt solution at 410° C. for 165 minutes (with comparable results expected for times from 150 minutes to 180 minutes). This second chemical strengthening is expected to develop a deep depth of layer of potassium without buckling or causing larger warp. After the second chemical strengthening, 1.0 μm was etched from all surfaces using an HF etchant to remove any surface flaws introduced or magnified by the various chemical strengthening treatment. Table 2 provides properties of the stress profile achieved for Example 6 after the second chemical strengthening both before and after the etching. As shown in Table 2, the depth of layer (DOL) of potassium is greater than the depth of compression (DOC) for the first portion, which is mainly attributed to the deep DOL created in the second chemical strengthening (without the diffusion layer). The etching decreased the DOL by 1.0 μm in both the first portion and the central portion after the etching corresponding to the amount of material removed by the etching. The compressive stress of the first portion decreased by 30 MPa but was still about 900 MPa or more due to the etching while the compressive stress decreased by 160 MPa due to the etching, although the post-etching compressive stress of the central portion is still greater than or equal to 700 MPa (in fact, 800 MPa here).

TABLE 2
Properties of Example 6

| | DOC (μm) | DOL (μm) | CS (MPa) |
|---|---|---|---|
| First Portion (before etch) | 12.6 | 20.0 | 940 |
| First Portion (after etch) | 12.5 | 19.0 | 910 |
| Central Portion (before etch) | 3.4 | 6.0 | 970 |
| Central Portion (after etch) | 3.2 | 5.0 | 810 |

The above observations can be combined to provide foldable apparatus comprising foldable substrates, foldable substrates, and methods of making foldable apparatus and foldable substrates comprising foldable substrates that comprise a first portion, a second portion, and a central portion positioned therebetween. The substrate and/or the portions can comprise glass-based and/or ceramic-based portions, which can provide good dimensional stability, reduced incidence of mechanical instabilities, good impact resistance, and/or good puncture resistance. The portions can comprise glass-based and/or ceramic-based portions comprising one or more compressive stress regions, which can further provide increased impact resistance and/or increased puncture resistance. By providing a substrate comprising a glass-based and/or ceramic-based substrate, the substrate can also provide increased impact resistance and/or puncture resistance while simultaneously facilitating good folding performance. In aspects, the substrate thickness can be sufficiently large (e.g., from 50 micrometers (microns or μm) to 2 millimeters) to further enhance impact resistance and puncture resistance. Providing foldable substrates comprising a central portion comprising a central thickness that is less than a substrate thickness (e.g., first thickness of the first portion and/or second thickness of the second portion) (e.g., by 10 μm or more) can enable a small parallel plate distance (e.g., 10 millimeters or less) based on the reduced thickness in the central portion, which can enable the foldability and/or rollability of the foldable substrate and/or foldable apparatus.

In aspects, the foldable apparatus and/or foldable substrates can comprise one or more recesses, for example, a first central surface area recessed from a first major surface by a first distance and/or a second central surface area recessed from a second major surface by a second distance. Providing a first recess opposite a second recess can provide the central thickness that is less than a substrate thickness. Further, providing a first recess opposite a second recess can reduce a maximum bend-induced strain of the foldable apparatus, for example, between a central portion and a first portion and/or second portion since the central portion comprising the central thickness can be closer to a neutral axis of the foldable apparatus and/or foldable substrates than if only a single recess was provided. Additionally, providing the first distance substantially equal to the second distance can reduce the incidence of mechanical instabilities in the central portion, for example, because the foldable substrate is symmetric about a plane comprising a midpoint in the substrate thickness and the central thickness. Alternatively, providing at least one recess on only one side of the foldable substrate can provide a smooth major surface that, for example, can be facing the user and/or provide a uniform tactile sensation. Likewise, providing at least one recess on only one side of the foldable substrate can be manufactured with only a single chemically strengthening process, reducing processing time, space, materials, and cost as well as potentially increasing throughput.

The present disclosure unexpectedly demonstrates that buckling-free and low warp foldable substrates can be obtained. As discussed below, a diffusion layer can be disposed over the central portion to limit (but not prevent) ion exchange in one of the chemical strengthening steps, where the entire foldable substrate undergoes at least some ion exchange in each of the two or more chemical strengthening steps. As demonstrated herein for Example 1 (FIGS. 23 and 25-26), there is a critical thickness for the diffusion layer that allows for some ion exchange in the central portion that avoids buckling (seen without a diffusion layer—Example AA) and the large warp (seen with too thick of a diffusion layer—Example 2-see FIG. 27). The ratio of the lithium difference to the larger alkali difference can be characteristic of the method described herein, where elevated concentration profiles of lithium and the larger alkali metal can be formed throughout the entire central thickness of the central portion relative to the bulk composition (e.g., composition at the first midpoint of the first portion).

The foldable substrate can function as a rollable substrate with a central width greater than a second width. Providing a second width of the second portion of 15% or less of the length of the foldable substrate can provide sufficient width to handle the ends of the foldable substrate during processing, to secure the foldable substrate and/or foldable apparatus as part of an electronic device, and/or to maximize an amount of the foldable substrate and/or foldable apparatus that can be part of a display portion visible to the user. Providing a central portion from 15% to 50% of the length of the foldable substrate can enable a display portion of the foldable apparatus to be adjusted as a portion of the rollable substrate is moved into and/or out of view of a user without unnecessarily expanding a size of the corresponding apparatus when in a fully rolled configuration. Providing a first width of the first portion of 35% or more of the length of the foldable substrate can provide a large display portion visible to the user while ensuring that substantially all of the rest of the foldable substrate (e.g., central portion and second portion) can be within a footprint of the first portion.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A foldable apparatus comprising a substrate comprising:
a substrate thickness defined between a first major surface and a second major surface opposite the first major surface;
a first portion comprising the substrate thickness, a first compressive stress region extending to a first depth of compression from the first major surface, a second compressive stress region extending to a second depth of compression from the second major surface;
a second portion comprising the substrate thickness, a third compressive stress region extending to a third depth of compression from the first major surface, a fourth compressive stress region extending to a fourth depth of compression from the second major surface;
a central portion positioned between the first portion and the second portion, the central portion comprising a central thickness defined between a first central surface area and a second central surface area opposite the first central surface area, a first central compressive stress region extending to a first central depth of compression from the first central surface area, a second central compressive stress region extending to a second central depth of compression from the second central surface area, the first central surface area is recessed from the first major surface by a first distance, and the central thickness is less than the substrate thickness;
a lithium difference defined as a central concentration of lithium oxide at a central midpoint of the central portion minus a first concentration of lithium oxide at a first midpoint of the first portion is from 0.2 mol % to 2 mol %, wherein the central midpoint is midway between the first central surface area and the second central surface area, and the first midpoint is midway between the first major surface and the second major surface in the first portion; and
a larger alkali difference defined as a central concentration of a larger alkali metal oxide at the central midpoint of the central portion minus a first concentration of the larger alkali metal oxide at the first midpoint of the first portion by from 0.2 mol % to 2 mol %, wherein the larger alkali metal oxide is selected from a group of potassium oxide, rubidium oxide, cesium oxide, and francium oxide,
wherein a ratio of the lithium difference to the larger alkali difference is from 0.6 to 1.7, and the substrate comprises a glass-based material.

2. The foldable apparatus of claim 1, wherein the first concentration of the larger alkali metal oxide at the first midpoint is less than or equal to 0.1 mol %.

3. The foldable apparatus of claim 1, wherein the first concentration of lithium oxide at the first midpoint is less than or equal to 0.1 mol %.

4. The foldable apparatus of claim 1, wherein:
the first compressive stress region is associated with a first depth of layer of a larger alkali metal oxide, the first central compressive stress region is associated with a first central depth of layer of the larger alkali metal oxide,
a second lithium difference defined as the concentration of lithium oxide at twice the first central depth of layer from the first central surface area minus a second concentration of lithium oxide at twice the first depth of layer from the first major surface of the first portion is from 0.2 mol % to 2 mol %,
a second larger alkali difference defined as the concentration of the larger alkali metal oxide at twice the first central depth of layer from the first central surface area minus a second concentration of the larger alkali metal oxide at twice the first depth of layer from the first major surface of the first portion by from 0.2 mol % to 2 mol %, and
wherein a second ratio of the second lithium difference to the second larger alkali difference is from 0.6 to 1.7.

5. The foldable apparatus of claim 1, wherein a ratio of a first depth of layer of potassium ions in the first portion from the first major surface to a first central depth of layer of potassium ions in the central portion from the first central surface area is from 2.0 to 6.0, and the first compressive stress region comprises a non-zero concentration profile of lithium and the larger alkali metal oxide to a first depth of layer of the larger alkali metal oxide.

6. The foldable apparatus of claim 5, wherein the first depth of layer of potassium ions divided by the substrate thickness is from 0.12 to 0.17, and the first central depth of layer of potassium ions divided by the central thickness is from 0.15 to 0.20.

7. The foldable apparatus of claim 1, wherein a first maximum compressive stress at the first major surface is from 600 MegaPascals to 1,500 MegaPascals, and a first central maximum compressive stress at the first central surface area is from 600 MegaPascals to 1,500 MegaPascals.

8. The foldable apparatus of claim 7, wherein an absolute value of a difference between the first maximum compressive stress and the first central maximum compressive stress is from 0 MegaPascals to 100 MegaPascals.

9. The foldable apparatus of claim 1, wherein a first surface concentration of lithium oxide at the first major surface is from 2.0 mol % to 5.0 mol %, and a first central surface concentration of lithium oxide at the first central surface area is from 1.0 mol % to 4.0 mol %.

10. The foldable apparatus of claim 1, wherein a first surface concentration of the larger alkali metal oxide at the first major surface is from 8 mol % to 15 mol %, a first central surface concentration of the larger alkali metal oxide at the first central surface area is from 8 mol % to 15 mol %, and the first surface concentration of the larger alkali metal oxide is greater than the first central surface concentration of the larger alkali metal oxide by from greater than or equal to 0.2 mol % to 2.0 mol %.

11. The foldable apparatus of claim 1, wherein a first surface concentration of sodium oxide at the first major surface is from 0.5 mol % to 3.0 mol %, and a first central surface concentration of sodium oxide at the first central surface area is from 0.5 mol % to 3.0 mol %.

12. The foldable apparatus of claim 1, wherein a first larger alkali concentration profile in the first compressive stress region comprises:
a spike region extending between the first major surface and a first knee; and
a deep region extending between the first knee and the first depth of compression,
wherein an absolute value of a slope of a stress profile in the spike region is greater than an absolute value of a slope of a stress profile in the deep region.

13. The foldable apparatus of claim 12, wherein a location of the first knee divided by the substrate thickness is from 0.025 to 0.075.

14. The foldable apparatus of claim 1, wherein the first depth of compression divided by the substrate thickness is from 0.15 to 0.20.

15. The foldable apparatus of claim 1, wherein the second major surface is coplanar with the second central surface area.

16. The foldable apparatus of claim 1, wherein the foldable apparatus achieves a parallel plate distance from 1 millimeter to 10 millimeters.

17. A method of making a foldable substrate comprising:
chemically strengthening a substrate in a first molten salt bath maintained at from 380° C. to 480° C. for a first period of time from 20 minutes to 8 hours to form an intermediate substrate, the substrate being chemically strengthened comprises:
an initial first major surface and an initial second major surface opposite the first major surface present in a first portion and a second portion; and
a central portion positioned between an initial first portion and an initial second portion, the central portion comprising an existing central thickness defined between an existing first central surface area and an existing second central surface area opposite the existing first central surface area, the existing first central surface area is recessed from the existing first major surface by an existing first distance;
disposing a diffusion layer over the first central surface area and the second central surface area of the intermediate substrate;
immersing the intermediate substrate having the diffusion layer disposed thereon in a second molten salt bath maintained at from 380° C. to 480° C. for a second period of time from 1 minute to 3 hours; and then
removing the diffusion layer to form the foldable substrate,
wherein the foldable substrate is a glass-based substrate comprising:
the first portion comprising a substrate thickness, a first compressive stress region extending to a first depth of compression from a first major surface, a second compressive stress region extending to a second depth of compression from a second major surface;
the second portion comprising the substrate thickness, a third compressive stress region extending to a third depth of compression from the first major surface, a fourth compressive stress region extending to a fourth depth of compression from the second major surface; and
the central portion positioned between the first portion and the second portion, the central portion comprising a central thickness defined between a first central surface area and a second central surface area opposite the first central surface area, a first central compressive stress region extending to a first central depth of compression from the first central surface area, a second central compressive stress region extending to a second central depth of compression from a second central surface area, the first central surface area is recessed from the first major surface by a first distance, and the central thickness is less than the substrate thickness.

18. A method of making a foldable substrate comprising:
disposing a diffusion layer over the first central surface area and the second central surface area of an existing substrate;
chemically strengthening the existing substrate having the diffusion layer disposed thereof in a first molten salt bath maintained at from 380° C. to 480° C. for a first period of time from 1 minute to 30 minutes to form an intermediate substrate, the substrate being chemically strengthened comprises:
an initial first major surface and an initial second major surface opposite the first major surface present in a first portion and a second portion; and
a central portion positioned between an initial first portion and an initial second portion, the central portion comprising an existing central thickness defined between an existing first central surface area and an existing second central surface area opposite the existing first central surface area, the existing first central surface area is recessed from the existing first major surface by an existing first distance;
removing the diffusion layer from the intermediate substrate;
immersing the intermediate substrate, after the diffusion layer is removed, in a second molten salt bath maintained at from 380° C. to 480° C. for a second period of time from 20 minutes to 4 hours to form the foldable substrate,
wherein the foldable substrate is a glass-based substrate comprising:
the first portion comprising a substrate thickness, a first compressive stress region extending to a first depth of compression from a first major surface, a second compressive stress region extending to a second depth of compression from a second major surface;
the second portion comprising the substrate thickness, a third compressive stress region extending to a third depth of compression from the first major surface, a fourth compressive stress region extending to a fourth depth of compression from the second major surface; and
the central portion positioned between the first portion and the second portion, the central portion comprising a central thickness defined between a first central surface area and a second central surface area opposite the first central surface area, a first central compressive stress region extending to a first central depth of compression from the first central surface area, a second central compressive stress region extending to a second central depth of compression from a second central surface area, the first central surface area is recessed from the first major surface by a first distance, and the central thickness is less than the substrate thickness.

19. The method of claim 18, wherein the diffusion layer comprises an oxynitride material having a layer thickness from 10 nanometers to 40 nanometers.

20. The method of claim 18, further comprising further chemically strengthening the foldable substrate in a third molten salt bath maintained at from 380° C. to 530° C. for a first period of time from 1 minute to 30 minutes to form an intermediate substrate.
